(19) United States
(12) Patent Application Publication
(10) Pub. No.: US 2025/0363364 A1
(43) Pub. Date: Nov. 27, 2025

(54) HIERARCHICAL THOUGHT SUPERVISION NETWORK FOR ADAPTIVE PROCESSING

(71) Applicant: AtomBeam Technologies Inc., Moraga, CA (US)

(72) Inventors: Brian Galvin, Silverdale, WA (US); Alan McCord, Forney, TX (US)

(21) Appl. No.: 19/076,924

(22) Filed: Mar. 11, 2025

Related U.S. Application Data
(63) Continuation of application No. 19/054,759, filed on Feb. 14, 2025.
Application No. 19/054,759 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(63) Continuation of application No. 19/051,193, filed on Feb. 12, 2025, now Pat. No. 12,387,050.
(60) Provisional application No. 63/651,359, filed on May 23, 2024.

(51) Int. Cl. G06N 3/082

(52) U.S. Cl. CPC G06N 3/082

(57) ABSTRACT

A system and method for a hierarchical thought supervision network with adaptive processing capabilities. The system processes data through a base graph layer of interconnected computational nodes, a telemetry layer for real-time monitoring, and one or more supervision layers composed of supervisory nodes. The base layer handles thought processing and management, while the telemetry layer continuously tracks operational metrics to evaluate processing efficiency. Supervisory nodes adapt network operations by optimizing thought encodings, generating new nodes when needed, and pruning inefficient nodes based on performance objectives. A telemetry layer continuously tracks processing efficiency using adaptive kernel functions and topology-aware distance metrics. The system maintains effective processing while dynamically adjusting to computational demands through coordinated supervision across multiple layers. This approach enables real-time network adaptation while optimizing performance and efficiency across the system.

### CROSS-REFERENCE TO RELATED APPLICATIONS

Priority is claimed in the application data sheet to the following patents or patent applications, each of which is expressly incorporated herein by reference in its entirety:
Ser. No. 19/054,759
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
Ser. No. 63/651,359
Ser. No. 19/051,193

### BACKGROUND OF THE INVENTION

### Field of the Art

The present invention relates to the field of artificial intelligence and machine learning, specifically to deep learning models for processing and generating data across various domains, including but not limited to language, time series, images, and audio.

### Discussion of the State of the Art

In recent years, deep learning models have achieved remarkable success in numerous fields, such as natural language processing (NLP), computer vision, and speech recognition. One of the most prominent architectures is the Transformer. Transformers have become the foundation for state-of-the-art language models like BERT and GPT. Transformers typically process input data, such as text, by first converting tokens into dense vector representations using an embedding layer. Positional encoding is then added to preserve the order of the tokens. The embedded inputs are processed through self-attention mechanisms and feed-forward layers to capture dependencies and generate outputs.

However, the reliance on embedding and positional encoding layers limits the flexibility of Transformers in handling diverse data types beyond language. Moreover, the use of dense vector representations can be computationally intensive and memory-inefficient, especially for large-scale models.

What is needed is a new neural network model that can operate at a higher level of abstraction, using more compact and expressive representations that can efficiently capture the underlying patterns in the data. By removing the embedding and positional encoding layers from a transformer, deep learning models can more efficiently process vast amounts of diverse information. The modified transformer system should be flexible enough to handle various data modalities beyond just text and should enable seamless transfer learning across different languages and domains.

### SUMMARY OF THE INVENTION

Accordingly, the inventor has conceived and reduced to practice a hierarchical thought supervision network system and method. The system implements an innovative approach to thought-based processing through a layered network architecture that enables sophisticated thought management, monitoring, and adaptation. By integrating continuous performance analysis with hierarchical supervision, the system maintains efficient thought processing while dynamically adjusting to changing computational demands.

According to a preferred embodiment, a system for hierarchical thought supervision comprises a base graph layer, a telemetry layer, and one or more supervision layers. The base graph layer includes interconnected network nodes configured to process and manage thought representations. The telemetry layer implements monitoring nodes that collect and analyze operational metrics related to thought processing efficiency. Each supervision layer comprises supervisory nodes that adapt network operations through thought encoding optimization, network node generation, and node pruning based on thought processing performance objectives.

According to another preferred embodiment, the system implements dynamic thought encodings that comprise representations of operational characteristics, enabling real-time adaptation of thought processing performance. These encodings facilitate structured network modifications and autonomous optimization across system layers.

According to an aspect of an embodiment, the telemetry layer employs continuous monitoring mechanisms utilizing adaptive kernel functions and topology-aware distance metrics to track thought processing and network operations.

According to an aspect of an embodiment, network performance objectives include encoding costs, transmission costs, latency considerations, and efficiency improvements. These objectives drive the supervisory decision-making process, ensuring optimal thought processing adaptation.

According to an aspect of an embodiment, the base graph layer implements a thought cache for storing and retrieving thought representations, comprising both local cache for recent thoughts and global cache for persistent thought patterns.

According to an aspect of an embodiment, supervisory nodes implement thought synthesis operations for combining thought representations while maintaining comprehensive thought encoding histories for continuous optimization of processing strategies.

According to an aspect of an embodiment, supervision layers implement hierarchical thought supervision through coordinated local and global supervisory nodes, enabling sophisticated cross-layer thought coordination for dynamic resource optimization.

According to another preferred embodiment, methods for hierarchical thought supervision may comprise implementing various aspects of layered network architectures through continuous adaptation and optimization. These methods may include establishing and maintaining base graph layers with interconnected nodes, implementing telemetry layers for performance monitoring, and maintaining supervision layers that dynamically adapt network operations. Methods may further comprise implementing dynamic thought encodings, employing adaptive kernel functions and topology-aware metrics for continuous monitoring, managing thought caches with both local and global storage capabilities, performing thought synthesis operations, maintaining thought encoding histories, and implementing cross-layer thought coordination. Through these methods, systems may achieve efficient thought processing while maintaining adaptability through various combinations of dynamic node generation, pruning, encoding optimization, and resource management based on continuous performance analysis and established operational objectives.

### BRIEF DESCRIPTION OF THE DRAWING FIGURES

FIG. 1 is a block diagram illustrating an exemplary architecture for a latent transformer, where the transformer operates on latent space vector representations of an input.

FIG. 2 is a block diagram illustrating an exemplary system architecture for a multi-state LLM with unlimited context.

FIG. 3 is a block diagram illustrating an exemplary system architecture for a multi-state LLM with unlimited context with thought synthesis and retrieval.

FIG. 4 is a block diagram illustrating an exemplary system architecture for a multi-state LLM with unlimited context with local and global thought caches.

FIG. 5 is a block diagram illustrating exemplary components for a multi-state LLM with unlimited context, a router and a controller.

FIG. 6 is a block diagram illustrating an exemplary system architecture of a thought cache that has both a long-term memory and a short-term memory.

FIG. 7 is a block diagram illustrating an exemplary system architecture for a large codeword model for deep learning.

FIG. 8 is a block diagram illustrating an aspect of system for a large codeword model for deep learning, a codeword generation subsystem.

FIG. 9 is a block diagram illustrating an embodiment of the system for a large codeword model for deep learning, where the machine learning core is a Transformer-based core.

FIG. 10 is a block diagram illustrating an embodiment of the system and method for a large codeword model for deep learning, where the machine learning core is a VAE-based core.

FIG. 11 is a block diagram illustrating an aspect of system and method for a large codeword model for deep learning, a machine learning core training system.

FIG. 12A illustrates exemplary architecture of adaptive dynamically-encoded agent network.

FIG. 12B illustrates exemplary architecture of dynamically-encoded agents within adaptive dynamically-encoded agent network, in an embodiment.

FIG. 12C is a top-down view of adaptive agent layer, illustrating the interconnected nature of dynamically-encoded base agents.

FIG. 12D is a block diagram illustrating the architecture of adaptive dynamically-encoded agent network interfacing with machine learning core.

FIG. 13 is a method diagram illustrating the adaptive encoding workflow of adaptive dynamically-encoded agent network.

FIG. 14 is a method diagram illustrating the agent lifecycle management process of adaptive dynamically-encoded agent network.

FIG. 15 is a method diagram illustrating the data flow through adaptive dynamically-encoded agent network.

FIG. 16 is a method diagram illustrating telemetry and performance monitoring in adaptive dynamically-encoded agent network.

FIG. 17 is a method diagram illustrating inter-agent communication and coordination in adaptive dynamically-encoded agent network.

FIG. 18 is a method diagram illustrating memory integration and long-term adaptation in adaptive dynamically-encoded agent network.

FIG. 19 is a method diagram illustrating system-wide optimization and stability management in adaptive dynamically-encoded agent network.

FIG. 20 is a method diagram illustrating fault recovery and redundancy handling in adaptive dynamically-encoded agent network.

FIG. 21 is a method diagram illustrating adaptive processing of multi-modal codeword data in adaptive dynamically-encoded agent network.

FIG. 22A is a block diagram illustrating exemplary architecture of hierarchical thought supervision network with thought processing and caching core.

FIG. 22B is a block diagram illustrating exemplary architecture of hierarchical thought supervision network.

FIG. 23 is a method diagram illustrating the core thought supervision process of hierarchical thought supervision network.

FIG. 24 is a method diagram illustrating the thought cache integration flow of hierarchical thought supervision network.

FIG. 25 is a method diagram illustrating the performance monitoring and optimization process of hierarchical thought supervision network.

FIG. 26 is a method diagram illustrating the node lifecycle management process of hierarchical thought supervision network.

FIG. 27 is a method diagram illustrating the cross-layer coordination process of hierarchical thought supervision network.

FIG. 28 illustrates an exemplary computing environment on which an embodiment described herein may be implemented.

### DETAILED DESCRIPTION OF THE INVENTION

The inventor has conceived and reduced to practice a hierarchical thought supervision network system and method for optimizing language model performance through multi-level monitoring and adaptation of thought processing. In an embodiment, a system combines sophisticated thought caching mechanisms with hierarchical supervision capabilities, enabling dynamic optimization of thought generation, storage, and synthesis operations. Base graph layers may interface with language model cores through network node subsystems, processing thoughts and managing their transformations while telemetry layers continuously monitor performance metrics and resource utilization. Supervision layers, which may comprise both local and global components, analyze telemetry data to implement targeted optimizations, ranging from node-level adjustments to system-wide reconfigurations. Through coordinated operation of these layers, a system can maintain efficient thought processing while dynamically adapting to changing computational demands and thought patterns.

One skilled in the art would recognize that various implementations of a hierarchical thought supervision network system are possible, with different embodiments potentially including or omitting various elements based on specific implementation requirements, computational resources, deployment environments, and operational objectives. System components described herein may be implemented through hardware, software, firmware, or combinations thereof. In some implementations, certain components may be combined while in others they may be further subdivided into additional subcomponents. Various arrangements of components may be employed, and specific data flows or component interactions described herein represent exemplary implementations rather than limiting configurations. Additionally, functionality described in relation to certain components may be incorporated into other components in some implementations, and the names of components are for descriptive purposes rather than limiting their functionality. System scale may vary from small deployments to large distributed implementations, with components potentially being added or removed based on scaling requirements. Performance characteristics, operational parameters, and specific implementation details may vary based on deployment context, available resources, and specific use cases.

In an embodiment, a base graph layer may comprise interconnected network nodes configured to process and manage thought representations. Network nodes may, for example, include computational nodes for executing thought transformations, thought processing units for handling encoding operations, and state managers for tracking operational status. A node communication controller may facilitate information exchange between nodes, enabling coordinated thought processing across distributed components.

A thought cache manager may, in some implementations, integrate with base graph layers to provide efficient storage and retrieval of processed thoughts. This manager may comprise local cache controllers for handling immediate access needs and global cache interfaces for managing broader thought distribution. For example, when frequently accessed thoughts are identified, they may be maintained in local caches for rapid retrieval while less frequently accessed thoughts may be stored in global caches with optimized encoding schemes.

In an embodiment, a telemetry layer may implement continuous monitoring of system operations through various specialized components. Performance metric collectors may gather data about thought processing efficiency, resource utilization, and operation timing. Analysis engines may process this telemetry data using adaptive kernel functions and topology-aware distance metrics to identify optimization opportunities. Resource tracking systems may, for example, monitor memory usage, computation loads, and network utilization to inform supervision layer decisions.

A supervision layer may, in an embodiment, implement hierarchical monitoring and adaptation through coordinated local and global supervision subsystems. Local supervision subsystems may continuously monitor and optimize operations within their assigned network regions, implementing immediate adjustments to thought processing parameters and resource allocation. For example, if telemetry data indicates reduced efficiency in a particular node cluster, local supervision components may adjust encoding parameters, redistribute workloads, or initiate node pruning operations to maintain optimal performance.

Global supervision controllers may coordinate system-wide adaptations by aggregating insights from local supervisors and implementing broader optimization strategies. These controllers may, for example, manage cross-layer coordination, system-wide resource allocation, and configuration synchronization across distributed components. In an embodiment, global supervisors may detect emerging patterns in thought processing demands and proactively adjust system resources to maintain efficient operation at scale.

A thought processing core may integrate multiple processing approaches to enable efficient thought manipulation and transformation. Base transformer systems may comprise VAE encoder subsystems for compressing thought representations, latent transformer subsystems for processing thoughts in compressed space, and VAE decoder subsystems for reconstructing processed thoughts. In some implementations, thought synthesis systems may enhance these capabilities by implementing pattern recognition engines, combination processors, and quality assessment units that work together to generate new thoughts from existing patterns.

Optimization engines may continuously refine system performance through coordinated adaptation mechanisms. Performance tuners may, for example, adjust processing parameters based on telemetry feedback, while resource balancers manage computational load distribution across available nodes. Adaptation controllers may implement dynamic adjustments to system configuration based on observed performance patterns and changing operational requirements.

In an embodiment, processing pipeline controllers may manage the flow of thoughts through system components. Input handlers may receive and prepare thoughts for processing, while transformation sequencers coordinate the application of various processing operations. Output generators may prepare processed thoughts for storage or transmission, implementing appropriate encoding transformations based on intended use cases.

Error recovery mechanisms may be implemented throughout system layers to maintain operational stability. Local supervision subsystems may, for example, include error recovery handlers that detect and address processing failures at the node level. Global supervision controllers may coordinate broader recovery operations when local mechanisms prove insufficient, implementing failover procedures or resource reallocation to maintain system availability.

Network node subsystems may implement dynamic configuration capabilities through node state managers and communication controllers. State managers may, for example, maintain detailed operational histories for each node, tracking performance metrics, resource utilization patterns, and processing effectiveness over time. This historical data may inform adaptation decisions, allowing nodes to optimize their configuration based on observed patterns in thought processing demands.

Communication controllers may implement adaptive protocols for inter-node message passing, dynamically adjusting transmission parameters based on network conditions and processing requirements. In an embodiment, these controllers may employ various encoding schemes for different types of messages, optimizing bandwidth utilization while ensuring reliable delivery of critical processing instructions and thought data.

A monitoring subsystem may employ sophisticated pattern detection mechanisms to identify recurring operational patterns and potential optimization opportunities. Efficiency analyzers may, for example, process telemetry data using machine learning techniques to detect subtle patterns in system behavior that might indicate emerging performance issues or optimization opportunities. Pattern detection engines may correlate data across multiple operational dimensions, enabling early identification of complex performance patterns that might not be apparent through simpler analysis methods.

Thought cache managers may implement multi-tiered storage strategies with dynamic data placement optimization. In an embodiment, cache controllers may analyze thought access patterns and processing requirements to determine optimal storage locations and encoding schemes for different types of thoughts. Local cache controllers may, for example, maintain frequently accessed thoughts in high-speed memory while implementing progressive compression for less frequently accessed data.

Global cache interfaces may coordinate distributed storage operations across multiple system nodes, implementing sophisticated synchronization protocols to maintain cache coherence while minimizing communication overhead. These interfaces may, for example, employ predictive caching strategies, pre-positioning thought data based on anticipated processing requirements and observed usage patterns.

Resource tracking systems may implement adaptive monitoring strategies that adjust their operation based on observed system behavior. Memory usage monitors may, for example, dynamically adjust sampling rates and monitoring granularity based on observed volatility in memory utilization patterns. Computation load trackers may employ predictive models to anticipate processing demands and adjust resource allocation proactively.

In an embodiment, supervision layers may implement hierarchical optimization strategies through coordinated operation of multiple control subsystems. Node generation controllers may analyze telemetry data to identify opportunities for enhancing processing capacity through targeted node creation. For example, when persistent processing bottlenecks are detected, generation controllers may instantiate new processing nodes with specialized configurations optimized for the specific workload patterns observed in that network region.

Pruning management units may continuously evaluate node effectiveness, identifying and removing underperforming or redundant nodes to maintain optimal resource utilization. These units may, for example, track node utilization patterns, processing efficiency, and contribution to overall system performance to make informed decisions about node retention or removal. When nodes are selected for pruning, these units may implement gradual decommissioning procedures to ensure smooth transition of processing responsibilities to remaining nodes.

Cross-layer coordinators may facilitate synchronized optimization actions across different system levels. In an embodiment, these coordinators may aggregate performance insights from multiple layers to develop comprehensive optimization strategies that consider both local processing efficiency and global resource utilization patterns. For example, when local supervision subsystems detect recurring performance issues, cross-layer coordinators may initiate broader system adjustments that address root causes rather than symptoms.

Resource allocation managers may implement sophisticated workload distribution strategies based on continuous analysis of system utilization patterns. These managers may, for example, maintain detailed models of processing capabilities and resource availability across all system nodes, using this information to optimize task distribution and resource allocation. In some implementations, allocation managers may employ predictive modeling techniques to anticipate resource requirements and adjust system configuration proactively.

Synchronization controllers may maintain operational coherence across distributed system components through adaptive coordination mechanisms. These controllers may, for example, implement variable synchronization protocols that adjust their operation based on network conditions and processing requirements. During periods of high system load, synchronization frequency might be reduced for non-critical operations while maintaining tight synchronization for essential processing tasks.

Pattern recognition engines within thought synthesis systems may implement adaptive learning mechanisms to improve their effectiveness over time. These engines may, for example, maintain historical records of successful thought combinations and processing patterns, using this information to refine their recognition strategies and improve prediction accuracy. In some implementations, recognition engines may employ multiple analysis techniques simultaneously, combining results through weighted voting mechanisms to improve pattern detection reliability.

Combination processors may implement various strategies for merging and synthesizing thoughts based on observed patterns and processing requirements. For example, when combining related thoughts, these processors may employ techniques ranging from simple concatenation to sophisticated semantic fusion operations, selecting appropriate methods based on thought characteristics and desired outcomes. Quality assessment units may continuously evaluate combination results, providing feedback that enables progressive refinement of synthesis strategies.

Configuration managers may implement dynamic system adjustment capabilities through coordinated parameter optimization. These managers may, for example, maintain hierarchical configuration models that capture relationships between different system parameters, using these models to predict the impact of potential configuration changes before implementation. When configuration updates are required, managers may implement graduated adjustment procedures that maintain system stability while optimizing performance.

Error recovery handlers may implement multi-level fault tolerance mechanisms throughout system components. Local recovery mechanisms may, for example, handle routine processing issues through immediate corrective actions, while escalating more serious problems to higher-level supervision systems when necessary. Recovery handlers may maintain detailed error histories that inform the development of preventive measures and help optimize system resilience over time.

Performance tuners within optimization engines may implement continuous adaptation strategies based on real-time analysis of system behavior. These tuners may, for example, maintain sliding windows of performance metrics that enable detection of both immediate issues and longer-term trends. By analyzing patterns across multiple operational dimensions, performance tuners can identify complex optimization opportunities that might not be apparent through simpler analysis methods.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “sourceblock” refers to a semantically meaningful unit of text that is derived from the input data through a process called syntactic splitting. Syntactic splitting involves breaking down the input text into smaller chunks along syntactic boundaries, such as those between words or tokens. These resulting chunks, or sourceblocks, serve as the basic units of representation in LCMs, replacing the traditional word or subword tokens used in Large Language Models (LLMs). Each sourceblock is then assigned a unique codeword from a codebook, which allows for efficient compression and processing of the text data. By preserving syntactic and semantic information within sourceblocks, LCMs aim to capture the inherent structure and meaning of the language more effectively while achieving higher compression ratios compared to LLMs.

As used herein, “machine learning core” refers to the central component responsible for processing and learning from the codeword representations derived from the input data. This core can consist of one or more machine learning architectures, working individually or in combination, to capture the patterns, relationships, and semantics within the codeword sequences. Some common architectures that can be employed in the machine learning core of LCMs include but are not limited to transformers, variational autoencoders (VAEs), recurrent neural networks (RNNs), convolutional neural networks (CNNs), and attention mechanisms. These architectures can be adapted to operate directly on the codeword representations, with or without the need for traditional dense embedding layers. The machine learning core learns to map input codeword sequences to output codeword sequences, enabling tasks such as language modeling, text generation, and classification. By leveraging the compressed and semantically rich codeword representations, the machine learning core of LCMs can potentially achieve more efficient and effective learning compared to traditional token-based models. The specific choice and configuration of the machine learning architectures in the core can be tailored to the characteristics of the input data and the desired output tasks, allowing for flexibility and adaptability in the design of LCMs.

As used herein, “codeword” refers to a discrete and compressed representation of a sourceblock, which is a meaningful unit of information derived from the input data. Codewords are assigned to sourceblocks based on a codebook generated by a codebook generation system. The codebook contains a mapping between the sourceblocks and their corresponding codewords, enabling efficient representation and processing of the data. Codewords serve as compact and encoded representations of the sourceblocks, capturing their essential information and characteristics. They are used as intermediate representations within the LCM system, allowing for efficient compression, transmission, and manipulation of the data.

As used herein, “supervisory neuron” refers to a specialized computational unit within a neural network that monitors, analyzes, and modifies the structure and behavior of a group of operational neurons in real-time. Supervisory neurons act as local controllers, continuously collecting activation data from their assigned neural network region. They perform statistical analysis on this data to identify patterns, anomalies, or suboptimal configurations. Based on this analysis, supervisory neurons can initiate structural modifications to the network, such as adding or removing neurons, creating or pruning connections, or adjusting connection weights. This adaptive mechanism allows the neural network to evolve its architecture dynamically in response to changing input patterns or task requirements, potentially improving performance and efficiency without the need for explicit retraining.

As used herein, “operational neuron” refers to a standard processing unit within a neural network that performs the primary computational tasks of the network. Operational neurons receive inputs, apply activation functions, and produce outputs that are passed on to other neurons or as final network outputs. Unlike supervisory neurons, operational neurons do not have the capability to modify the network structure. Instead, they form the basic building blocks of the neural network, collectively processing information to perform tasks such as pattern recognition, classification, or prediction. The behavior and connectivity of operational neurons are subject to modification by supervisory neurons, allowing for adaptive network architectures.

As used herein, “local neural network region” refers to a subset of interconnected operational neurons within a larger neural network, typically monitored and managed by one or more supervisory neurons. This region forms a functional unit within the network, often specialized for processing certain types of information or performing specific subtasks. The concept of local neural network regions allows for distributed control and adaptation within large-scale neural networks. By focusing on local regions, supervisory neurons can make targeted modifications that optimize performance for specific functions without necessarily affecting the entire network. This localized approach to network adaptation can lead to more efficient and specialized processing capabilities.

As used herein, “structural modification” refers to any change in the architecture, connectivity, or parameters of a neural network, including but not limited to neuron addition, neuron removal, connection creation, connection removal, and weight adjustment. Structural modifications are a key mechanism by which neural networks can adapt to new information or changing task requirements. Unlike traditional learning algorithms that only adjust connection weights, structural modifications allow for more fundamental changes to the network architecture. This can potentially lead to more flexible and powerful neural networks capable of handling a wider range of tasks or adapting to significant shifts in input distributions. Structural modifications are typically initiated by supervisory neurons based on their analysis of local network performance and activation patterns.

As used herein, “activation data” refers to information about the activity of neurons in a neural network, including but not limited to activation levels, activation frequencies, and inter-neuron correlation patterns. Activation data provides insight into the internal workings of the neural network, revealing how information flows through the network and which neurons or connections are most important for specific tasks. Supervisory neurons collect and analyze activation data to inform their decision-making processes. By examining patterns in activation data over time, supervisory neurons can identify underutilized or overactive parts of the network, detect emerging specializations, or recognize when the network is struggling with certain types of inputs. This information is crucial for determining appropriate structural modifications and optimizing network performance.

As used herein, “dynamically-encoded agent” refers to a computational entity within adaptive dynamically-encoded agent network 5600 that processes, transmits, and adapts encoding structures in response to telemetry data, system performance objectives, and environmental conditions. Dynamically-encoded agents optimize encoding transformations, exchange information with other agents, and may be instantiated, modified, or pruned based on network demands.

As used herein, “adaptive dynamically-encoded agent network” refers to a multi-layered network comprising dynamically-encoded agents that communicate, optimize encoding transformations, and manage resource distribution in real time. The network includes telemetry monitoring, memory retention, and system-wide optimization capabilities that enable continuous adaptation based on performance metrics.

As used herein, “telemetry agent” refers to an agent responsible for continuously monitoring encoding efficiency, transmission latency, processing workload distribution, and overall system performance. Telemetry agents provide feedback to dynamically-encoded agents, enabling real-time optimization and adaptation.

As used herein, “encoding optimization” refers to the process by which dynamically-encoded agents adjust encoding parameters, data compression levels, transformation techniques, and transmission strategies to improve efficiency, minimize redundancy, and enhance downstream processing.

As used herein, “agent lifecycle management” refers to the dynamic process of generating, modifying, or pruning dynamically-encoded agents in response to system demands, performance inefficiencies, or workload imbalances. This includes adaptive agent instantiation, resource reallocation, and redundancy management.

As used herein, “inter-agent communication” refers to the structured exchange of encoding data, performance updates, and adaptation directives between dynamically-encoded agents through inter-agent communication links. Communication may include direct encoding transmissions, collaborative optimization messages, and distributed learning signals.

As used herein, “memory agent” refers to an agent responsible for storing, retrieving, and refining encoding transformation records over time. Memory agents manage both short-term and long-term encoding retention, allowing the system to recall prior optimization strategies and improve encoding efficiency through iterative learning.

As used herein, “multi-modal encoding” refers to the capability of dynamically-encoded agents to process and optimize encoding transformations for different data types, including but not limited to text, images, time-series signals, and structured datasets. Multi-modal encoding ensures that diverse data formats are effectively transmitted and utilized within the network.

As used herein, “network optimization cycle” refers to the iterative process by which dynamically-encoded agents refine their encoding models, adjust processing strategies, and synchronize adaptation mechanisms across multiple network layers based on telemetry insights.

As used herein, “thought encoding adaptation” refers to the process by which hierarchical thought supervision network 6600 dynamically adjusts the structure, format, or complexity of thought representations based on system performance metrics, retrieval efficiency, and computational demands. Thought encoding adaptation may involve compression techniques, encoding refinement, or transformation strategies that optimize storage, processing, and retrieval while preserving semantic integrity. These adaptations may be applied at the local or global level and are guided by telemetry data, efficiency analysis, and supervisory control mechanisms.

As used herein, “cross-layer coordination” refers to the structured interaction between different hierarchical levels of hierarchical thought supervision network 6600 to ensure synchronized optimization, resource distribution, and adaptive processing across local and global supervisory subsystems. Cross-layer coordination involves the exchange of performance metrics, optimization directives, and system state updates between base graph layer 6610, telemetry layer 6630, and supervision layer 6650. It enables dynamic workload balancing, hierarchical decision-making, and system-wide adaptation to changing computational demands.

### Conceptual Architecture of Multi-Stage LLM

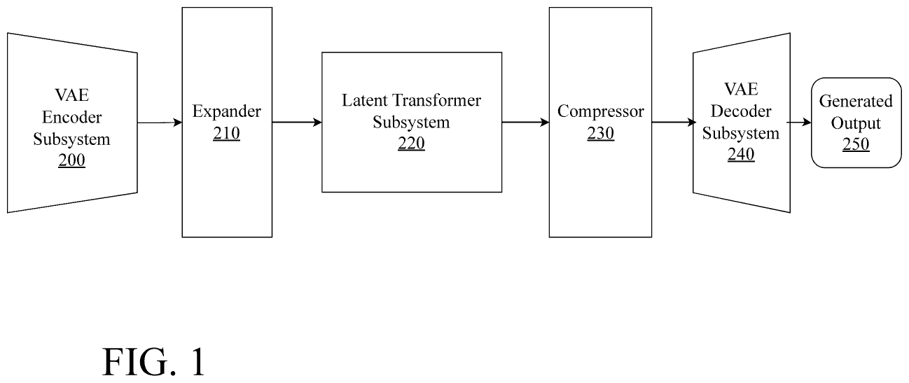

FIG. 1 is a block diagram illustrating an exemplary architecture for a latent transformer, where the transformer operates on latent space vector representations of an input. Central to a latent transformer is a latent transformer subsystem 220, which serves as the central processing unit responsible for learning the underlying patterns, relationships, and dependencies within the input data. Latent transformer subsystem 220 leverages advanced techniques such as self-attention mechanisms and multi-head attention to capture the complex interactions and sequences in the data, enabling it to generate accurate and context-aware outputs.

The input to latent transformer subsystem 220 is provided by a VAE (Variational Autoencoder) encoder subsystem 200. VAE encoder subsystem 600 is responsible for encoding an input into a lower-dimensional latent space representation. VAE encoder subsystem 200, learns to compress the data into a compact latent space representation while preserving the essential features and characteristics of the input. Latent space vectors produced by the VAE encoder subsystem 200 may be further processed by an expander 210, which increases the dimensionality of the input data to a point where the vectors can be efficiently processed by latent transformer subsystem 220.

A latent space representation of the input generated by VAE encoder subsystem 200 serves as the input to latent transformer subsystem 220. Latent transformer subsystem 220 operates in this latent space, leveraging the compressed and informative representation to learn the complex patterns and relationships within the data. By working in the latent space, latent transformer subsystem 220 can efficiently process and model the data, capturing the intricate dependencies and generating accurate and meaningful outputs.

Once latent transformer subsystem 220 has processed the latent space representation, the generated output is passed through a VAE decoder subsystem 240. VAE decoder subsystem 240 is responsible for decoding the latent space representation back into the original data space. Prior to processing by VAE decoder subsystem 240, latent transformer subsystem 220 outputs may be compressed back to an original size before being processed by the expander 210 by being processed by a compressor 230. VAE decoder subsystem 240 learns to reconstruct the original data from the latent space representation, ensuring that the generated output is coherent and meaningful.

The reconstructed output from VAE decoder subsystem 240 is provided as a compressed generated output 250. The compressed generated output 250 represents the final result of the latent transformer, which is a compressed version of the original input.

VAE encoder subsystem 200 and VAE decoder subsystem 240 play large roles in the overall functioning of the latent transformer. VAE encoder subsystem 200 enables the system to learn a compressed and informative representation of the input data in the latent space, while the VAE decoder subsystem 240 ensures that the compressed generated output 250 is coherent and meaningful by reconstructing it back into the original data space. The combination of these subsystems allows the latent transformer to focus on learning the complex patterns and relationships within the data, leading to accurate and context-aware outputs.

The specific architectures and parameters of VAE encoder subsystem 200, latent transformer subsystem 220, and VAE decoder subsystem 240 can be customized and adapted based on the characteristics and requirements of the input data and the specific task at hand. The modular design of the system allows for flexibility and extensibility, enabling the integration of different architectures, attention mechanisms, and training techniques to optimize the performance and efficiency of the latent transformer.

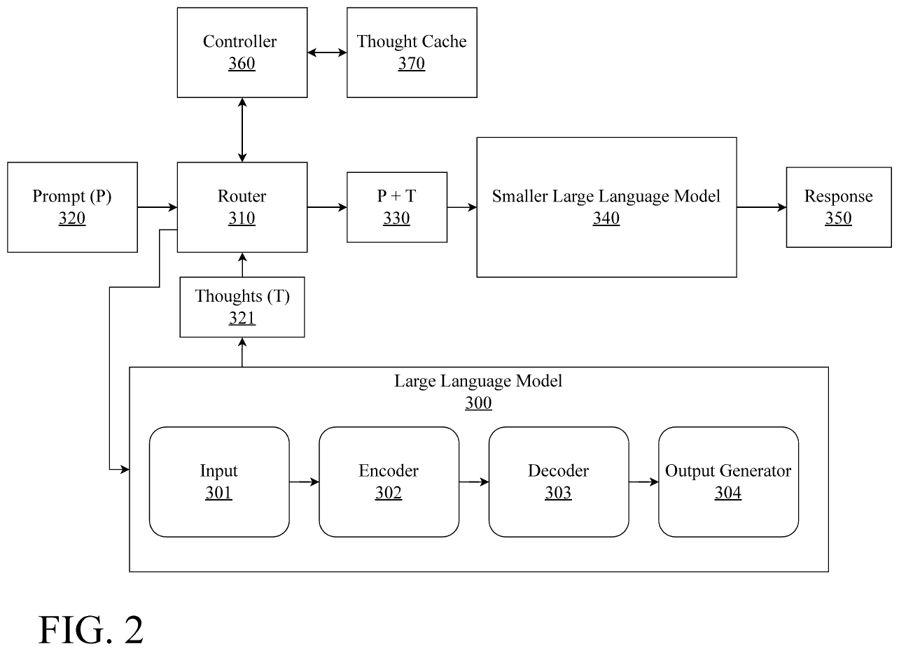

FIG. 2 is a block diagram illustrating an exemplary system architecture for a multi-state LLM with unlimited context. The system includes a large language model 300, a router 310, a controller 360, a thought cache 370, and a smaller language model 340 that work together to process prompts and generate responses while optimizing computational resources.

The system receives an initial prompt (P) 320 through the router 310. The router serves as the central control component, determining whether to utilize the large language model 300 or access the thought cache 370 through the controller 360. Upon receiving a prompt, the router first queries the thought cache to determine if relevant thoughts exist for similar prompts.

The large language model 300 includes an input component 301, an encoder 302, a decoder 303, and an output generator 304. The large language model 300 can utilize various internal architectures, including but not limited to traditional transformer cores or latent transformer cores (as shown in FIG. 1). The model's attention mechanisms can be implemented using either standard multi-head attention (MHA) or multi-head latent attention (MLA), with the overall system functioning identically regardless of the specific attention mechanism chosen. When using MLA, the model benefits from reduced KV cache requirements during inference while maintaining performance comparable to or better than traditional MHA implementations. When the router determines that cached thoughts are not available or suitable, the prompt is processed through the large language model 300. During this processing, the model enters a reasoning phase where it generates thoughts (T) 321 about the prompt. These thoughts represent the model's analysis and reasoning about the prompt before generating a final response.

The controller 360 manages interaction with the thought cache 370, which can be implemented as either a local or cloud-based storage system. The thought cache stores previously generated thoughts in a vector database format, allowing for efficient retrieval of relevant thoughts for similar prompts. The cache can maintain both session-specific thoughts for temporary storage and long-term thoughts for persistent knowledge.

When thoughts are either generated by the large language model or retrieved from the cache, they are combined with the original prompt to create a prompt and thought combination (P+T) 330. This combination is then routed to the smaller language model 340, which requires significantly fewer computational resources than the large model. The smaller model processes the P+T 330 combination to generate the final response 350.

In operation, for example, if a user submits a prompt asking about climate change impacts, the router first checks the thought cache for relevant existing thoughts. If suitable thoughts exist, they are retrieved and combined with the prompt. If no relevant thoughts are found, the large model processes the prompt to generate new thoughts about climate science, global impacts, and relevant data. These thoughts, combined with the original prompt, are then processed by the smaller model 340 to generate a concise, relevant response. The new thoughts are also cached for future use. To demonstrate how thoughts are created, imagine the prompt “What do you think is the future of string theory, particularly given the spectacular failure of supersymmetry at LHC” being entered into the LLM DeepSeek. During the reasoning phase, the model returns to the user the following thoughts:

“Okay, the user is asking about the future of string theory in light of supersymmetry not being found at the LHC. Let me start by recalling what I know about string theory and SUSY.

String theory relies heavily on supersymmetry because SUSY helps stabilize the extra dimensions and makes the math work better. But the LHC hasn't found any superpartners, which challenges some of the more popular SUSY models. However, I should note that SUSY isn't the only part of string theory. There are versions without it, like bosonic string theory, but those aren't as developed or realistic.

The user might be implying that since SUSY isn't found, string theory is in trouble. I need to address that but also explain why it's not the whole story. Maybe mention that SUSY could still exist at higher energy scales beyond LHC's reach. Also, string theory has other applications beyond particle physics, like in condensed matter or quantum gravity.

I should break down the response into points. First, clarify the relationship between SUSY and string theory. Then discuss the LHC results and their implications. Talk about other areas where string theory contributes, like holography or black hole physics. Mention alternatives within string theory that don't rely on low-energy SUSY. Also, touch on the possibility of future experiments or theoretical breakthroughs.

Need to be balanced. Acknowledge the challenges but also the potential. Avoid being too dismissive or overly optimistic. Maybe conclude by saying the future is uncertain but still active in different areas. Check if there are recent developments post-LHC that I should consider, but since the user didn't specify, stick to general points.

Make sure to explain technical terms like “landscape” or “holography” briefly. Keep the language accessible but precise. The user might be someone with a basic understanding of physics, possibly a student or enthusiast. They want to know if string theory is still viable and where it's headed. They might also be interested in how scientific theories adapt when experimental evidence is lacking.

In summary, structure the answer to address the SUSY issue, discuss other aspects of string theory, mention alternative research directions, and conclude with the ongoing relevance despite challenges. Ensure each point flows logically and answers the user's concern about the theory's future post-LHC results.” Using the above generated thoughts, model generated a response to the user's query.

The above thoughts represent T in the accompanying FIG. 2. By extracting thoughts generated by a model in their reasoning phase and passing both those thoughts and the initial prompt through a substantially smaller model with less parameters, the same response may be given while using much less energy.

The system supports multiple cache architectures, including but not limited to local device storage for personal use and cloud-based storage for enterprise applications. This allows for knowledge sharing across users while maintaining appropriate privacy and access controls. Multiple specialized caches can exist for different domains or use cases, such as financial analysis or scientific research.

The system supports multiple specialized cache architectures that enable domain-specific knowledge storage and AI agent collaboration. These architectures include but are not limited to local device caches for personal use, edge caches for specific AI agents, and distributed cloud-based caches for enterprise applications. Each specialized cache maintains its own thought organization optimized for its domain—for instance, a financial analysis cache might structure thoughts around market patterns and risk assessment frameworks, while a scientific research cache might organize thoughts based on experimental methodologies and theoretical frameworks. AI agents can be assigned primary affinity to specific specialized caches while maintaining ability to access other caches when needed. For example, a financial analysis agent might primarily interact with the financial cache but could access the scientific research cache when analyzing biotechnology investments. The system implements cache-specific validation rules and quality metrics tailored to each domain's requirements—financial thoughts might require numerical accuracy validation, while scientific thoughts might undergo peer-review-style verification by other AI agents. These specialized caches can operate independently or in interconnected hierarchies, with bridge agents managing thought transfer between different domains. Enterprise deployments can maintain multiple parallel specialized caches with varying access levels, enabling selective knowledge sharing while preserving security boundaries. For instance, a pharmaceutical company might maintain separate but interconnected caches for public research, proprietary development, and regulatory compliance, with AI agents navigating these boundaries based on clearance levels and task requirements.

The system achieves effectively unlimited context windows through a combination of thought abstraction and hierarchical memory management. Rather than attempting to maintain extended token sequences, the system is capable of converting contextual information into thought representations that capture higher-level patterns and relationships. These thoughts serve as compressed encodings of context, where each thought unit may encapsulate understanding that would traditionally require thousands of tokens to represent.

In one embodiment, the system implements a multi-tier thought storage architecture where context exists simultaneously at multiple levels of abstraction. The most recent context maintains detailed thought representations with full fidelity, while older context is progressively synthesized into more abstract thought patterns that capture essential relationships and understanding while reducing storage requirements. This progressive abstraction allows the system to maintain effectively unlimited context while managing computational resources efficiently.

When processing new prompts, router 310 analyzes both recent detailed thoughts and older abstract thoughts to identify relevant context. A thought synthesizer 430 can then combine these different levels of abstraction to generate new thoughts that incorporate both immediate context and long-term understanding. This multi-level synthesis enables the system to maintain contextual coherence across extended interactions without requiring linear scaling of computational resources.

Thought cache 370 implements indexing structures that maintain temporal relationships between thoughts while enabling efficient retrieval based on relevance. Unlike traditional attention mechanisms that must process entire token sequences, the system can directly access relevant thoughts across any temporal distance through its hierarchical indexing system. This capability allows the model to maintain contextual awareness across arbitrarily long sequences while keeping retrieval costs nearly constant.

In one embodiment, thought cache 370 implements multiple storage tiers that automatically organize thoughts based on their temporal relevance and utilization patterns. In its primary tier, the thought cache maintains recent thoughts with their complete reasoning chains and relationship mappings intact. As these thoughts age within the cache, specialized consolidation mechanisms within the cache combine related thoughts into more efficient meta-thoughts that preserve essential reasoning while reducing storage overhead.

Thought cache 370 monitors access patterns and triggers consolidation events when thought clusters meet specific temporal or utilization thresholds. During these events, thought cache 370 analyzes thought clusters using its built-in synthesis capabilities to generate consolidated meta-thoughts. These meta-thoughts capture insights and relationships from the original thought cluster while requiring significantly less storage space. For example, a sequence of thoughts about various machine learning algorithms might consolidate into a meta-thought capturing their comparative advantages and key implementation considerations.

Intelligence within thought cache 370 adapts consolidation timing based on thought utility metrics. Thought cache 370 tracks each thought's retrieval frequency, synthesis participation, and relationship density with other thoughts. Thoughts demonstrating high utility retain their detailed form longer, while less frequently accessed thoughts undergo earlier consolidation. This adaptive approach ensures that frequently needed reasoning patterns remain readily available in their most useful form.

Thought cache's 370 hierarchical storage structure spans multiple performance tiers, from high-speed memory for recent and frequently accessed thoughts to more economical storage for consolidated meta-thoughts. Thought cache 370 may migrate thoughts between these tiers based on usage patterns and age, optimizing storage resource utilization while maintaining rapid access to relevant contextual information. This tiered structure enables the cache to efficiently manage large volumes of thoughts while keeping the most pertinent information readily accessible.

Thought cache 370 implements a universal thought representation format that enables consistent interpretation across different language models and reasoning contexts. This standardization occurs through a formal thought schema that defines how reasoning steps, logical relationships, and contextual dependencies are encoded. Each thought contains structured fields for core reasoning components, metadata describing the thought's context and assumptions, and explicit markers for temporal and logical dependencies. This structured format ensures that thoughts remain interpretable regardless of which model originally generated them or which model ultimately consumes them.

Before a cached thought is applied to a new context, the system may perform an automated compatibility analysis. This analysis examines both the structural alignment between the cached thought and the current context, and the semantic applicability of the reasoning pattern. The system maintains model-specific adapters that can transform thoughts between different models' preferred reasoning styles while preserving the core logical structure. These adapters handle variations in formatting, vocabulary, and reasoning granularity, ensuring smooth thought transfer between models with different characteristics.

The cache incorporates a contextual validation layer that assesses thought applicability before reuse. When retrieving a cached thought, this layer examines the current prompt's context against the thought's encoded assumptions and dependencies. If misalignments are detected, the system can automatically generate bridging thoughts that reconcile differences between the cached reasoning and the current context. For example, if a cached mathematical proof assumes certain preconditions that differ slightly from the current problem, the system generates additional reasoning steps to account for these differences.

The system's thought schema includes explicit version controls and model compatibility markers. These markers identify which model versions and architectures have successfully utilized each thought, enabling the cache to predict compatibility issues before attempting thought reuse. When new model versions are deployed, the system can automatically flag thoughts that may require revalidation or adaptation to maintain compatibility with updated model capabilities or knowledge cutoffs.

Through these standardization and compatibility mechanisms, the thought cache ensures reliable thought transfer across different models and contexts while maintaining the integrity of reasoning patterns. The combination of structured thought representation, contextual validation, and adaptive transformation enables efficient thought reuse while preventing inconsistencies or misinterpretations.

Through this architecture, the system achieves effective unlimited context not through brute-force token retention but through intelligent abstraction and synthesis of understanding. The smaller language model can process these thought-based contexts more efficiently than traditional token sequences, enabling contextual reasoning without the computational overhead typically associated with extended context windows.

The system supports multiple architectural approaches for maintaining extended context through thought processing. While transformer-based attention mechanisms provide one implementation path, the system can alternatively employ recurrent neural networks (RNNs) for processing thought sequences. In an RNN-based implementation, thoughts are processed sequentially, with the network's hidden state maintaining a compressed representation of historical context. This approach enables efficient processing of arbitrary-length thought sequences while maintaining a constant memory footprint, as the hidden state size remains fixed regardless of sequence length.

The system may also implement memory networks for thought storage and retrieval. These networks maintain an explicit, addressable memory that stores thought representations and their relationships. Unlike attention mechanisms that must process all context simultaneously, memory networks can selectively access relevant thoughts through content-based addressing. The memory network architecture enables direct access to specific thoughts based on relevance to the current prompt, without requiring linear scanning of the entire context history.

The thought cache itself can be structured as a differentiable neural memory, where thoughts are stored as embeddings that can be smoothly updated and combined. This approach enables the cache to learn optimal thought storage and retrieval patterns through experience, adapting its organization to maximize the utility of cached thoughts. The differentiable memory structure supports gradient-based optimization of thought storage and retrieval operations, allowing the system to continuously improve its context management efficiency.

Hybrid architectures combining multiple approaches can leverage the strengths of each method. For example, in one embodiment, the system might employ RNNs for sequential thought processing while using a memory network for long-term storage, or combine transformer attention for recent context with compressed RNN states for historical context. These hybrid approaches enable flexible scaling of context processing based on specific application requirements and resource constraints.

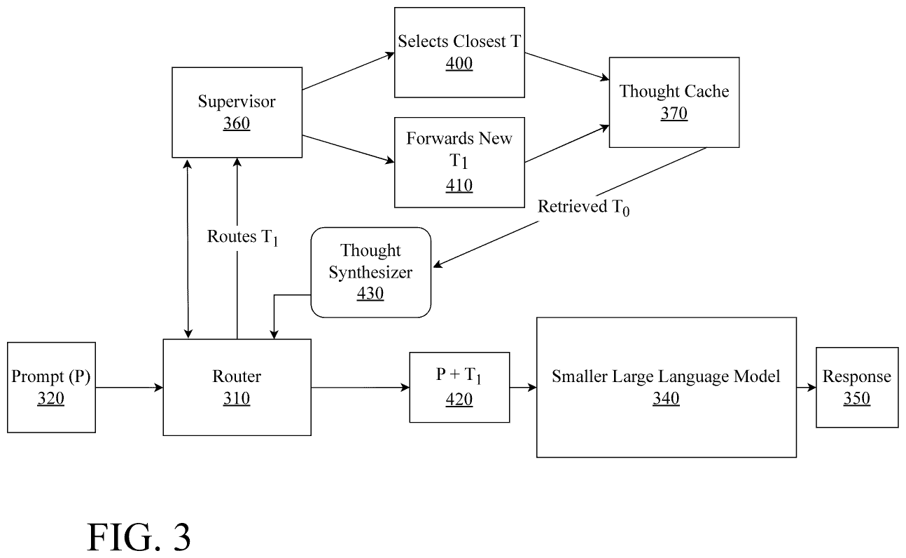

FIG. 3 is a block diagram illustrating an exemplary system architecture for a multi-state LLM with unlimited context with thought synthesis and retrieval. The figure demonstrates how the system handles scenarios where cached thoughts may be relevant but not precisely matched to the current prompt.

The system begins when a prompt (P) 320 is received by the router 310. When router 310 receives a prompt 320, it interacts with the thought cache 370 through the controller 360 to retrieve potentially relevant thoughts.

The controller 360 performs two key functions in this embodiment. First, it selects the closest thought (To) 400 from the cache that relates to the current prompt. Second, after a synthesizer 430 creates a new thought T₁ 410, controller 360 manages the storage of newly synthesized thoughts. The controller evaluates the retrieved T₀ against certain relevance thresholds to determine if synthesis is needed. These thresholds can be configured based on vector similarity scores between the prompt and the cached thought, with different thresholds potentially being set for different domains or use cases. For example, a threshold of 0.8 (on a 0-1 scale) might indicate the thought is relevant enough to use directly, while scores between 0.5-0.8 might trigger synthesis with other related thoughts, and scores below 0.5 might indicate the need to generate entirely new thoughts using the large model. The system can also employ multiple thresholds simultaneously-one for determining if a thought is “close enough” to use directly, another for determining if thoughts are similar enough to be candidates for synthesis, and another for determining if cached thoughts are relevant enough to be considered at all.

The system can assign and append relevance scores and metadata to thoughts in several ways. When a thought (T) is created by the large model, it can be analyzed and scored across multiple dimensions including but not limited to quality assessment metrics, vector embeddings, usage statistics, and domain tags. Quality assessment encompasses the thought's reasoning pattern quality based on its structure and completeness, accuracy scores for verifiable facts, and confidence scores from the model about its conclusions. Vector embeddings can be calculated and stored with each thought, allowing for fast similarity comparisons during cache lookups, with multiple specialized embeddings potentially stored for different aspects like topic, reasoning style, and domain. Usage statistics track metrics such as success rates when the thought is used (including user feedback), frequency of successful reuse, and performance metrics when used with different types of prompts. Domain tags provide additional context through subject matter categorization, specific topic tags, and required expertise level indicators. These scores and metadata can be stored alongside the thought in the cache in a structured format and updated over time based on usage patterns. The comprehensive metadata enables more sophisticated routing and synthesis decisions while allowing the system to improve its thought selection over time through continuous feedback and performance tracking. For instance, a thought might store its general and domain-specific embeddings, various quality and confidence scores, detailed categorization, and usage statistics, all of which can be used to make more informed decisions about when and how to use or synthesize that thought in future operations.

A synthesizer 360 processes T₀ to create a new thought T₁ that better aligns with the current prompt's requirements. For example, if a prompt asks about specific aspects of quantum computing, and T₀ contains general quantum computing concepts, the synthesizer can create a T₁ that focuses more precisely on the specific aspects requested in the prompt.

Thought synthesizer 430 combines and processes thoughts when multiple relevant thoughts are found or when existing thoughts need modification. For example, if one cached thought covers quantum bits and another covers error correction, the synthesizer can combine these into a new thought that addresses quantum computing error rates in qubits. The synthesizer can also adapt existing thoughts to better match current prompt requirements. This synthesis process involves understanding the logical relationships between different thoughts, identifying complementary and conflicting information, and creating coherent combinations that preserve the accuracy and context of the original thoughts. The synthesizer employs various combination strategies depending on the relationship between thoughts—it might perform simple concatenation for complementary thoughts, create hierarchical structures for nested concepts, or generate entirely new bridging content to connect related ideas. Additionally, the synthesizer can evaluate the quality of synthesized thoughts and may generate multiple candidate combinations before selecting the most appropriate one based on relevance scores and coherence metrics.

The synthesizer can work with multiple retrieved thoughts simultaneously, combining relevant aspects from each to create a more comprehensive T₁. For instance, if one cached thought contains information about neural networks and another about computer vision, the synthesizer could combine relevant aspects of both to create a new thought more specifically targeted to a prompt about neural networks in computer vision applications.

The system may implement multiple strategies for thought synthesis, enabling the combination of existing cached thoughts to generate new, contextually relevant thoughts without necessarily engaging the large language model. These synthesis mechanisms operate on both the semantic content and vector representations of thoughts, employing various combination strategies depending on the relationship between thoughts and specific prompt requirements. The fundamental approach builds upon vector-based synthesis, where thoughts are represented in a high-dimensional embedding space that preserves semantic relationships through spatial relationships. In one embodiment, when multiple relevant thoughts are retrieved from the cache, their vector representations can be combined through a plurality of mathematical operations to create new thought vectors. These operations may include but are not limited to weighted averaging where more relevant thoughts receive higher weights in the final combination, vector addition with normalization that preserves the directional information of component thoughts, dimensional projection where thoughts are combined along specific semantic dimensions while preserving others, and non-linear combination using learned transformation matrices.

The system demonstrates this vector-based synthesis through concrete applications. For instance, when processing a prompt that requires information about quantum computing's impact on cryptocurrency, and the cache contains separate thoughts about quantum computing (T₁) and cryptocurrency security (T₂), the system performs a weighted combination expressed as T_new=α*T₁+β*T₂, where a and B represent relevance weights determined by similarity scores between each thought and the prompt. The resulting vector T_new is normalized to maintain consistent magnitude in the embedding space, ensuring that the synthesized thought retains proper proportional representation of its component concepts.

Beyond pure vector operations, the system, in additional embodiments, may employ neural synthesis through a specialized small-scale transformer model trained specifically for thought combination. A neural synthesizer would receive multiple thought vectors as input and generates a new, synthesized thought that captures the relevant aspects of all inputs while maintaining internal consistency. The neural synthesis component is capable of identifying and resolving contradictions between input thoughts, preserving temporal relationships and causal chains, generating bridging content to connect related concepts, and maintaining consistency with the original prompt context. This approach proves particularly valuable when combining thoughts that require subtle understanding of context and implications.

In another embodiment, the system may implement rule-based synthesis through a set of predefined combination patterns based on the logical relationship between thoughts. These patterns support sequential combination for thoughts representing steps in a process, hierarchical combination for thoughts with parent-child relationships, comparative combination for contrasting or parallel thoughts, and supplementary combination for thoughts that provide additional context or examples. The rule-based approach ensures that the structural integrity of thought relationships is preserved during synthesis.

In an embodiment, the system may employ a synthesis quality assessor that evaluates potential thought combinations before they are executed. This assessment examines semantic coherence of the combined thought, preservation of critical information from source thoughts, relevance to the original prompt, and internal consistency of the synthesized thought. The quality assessment process helps prevent the generation and propagation of invalid or inconsistent thought combinations.

In scenarios where multiple synthesis strategies might apply, the system employs a multi-stage synthesis process. This process begins by generating candidate syntheses using different strategies, proceeds to evaluate each candidate using quality metrics, selects the highest-quality synthesis result, and caches the successful synthesis strategy for similar future combinations. This approach ensures optimal synthesis results while building a knowledge base of effective strategies.

The synthesis mechanism supports multiple operation modes including synchronous operation for immediate response requirements, asynchronous operation for background synthesis and cache optimization, and hybrid operation for progressive refinement of synthesized thoughts. This flexibility allows the system to balance response time requirements with synthesis quality needs. Through these synthesis mechanisms, the system can effectively combine and evolve cached thoughts to address new prompts without always requiring the computational overhead of the large language model, while maintaining the quality and relevance of generated responses.

Once T₁ is created, it is combined with the original prompt to form P+T₁ 420, which is then processed by the smaller language model 340 to generate the final response 350. The newly synthesized T₁ is also routed back through the controller for potential caching with thought cache 370, allowing it to be used for future similar prompts.

In one embodiment, thought cache 370 provides performance improvements by eliminating redundant reasoning computations across similar prompts. When 310 router identifies a new prompt with reasoning requirements similar to previously processed queries, thought cache 370 can supply validated thought patterns rather than requiring the large language model to reconstruct the reasoning chain from scratch. This caching mechanism is particularly effective for common analytical patterns, such as mathematical derivations, logical deductions, or standard analytical frameworks that appear frequently across different prompts.

Additionally, thought cache 370 is capable of serving as a quality assurance mechanism by maintaining verified reasoning patterns. Once a thought sequence has been validated and demonstrates consistent success in generating accurate responses, that sequence becomes a trusted template for handling similar queries. For instance, when processing mathematical problems, the cache may contain verified proof structures that can be applied to new problems within the same class, ensuring consistent and reliable solution approaches.

In one embodiment, thought cache 370 implements a validation scoring system that tracks the success rate and reliability of each cached thought. This scoring considers factors such as but not limited to response accuracy, user feedback, and consistency with known truth standards. Thoughts that consistently contribute to high-quality responses receive higher validation scores, making them more likely to be selected for reuse in similar contexts. The cache can also mark certain thoughts as “golden” references when they demonstrate exceptional reliability in specific domains, establishing them as preferred reasoning patterns for their respective problem types.

To prevent the propagation of incorrect reasoning, thought cache 370 may employ a continuous validation mechanism. This mechanism monitors the performance of cached thoughts and can automatically flag patterns that lead to inconsistent or incorrect responses. When potential issues are detected, thought cache 370 may temporarily suspend the use of problematic thoughts and route similar prompts through the large language model for fresh analysis. This self-correction capability ensures that the efficiency benefits of thought caching do not come at the expense of response quality.

Thought cache 370 is capable of supporting selective thought inheritance, where new prompts can partially inherit validated reasoning patterns while allowing for context-specific modifications. This flexibility enables the system to leverage proven reasoning frameworks while adapting them to specific query requirements, combining the benefits of cached reliability with contextual relevance. Through these mechanisms, the thought cache achieves both performance optimization and quality enhancement, delivering faster responses while maintaining or improving the reliability of the system's outputs.

Through this synthesis process, the system can effectively leverage partially relevant cached thoughts to create more precise and relevant thoughts for the current prompt, reducing the need to engage the large language model while still maintaining response quality and relevance.

In another embodiment, thought cache 370 implements security and privacy controls to protect sensitive information while enabling efficient thought reuse. At the storage level, thought cache 370 maintains isolation between user contexts through encrypted partitioning. Each user's thoughts are encrypted with user-specific keys, ensuring that even within shared cache infrastructure, thoughts remain securely compartmentalized. This encryption extends to both the thought content and the associated metadata, preventing unauthorized access to reasoning patterns that might reveal proprietary information.

In the embodiment, thought cache 370 implements a permissions framework that governs thought sharing and reuse. By default, thoughts derived from user interactions are marked private and restricted to the originating user's context. Users can optionally designate specific thoughts for shared use through explicit consent mechanisms. When thoughts are marked for sharing, the cache employs automated sanitization processes that strip personally identifiable information and sensitive data while preserving the underlying reasoning patterns. This sanitization uses advanced pattern recognition to identify and remove context-specific details while maintaining the thought's utility for general reasoning.

To protect against cache poisoning attacks, thought cache 370 may incorporate a multi-stage validation pipeline. Before any thought is cached, it undergoes verification through a separate validation model that assesses its logical consistency and checks for potential malicious patterns. The cache maintains cryptographic checksums of validated thoughts, enabling rapid verification of thought integrity during retrieval operations. Additionally, the cache tracks the provenance of each thought, maintaining secure audit trails of thought creation, modification, and usage patterns.

The system implements graduated access controls that can restrict thought reuse based on security clearance levels, organizational boundaries, or specific sharing agreements. These controls allow enterprises to maintain separate thought caches for different security domains while selectively enabling thought sharing under controlled conditions. For instance, a financial institution might maintain separate caches for public customer service interactions and privileged internal analyses, with strict controls governing any cross-domain thought utilization.

Through these security mechanisms, the thought cache enables efficient reasoning reuse while protecting sensitive information and maintaining system integrity. The combination of encryption, access controls, and validation processes ensures that the performance benefits of thought caching do not compromise security or privacy requirements.

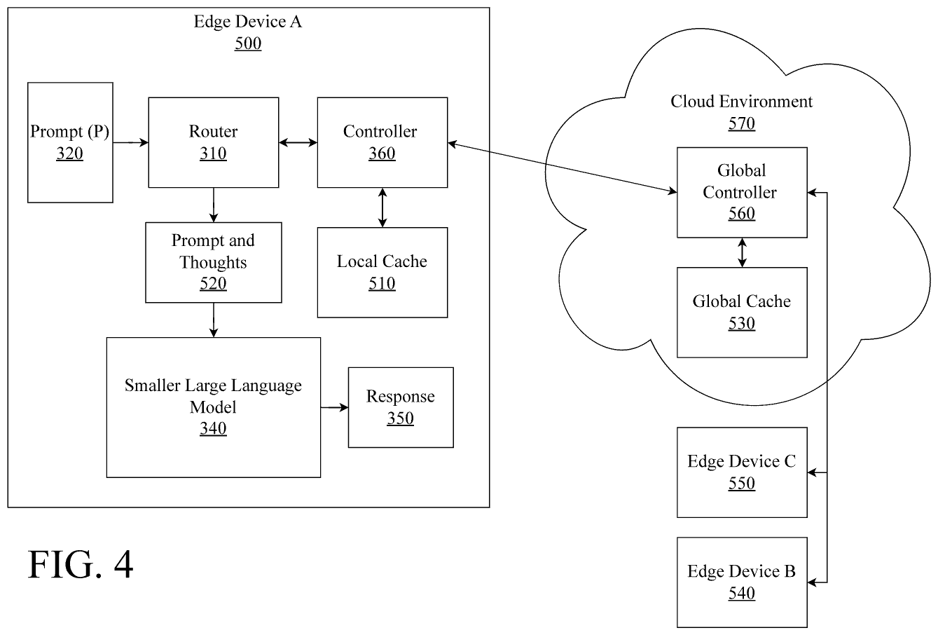

FIG. 4 is a block diagram illustrating an exemplary system architecture for a multi-state LLM with unlimited context with local and global thought caches. This embodiment demonstrates how the system can operate primarily on edge devices while maintaining access to a broader knowledge base through cloud connectivity.

Edge device A 500 represents a complete edge implementation of the system, which could be a device such as but not limited to a mobile phone, tablet, or other personal computing device. Within the edge device 500, router 310 receives prompts (P) 320 and coordinates with a local controller 360 and local cache 510. Local cache 510 stores frequently accessed or personally relevant thoughts directly on the device, enabling quick access and offline functionality.

The smaller language model 340 runs directly on the edge device, processing prompt and thought combinations 520 to generate responses 350. This local processing capability significantly reduces latency and computational requirements compared to constantly accessing cloud resources.

The cloud environment 570 contains a global cache 530 managed by a global controller 560. This global infrastructure serves as a centralized repository for thoughts generated across multiple edge devices (B 540, C 550). The global controller coordinates cache synchronization and manages access patterns across the network of connected devices.

When an edge device's controller 360 cannot find relevant thoughts in its local cache 510, it can query the global controller 560 to search the global cache 530. For example, if a user on edge device A 500 asks a question about a topic they haven't encountered before, the system first checks the local cache 510, then can reach out to the global cache 530 for relevant thoughts.

The system supports bi-directional synchronization, where new thoughts generated on edge devices can be uploaded to the global cache, and frequently accessed global thoughts can be downloaded to local caches. This creates a dynamic knowledge-sharing environment while maintaining efficient local operation.

Through this architecture, the system provides the benefits of edge computing (low latency, offline capability, privacy) while maintaining access to a broader knowledge base through the cloud infrastructure. The distributed nature of the system allows for efficient scaling and knowledge sharing across user communities while minimizing the computational load on individual devices.

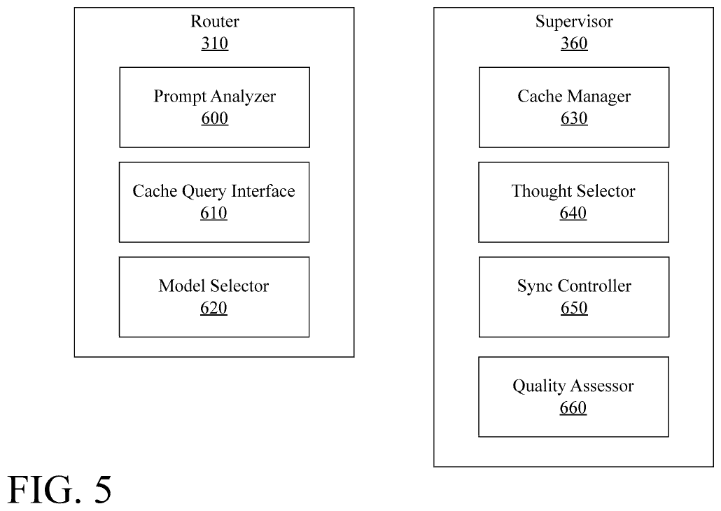

FIG. 5 is a block diagram illustrating exemplary components for a multi-state LLM with unlimited context, a router and a controller. A prompt analyzer 600 processes incoming prompts to determine their characteristics, domain, and requirements. For example, if a user submits a prompt about quantum computing, the analyzer identifies key technical terms, determines the complexity level, and flags specific concepts that may need specialized thoughts. It also evaluates whether the prompt requires reasoning about multiple concepts (like quantum computing and machine learning) that might benefit from thought synthesis. Analyzer 600 employs natural language processing to break down the prompt into component parts, identifying primary topics, subtopics, relationships between concepts, required depth of knowledge, and any constraints or special requirements specified in the prompt. It can also detect the tone and style of the desired response, technical sophistication level of the user, and whether the prompt requires factual recall, analytical reasoning, or creative synthesis.

A cache query interface 610 serves as the communication bridge between the router and cache systems. It formats prompt analysis results into efficient cache queries and manages the retrieval process. For instance, when searching for thoughts about quantum computing, it might query both technical definition thoughts and practical application thoughts, managing multiple parallel cache requests to both local and global caches. The interface optimizes query patterns based on the analyzer's output, constructing sophisticated search parameters that account for concept hierarchies, semantic relationships, and contextual relevance. It can prioritize different aspects of the query based on importance, manage query timeouts and fallbacks, and handle distributed cache architectures efficiently. The interface also implements caching strategies to optimize frequent queries and manages cache coherence between local and global storage.

A model selector 620 makes intelligent decisions about model utilization based on cache results and prompt analysis. It implements decision logic to determine whether to: use the large model for new thought generation, proceed with cached thoughts through the smaller model, or employ a hybrid approach. For example, if highly relevant thoughts exist in the cache, it might bypass the large model entirely to save computational resources. In one embodiment, model selector 620 employs decision trees and heuristics that consider multiple factors including thought relevance scores, computational resource availability, response time requirements, and quality thresholds. It can dynamically adjust its selection criteria based on system load, cache hit rates, and historical performance metrics. Model selector 620 also maintains statistics about the effectiveness of its decisions to continuously refine its selection strategy and may implement different selection policies based on user preferences or application requirements.

A cache manager 630 handles the organization, storage, and retrieval of thoughts in both local and global caches. It implements indexing strategies for quick thought retrieval and manages cache memory efficiently. For example, it might maintain separate indices for different knowledge domains or implement priority-based storage systems where frequently accessed thoughts are kept in faster memory. Cache manager 630 implements eviction policies to optimize cache utilization, considering factors such as but not limited to thought frequency of use, recency, size, and interdependencies with other cached thoughts. It also handles cache coherence between local and global stores, implements versioning and conflict resolution for distributed caches, and maintains metadata about cache performance and utilization patterns. The manager can dynamically adjust its caching strategies based on usage patterns and system resources, potentially implementing different policies for different types of thoughts or knowledge domains.

A thought selector 640 implements algorithms to identify and select the most relevant thoughts from the cache. It uses similarity metrics and relevance scoring to rank cached thoughts based on their applicability to the current prompt. For instance, when processing a prompt about quantum computing applications in cryptography, it might prioritize thoughts that bridge both quantum and cryptographic concepts. Thought selector 640 may employ multiple ranking algorithms that consider various aspects of thought relevance, including semantic similarity, contextual appropriateness, freshness, and historical success rates. It can perform multi-stage selection processes, first identifying broadly relevant thoughts and then refining the selection based on more specific criteria. The selector also considers relationships between thoughts, potentially selecting groups of related thoughts that together provide comprehensive coverage of the prompt's requirements. It maintains performance metrics about selection accuracy and can adapt its selection criteria based on feedback about the effectiveness of selected thoughts in generating successful responses.

A sync controller 650 manages the complex task of synchronizing thoughts between local and global caches. It implements policies for when to upload local thoughts to the global cache and when to download global thoughts to local storage. For example, it might upload locally generated thoughts about emerging technologies to the global cache while downloading commonly accessed thoughts about fundamental concepts to local storage. Sync controller 650 may employ synchronization strategies that balance network bandwidth usage, storage constraints, and data freshness requirements. It implements conflict resolution mechanisms for handling simultaneous updates, version control for tracking thought evolution, and differential synchronization to minimize data transfer. Sync controller 650 can adapt its sync frequency and policies based on usage patterns, network conditions, and device capabilities. It also maintains detailed synchronization logs and metrics to optimize future sync operations and implements recovery mechanisms for handling failed synchronization attempts. Additionally, sync controller 650 can prioritize synchronization tasks based on thought importance, urgency, and resource availability.

A quality assessor 660 continuously evaluates thought quality and usefulness. It monitors factors such as thought relevance, accuracy, and usage patterns to maintain cache quality. For example, if certain thoughts consistently lead to high-quality responses (as measured by user feedback or other metrics), they might be prioritized for retention and synchronization. Conversely, thoughts that rarely prove useful might be flagged for removal or update. Quality assessor 660 may employ multiple evaluation criteria including syntactic correctness, semantic coherence, factual accuracy, and practical utility. It maintains historical performance metrics for each thought, tracking success rates in different contexts and user satisfaction levels. Quality assessor 660 can detect outdated or inconsistent thoughts, identify redundant thoughts that could be merged, and flag thoughts that may need revision due to changing knowledge or requirements. It implements adaptive quality thresholds that can vary based on thought domain, importance, and usage context. Quality assessor 660 also provides detailed quality reports that can be used to guide cache maintenance operations and thought synthesis decisions, and it can trigger automatic thought improvement processes when quality metrics fall below acceptable thresholds.

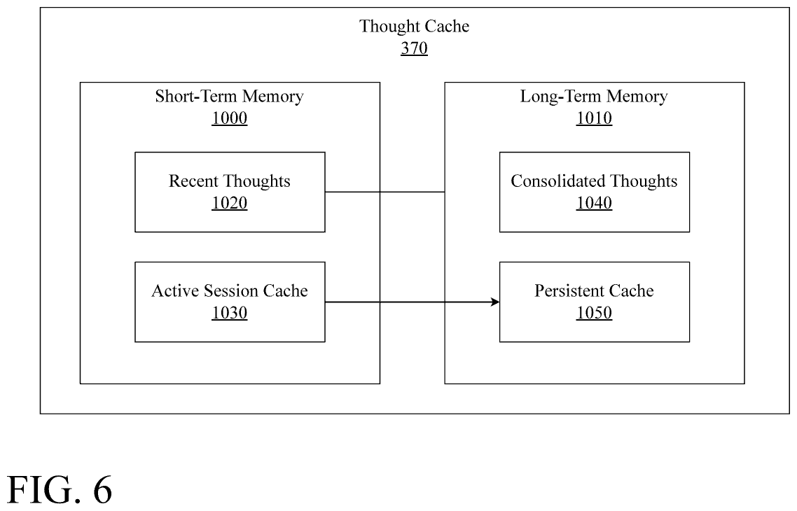

FIG. 6 is a block diagram illustrating an exemplary system architecture of a thought cache that has both a long-term memory and a short-term memory. In one embodiment, thought cache 370 represents a system for maintaining effectively unlimited context in language models through progressive compression and intelligent caching of thought patterns, enabling shared reasoning across multiple AI instances.

Thought cache 370 implements both a short-term memory 1000 and a long-term memory 1010. This dual-memory architecture enables the system to maintain both immediate computational context and historical reasoning patterns while managing computational resources efficiently.

The short-term memory 1000 comprises recent thoughts 1020 and an active session cache 1030. Recent thoughts 1020 maintain complete thought fidelity, storing both the explicit reasoning chains and the internal model states that generated them. This storage preserves not only the textual representation of thoughts but also the computational context and attention patterns that produced them, enabling precise replication of reasoning processes. The active session cache 1030 provides rapid access to these thoughts and their associated states, optimizing performance for ongoing interactions and enabling immediate thought sharing between different AI instances or specialized reasoning modules operating within the same session.

The long-term memory 1010 implements a more sophisticated storage approach through consolidated thoughts 1040 and a persistent cache 1050. Consolidated thoughts 1040 represent progressively compressed versions of thought patterns, where multiple related thoughts are combined into more compact representations while preserving essential reasoning patterns. This consolidation process employs various compression techniques, including attention-based compression, semantic clustering, and state space reduction. The persistent cache 1050 implements an indexed storage system that enables semantic search and retrieval of these consolidated thoughts, supporting efficient thought sharing across different AI instances and computing sessions.

The system implements bidirectional information flow between these components. Thoughts can move from recent thoughts 1020 to consolidated thoughts 1040 through progressive compression, while the active session cache 1030 can transfer frequently accessed patterns to the persistent cache 1050 for long-term retention. This bidirectional flow enables dynamic thought sharing between different system components and AI instances, supporting collaborative reasoning across multiple agents.

The architecture supports multiple implementation approaches for thought storage and transfer. Thoughts can be stored as chain-of-thought text, internal model states, attention patterns, or hybrid representations combining multiple formats. The system can dynamically select the most appropriate storage format based on the thought's intended use and the capabilities of the AI instances that may access it.

This architectural design enables the thought cache to serve as a central memory system for multiple AI instances, supporting collaborative reasoning while maintaining computational efficiency. The combination of short-term and long-term memory systems, along with progressive compression and flexible thought representation, allows the system to maintain effectively unlimited context while enabling efficient thought sharing across different AI agents and reasoning modules.

Through this architecture, the system achieves both unbounded context maintenance and efficient cross-instance thought sharing, two key innovations that enable more sophisticated and resource-efficient AI reasoning systems. The design's flexibility in implementation approaches and storage formats helps prevent trivial circumvention while enabling broad application across different types of language models and AI systems.

In one embodiment the system implements a collaborative thought sharing architecture that enables multiple AI agents to access and utilize a common thought cache. This shared cache architecture supports distributed reasoning across different types of language models and specialized reasoning modules while maintaining thought consistency and accessibility. When multiple users or AI agents operate within the system, they can all contribute to and benefit from the accumulated reasoning patterns stored in the shared cache.

The shared thought cache maintains a unified index that enables any authorized user or AI agent to access relevant thoughts regardless of which agent originally generated them. This indexing system tracks not only the content of thoughts but also their originating context, generating agent, and successful usage patterns. For example, when a specialized mathematical reasoning module generates a thought containing a proof strategy, that thought becomes available to general language models handling related mathematical queries, enabling them to leverage expert reasoning patterns without duplicating the computational effort.

Thought transfer between specialized reasoning modules occurs through a standardized thought protocol. This protocol defines how thoughts are packaged, transmitted, and unpacked between different types of AI agents. When transferring thoughts, the system includes not just the reasoning content but also relevant metadata such as the thought's context requirements, assumptions, and compatibility markers. For instance, if a natural language processing agent generates insights about sentence structure, these thoughts can be transferred to a grammar checking module in a format that preserves the structural analysis while adapting it to the specialized module's processing requirements.

The system coordinates collaborative reasoning through a central orchestration mechanism. This orchestrator tracks which agents are actively processing related prompts and manages the flow of thoughts between them. When multiple agents encounter similar reasoning requirements, the orchestrator can initiate thought sharing to prevent redundant computation. For example, if one agent has already performed detailed analysis of a complex concept, other agents can build upon that analysis rather than repeating it.

Cross-instance reasoning is enabled through thought synthesis capabilities. When different model instances approach similar problems from different angles, their thoughts can be combined to create more comprehensive understanding. The system tracks the complementary strengths of different model instances and can route thoughts to the most appropriate agent for specific types of reasoning tasks. For instance, a general language model might handle initial prompt analysis, while specialized agents process domain-specific aspects, with their combined thoughts contributing to the final response.

The shared cache implements sophisticated access control and version management to maintain thought integrity across multiple agents. Each thought is versioned to track its evolution as different agents interact with and build upon it. The system maintains provenance information that records how thoughts are transformed and combined through multi-agent collaboration, enabling attribution and quality assessment of collaborative reasoning patterns.

Through these mechanisms, the system enables efficient distribution of reasoning tasks across specialized modules while maintaining coherent thought flow. The collaborative architecture allows different AI agents to contribute their specialized capabilities while benefiting from the collective reasoning capacity of the system. This approach significantly reduces computational redundancy while enabling more sophisticated reasoning through the combination of multiple specialized perspectives.

### Conceptual Architecture of Large Codeword Model for Deep Learning

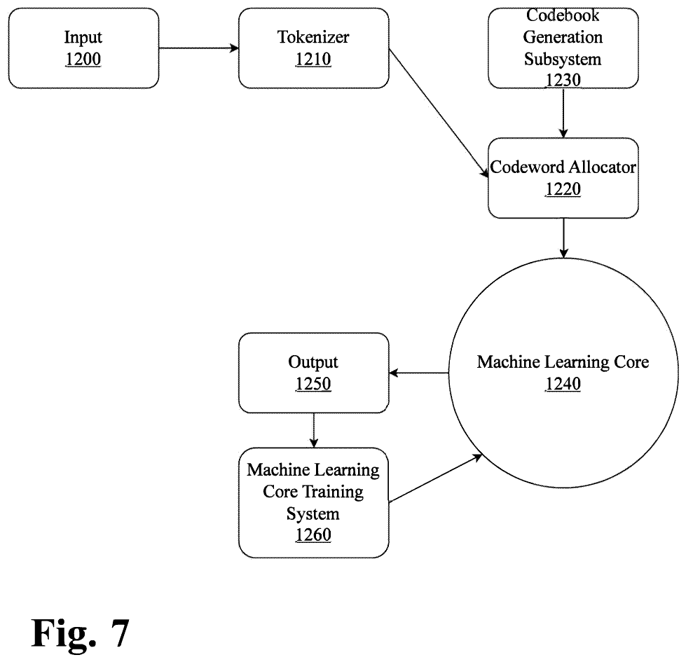

FIG. 7 is a block diagram illustrating an exemplary system architecture for a large codeword model for deep learning. An input 1200 represents the raw data that needs to be processed by the LCM. This data can be in various modalities, such as text, images, audio, time series, or any other structured or unstructured format. The input data is fed into the tokenizer 110 for further processing.

A tokenizer 1210 is responsible for splitting the input data into meaningful semantic units called sourceblocks. This process, known as semantic splitting, aims to capture the inherent structure and patterns in the data. The tokenizer can employ various techniques to identify the optimal sourceblocks, such as rule-based splitting, statistical methods, or machine learning approaches. For textual data, the tokenizer may use subword tokenization methods like Byte-Pair Encoding (BPE) or WordPiece, which break down words into smaller, more frequently occurring units. For images, the tokenizer may use approaches such as but not limited to a patch-approach, where the image is divided into fixed-size patches or regions. The specific tokenization method can be chosen based on the data modality and the characteristics of the domain. For example, the first paragraph of Leo Tolstoy's War and Peace which reads, “Well, Prince, so Genoa and Lucca are now just family estates of the Buonapartes,” may be tokenized into [‘Well’, ‘,’, ‘Prince’, ‘,’, ‘so’, ‘Gen’, ‘oa’, ‘and’, ‘Luc’, ‘ca’, ‘are’, ‘now’, ‘just’, ‘family’, ‘estates’, ‘of’, ‘the’, ‘Buon’, ‘apar’, ‘tes’, ‘.’].

In one embodiment, the tokenizer may utilize Huffman coding to split the data into sourceblocks. The Huffman coding-based tokenizer enables efficient and semantically meaningful splitting of the input data into sourceblocks. Huffman coding is a well-known data compression algorithm that assigns variable-length codes to symbols based on their frequency of occurrence. In the context of the LCM, the Huffman coding-based tokenizer adapts this principle to perform semantic splitting of the input data.

With Huffman coding, the tokenizer starts by analyzing the input data and identifying the basic units of meaning, such as words, phrases, or subwords, depending on the specific data modality and the desired level of granularity. These basic units form the initial set of sourceblocks. The tokenizer then performs a frequency analysis of the sourceblocks, counting the occurrences of each sourceblock in the input data. Based on the frequency analysis, the tokenizer constructs a Huffman tree, which is a binary tree that represents the probability distribution of the sourceblocks. The Huffman tree is built by iteratively combining the two least frequent sourceblocks into a single node, assigning binary codes to the branches, and repeating the process until all sourceblocks are included in the tree. The resulting Huffman tree has the property that sourceblocks with higher frequencies are assigned shorter codes, while sourceblocks with lower frequencies are assigned longer codes.

The Huffman coding-based tokenizer then uses the constructed Huffman tree to perform semantic splitting of the input data. It traverses the input data and matches the sequences of symbols against the sourceblocks represented in the Huffman tree. When a sourceblock is identified, the tokenizer assigns the corresponding Huffman code to that sourceblock, effectively compressing the data while preserving its semantic structure. The use of Huffman coding for semantic splitting offers several advantages. It allows for variable-length sourceblocks, enabling the tokenizer to capture meaningful units of varying sizes. This is particularly useful for handling data with different levels of complexity and granularity, such as text with compound words or images with hierarchical structures.

A Huffman coding-based approach optimizes the representation of the sourceblocks based on their frequency of occurrence. By assigning shorter codes to more frequent sourceblocks and longer codes to less frequent ones, the tokenizer achieves data compression while still preserving the semantic information. This compression reduces the overall size of the data and improves the efficiency of subsequent processing stages. Additionally, the Huffman tree construction process inherently captures the statistical properties and patterns within the input data. The resulting sourceblocks and their assigned codes reflect the underlying structure and relationships present in the data. This semantic awareness enhances the ability of the LCM to learn and generate meaningful representations.

After the semantic splitting process, the resulting sourceblocks and their assigned Huffman codes are passed to the codeword allocator. The codeword allocator maps each sourceblock to a unique codeword, which is a compact representation used by the subsequent components of the LCM architecture. The codeword mapping can be based on various schemes, such as a fixed-length binary encoding or a learned embedding space.

Once the input data is tokenized into sourceblocks, the codeword allocator 120 assigns a unique codeword to each sourceblock. The codewords are discrete, compressed representations of the sourceblocks, designed to capture the essential information in a compact form. The codeword allocator can use various mapping schemes to assign codewords to sourceblocks, such as hash functions, lookup tables, or learned mappings. For example, a simple approach could be to use a hash function that maps each sourceblock to a fixed-length binary code. Alternatively, another approach may involve learning a mapping function that assigns codewords based on the semantic similarity of the sourceblocks.

The codebook generation subsystem 130 is responsible for creating and maintaining the codebook, which is a collection of all the unique codewords used by the LCM. The codebook can be generated offline, before the actual processing begins, or it can be updated dynamically as new sourceblocks are encountered during processing. The codebook generation subsystem can use various techniques to create a compact and efficient codebook, such as frequency-based pruning, clustering, or vector quantization. The size of the codebook can be adjusted based on the desired trade-off between compression and information preservation. Going back to the War and Peace example, the string of tokens [′Well′, ‘,’, ‘Prince’, ‘,’, ‘so’, ‘Gen’, ‘oa’, ‘and’, ‘Luc’, ‘ca’, ‘are’, ‘now’, ‘just’, ‘family’, ‘estates’, ‘of’, ‘the’, ‘Buon’, ‘apar’, ‘tes’, ‘.’] may be given codewords such as [12, 5, 78, 5, 21, 143, 92, 8, 201, 45, 17, 33, 49, 62, 87, 11, 2, 179, 301, 56, 4], where each token is assigned a unique codeword, which is represented as an integer. The mapping between tokens and codewords is determined by the codebook generated by the LCM system.

The machine learning core 1240 is the central component of the LCM architecture, where the actual learning and processing take place. The core operates on the codewords generated by the codeword allocator, learning to process, generate, and manipulate the compressed representations. The machine learning core can be implemented using various configurations, depending on the specific task and data modality. Some possible variations include:

In one embodiment, the machine learning core 1240 may be a Transformer-based core. The Transformer-based core consists of several key components. An embedding layer maps the codewords to dense vector representations, capturing their semantic and syntactic properties. Positional encoding is used to incorporate positional information into the codeword embeddings, enabling the Transformer to distinguish the relative positions of the codewords in the input sequence. The multi-head attention mechanism, which is the core building block of the Transformer, allows the model to attend to different parts of the input sequence simultaneously, capturing complex dependencies and relationships between codewords. Feed-forward networks are used to introduce non-linearity and increase the expressive power of the model. Residual connections and layer normalization are employed to facilitate the flow of information and stabilize the training process.

The Transformer-based core can be implemented using an encoder-decoder architecture. The encoder processes the input codewords and generates contextualized representations, while the decoder takes the encoder's output and generates the target codewords or the desired output sequence. The encoder and decoder are composed of multiple layers of multi-head attention and feed-forward networks, allowing for deep and expressive processing of the codeword representations.

One of the key advantages of the Transformer-based core in the LCM architecture is its ability to capture long-range dependencies between codewords. Unlike recurrent neural networks (RNNs), which process the input sequentially, the Transformer can attend to all codewords in parallel, enabling it to effectively capture relationships and dependencies that span across the entire input sequence. This is useful for processing long and complex data sequences, where capturing long-range dependencies is crucial for understanding the overall context. Another advantage of the Transformer-based core is its parallelization capability. The self-attention mechanism in the Transformer allows for efficient parallel processing of the codewords on hardware accelerators like GPUs. This parallelization enables faster training and inference times, making the LCM architecture suitable for processing large amounts of data in real-time applications.

The Transformer-based core also generates contextualized representations of the codewords, where each codeword's representation is influenced by the surrounding codewords in the input sequence. This contextualization allows the model to capture the semantic and syntactic roles of the codewords based on their context, enabling a deeper understanding of the relationships and meanings within the data. The scalability of the Transformer-based core is another significant advantage in the LCM architecture. By increasing the number of layers, attention heads, and hidden dimensions, the Transformer can learn more complex patterns and representations from large-scale datasets. This scalability has been demonstrated by models like GPT-3, which has billions of parameters and can perform a wide range of tasks with impressive performance.

In another embodiment, the machine learning core 1240 may utilize a Variational Autoencoder (VAE)-based core. A VAE-based core consists of two main components: an encoder and a decoder. The encoder takes the codewords as input and maps them to a lower-dimensional latent space representation. The encoder is typically implemented as a neural network, such as a multi-layer perceptron (MLP) or a convolutional neural network (CNN), depending on the nature of the codewords and the data modality. The encoder learns to compress the codewords into a compact latent representation while capturing the essential features and relationships within the data.

The decoder, on the other hand, takes the latent space representation and reconstructs the original codewords. The decoder is also implemented as a neural network, typically the inverse architecture of the encoder. The decoder learns to map the latent space representation back to the codeword space, generating codewords that closely resemble the original input. One of the key advantages of the VAE-based core in the LCM architecture is its ability to learn a continuous and structured latent space representation of the codewords. The latent space captures the underlying patterns and relationships within the data, allowing for smooth interpolation and generation of new codewords. By sampling from the latent space, the VAE-based core can generate novel and meaningful codewords that are similar to the original data distribution.

The VAE-based core also enables efficient compression of the codewords. By encoding the codewords into a lower-dimensional latent space, the VAE reduces the storage and computational requirements of the LCM. The compact latent representation can be used for various downstream tasks, such as data compression, similarity search, or data generation. The VAE-based core in the LCM architecture offers several advantages over traditional data processing techniques. It enables the learning of a compact and expressive latent representation of the codewords, capturing the essential features and relationships within the data. The continuous latent space allows for smooth interpolation and generation of new codewords, enabling tasks such as data augmentation, anomaly detection, and creative content generation.

The LCM architecture with the VAE-based core has a wide range of applications across various domains. In natural language processing, it can be used for tasks such as language modeling, text generation, and text compression. In computer vision, the VAE-based core can be applied to image compression, image generation, and unsupervised representation learning. The architecture can also be used for audio and speech processing, where the codewords represent audio features, enabling tasks such as audio compression, speech synthesis, and music generation.

In another embodiment, the machine learning core 1240 may be a Recurrent Neural Network (RNN)-based core. The RNN-based core consists of one or more recurrent layers, such as Long Short-Term Memory (LSTM) or Gated Recurrent Unit (GRU) layers. These recurrent layers maintain an internal state that allows them to remember and process information from previous time steps, enabling the capture of long-term dependencies and context within the codeword sequences.

The RNN-based core takes a sequence of codewords as input and processes them one at a time. At each time step, the RNN-based core updates its internal state based on the current input codeword and the previous state. This allows the core to learn and encode the temporal dependencies and patterns within the codeword sequences.

The RNN-based core can be used for various tasks, such as codeword sequence prediction, codeword generation, and sequence-to-sequence mapping. In codeword sequence prediction, the RNN-based core learns to predict the next codeword in a sequence given the previous codewords. This enables tasks such as language modeling, time series forecasting, and predictive maintenance.

In codeword generation, the RNN-based core can be trained to generate new codeword sequences based on a learned probability distribution. By sampling from this distribution, the core can generate novel and coherent codeword sequences that resemble the training data. This has applications in tasks such as text generation, music composition, and synthetic data generation. Sequence-to-sequence mapping involves using two RNN-based cores, an encoder and a decoder, to map an input codeword sequence to an output codeword sequence. The encoder RNN processes the input sequence and generates a fixed-length context vector that captures the essential information. The decoder RNN takes the context vector and generates the output codeword sequence step by step. This architecture has been successfully applied to tasks such as machine translation, speech recognition, and image captioning.

The RNN-based core in the LCM architecture offers several advantages over traditional data processing techniques. It enables the capture and modeling of temporal dependencies and sequential patterns within the codeword sequences, which is crucial for processing and generating sequential data. The RNN-based core can learn and adapt to the specific characteristics and patterns of the data, allowing for more accurate and contextually relevant processing and generation. Furthermore, the RNN-based core can handle variable-length sequences, making it suitable for processing data with different lengths and temporal resolutions. The recurrent nature of the RNN allows it to maintain and propagate information over long sequences, enabling the capture of long-term dependencies and context.

In another embodiment, the core can be implemented as a hybrid of multiple architectures, combining the strengths of different approaches. For example, a Transformer-VAE hybrid can be used, where the Transformer encoder generates contextualized representations of the codewords, and the VAE decoder generates new codewords based on the learned latent space. The specific choice of the machine learning core can be tailored to the requirements of the task and the characteristics of the data. The modular nature of the LCM architecture allows for easy experimentation and adaptation of different core configurations.

After processing the codewords, the machine learning core generates the output 150 in the desired format. The output can be in the form of codewords, which can be mapped back to the corresponding sourceblocks or tokens using the inverse mapping scheme. Alternatively, the output can be directly generated in the target modality, such as text, images, or audio, depending on the specific application.

The LCM architecture offers several advantages over traditional deep learning approaches. By operating on compressed codewords instead of raw tokens, the LCM can reduce the computational and memory requirements, making it more efficient and scalable. The semantic splitting and codeword representation also allow the LCM to capture the inherent structure and patterns in the data, enabling more effective learning and generalization. Moreover, the modular nature of the LCM architecture allows for easy adaptation to different data modalities and tasks, making it a versatile and flexible framework for various applications.

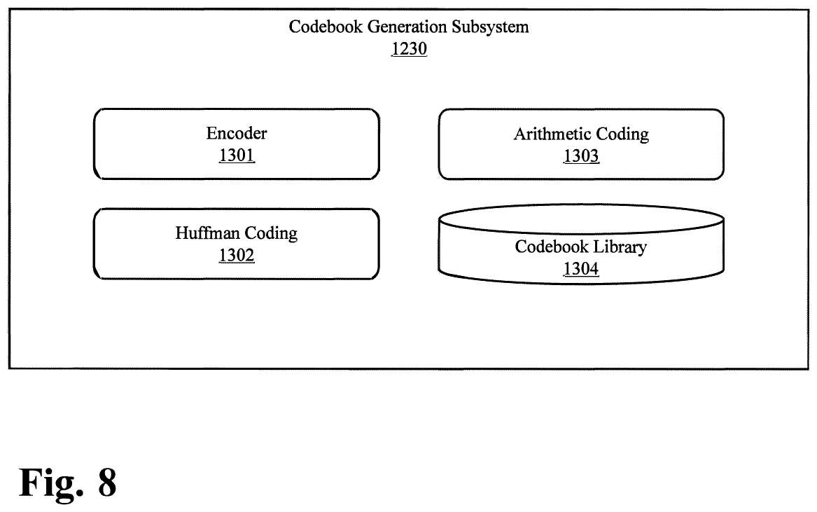

FIG. 8 is a block diagram illustrating an aspect of system and method for a large codeword model for deep learning, a codeword generation subsystem. According to the aspect, codebook generation subsystem 1230 is configured to generate one or more codebooks for a collection of input data using various techniques, such as Huffman coding or arithmetic coding.

The codebook is an important component of the codebook-based homomorphic compression system. According to the embodiment, it is a collection of codewords, where each codeword corresponds to a sourceblock in the tokenized input. The codebook may generated based on the frequency distribution of the tokenized inputs, assigning shorter codewords to more frequently occurring tokens and longer codewords to less frequent tokens. There are several techniques for generating the codebook, with the goal of minimizing the average codeword length while maintaining the uniqueness of the codewords. Two common techniques are Huffman coding 1302 and arithmetic coding 1303. Huffman coding 1302 is a variable-length coding technique that assigns codewords based on the frequency of occurrence of each symbol (sourceblock). It constructs a binary tree, known as the Huffman tree, where each leaf node represents a symbol and the path from the root to the leaf determines the codeword. More frequent symbols are assigned shorter codewords, while less frequent symbols receive longer codewords. Huffman coding guarantees an optimal prefix code, meaning no codeword is a prefix of any other codeword. For example, consider the quantized temperature data from the previous example. Let's say the frequency distribution of the intervals is as follows:
Sourceblock 0: 5%
Sourceblock 1: 10%
Sourceblock 2: 20%
Sourceblock 3: 15%
Sourceblock 4: 50%

Using Huffman coding, the codebook generation subsystem 1230 can generate the following codebook:
Sourceblock 0: 1100
Sourceblock 1: 101
Sourceblock 2: 00
Sourceblock 3: 01
Sourceblock 4: 11

The most frequent tokenized input (Sourceblock 4) receives the shortest codeword (11), while the least frequent tokenized input (Sourceblock 0) receives the longest codeword (1100).

Arithmetic coding 1303 is another entropy coding technique that assigns codewords to sourceblocks based on their probability distribution. Unlike Huffman coding, arithmetic coding does not assign fixed codewords to symbols. Instead, it represents the entire message as a single fractional number between 0 and 1. The interval [0, 1) is recursively divided based on the probabilities of the symbols, and the final codeword is a binary fraction that falls within the subinterval corresponding to the entire message. Arithmetic coding achieves near-optimal compression rates but requires more computational complexity compared to Huffman coding. For example, using the same quantized temperature data and frequency distribution as before, arithmetic coding would assign subintervals to each symbol based on their probabilities:
Sourceblock 0: [0.00, 0.05)
Sourceblock 1: [0.05, 0.15)
Sourceblock 2: [0.15, 0.35)
Sourceblock 3: [0.35, 0.50)
Sourceblock 4: [0.50, 1.00)

To encode a message sequence like [Sourceblock 4, Sourceblock 2, Sourceblock 1], arithmetic coding would recursively subdivide the interval [0, 1) based on the probabilities of the symbols, resulting in a final subinterval. The codeword would be a binary fraction that lies within this final subinterval.

According to an embodiment, an encoder component 1301 is present and configured to implement one or more deep learning techniques for generating codewords for quantized data. Deep learning techniques can be employed to generate effective codewords for the quantized data. One approach is to use deep learning-based autoencoder models to learn compact and meaningful representations of the quantized data. Autoencoders are neural network architectures that consist of an encoder and a decoder, where the encoder learns to compress the input data into a lower-dimensional latent space, and the decoder reconstructs the original data from the latent representation.

Here are a few exemplary deep learning encoding techniques that can be implemented for creating codewords of the quantized data, according to an embodiment. Convolutional autoencoders (CAEs) leverage convolutional neural networks (CNNs) in the encoder and decoder parts of the autoencoder. CNNs are particularly effective in capturing spatial dependencies and hierarchical features in data, making them well-suited for encoding structured data such as images or time series. In the context of the codebook-based homomorphic compression, a CAE can be trained on the quantized data. The encoder part of the CAE learns to compress the quantized data into a compact latent representation, which serves as the codeword. The decoder part learns to reconstruct the quantized data from the codeword. As an example, consider an example of using a CAE for encoding quantized sensor data. The quantized data is represented as a 2D matrix, where each row corresponds to a sensor reading, and each column represents a time step. The CAE encoder consists of convolutional layers followed by pooling layers, which gradually reduce the spatial dimensions of the input and extract meaningful features. The output of the encoder is a compact latent representation, which serves as the codeword. The CAE decoder consists of upsampling layers and convolutional layers, which reconstruct the original quantized data from the codeword.

Another form of deep learning coding includes recurrent autoencoders (RAEs). Recurrent autoencoders utilize recurrent neural networks (RNNs) in the encoder and decoder parts of the autoencoder. RNNs are well-suited for processing sequential data, such as time series or natural language, as they can capture temporal dependencies and context. An RAE can be used to encode quantized sequential data. The encoder part of the RAE consists of recurrent layers, such as Long Short-Term Memory (LSTM) or Gated Recurrent Unit (GRU) layers, which process the input sequence and generate a fixed-length latent representation, serving as the codeword. The decoder part of the RAE takes the codeword and reconstructs the original quantized sequence. For example, consider an example of using an RAE for encoding quantized audio data. The quantized audio signal is represented as a sequence of amplitude values. The RAE encoder consists of LSTM layers that process the input sequence and generate a fixed-length latent representation, which serves as the codeword. The RAE decoder, also consisting of LSTM layers, takes the codeword and reconstructs the original quantized audio sequence.

Another form of deep learning coding includes variational autoencoders (VAEs). Variational autoencoders extend the concept of autoencoders by introducing a probabilistic framework. VAEs learn to encode the input data into a probability distribution in the latent space, rather than a single point. The encoder part of the VAE learns to map the input data to the parameters of a probability distribution (e.g., mean and variance of a Gaussian distribution), and the decoder part learns to reconstruct the original data from samples drawn from this distribution. A VAE can be used to generate codewords that capture the underlying probability distribution of the quantized data. The encoder part of the VAE learns to map the quantized data to the parameters of a probability distribution in the latent space. The codewords are then obtained by sampling from this distribution. The decoder part of the VAE learns to reconstruct the original quantized data from the sampled codewords. Consider an example of using a VAE for encoding quantized image data. The quantized images are fed into the VAE encoder, which learns to map each image to the parameters of a Gaussian distribution in the latent space. The codewords are obtained by sampling from this distribution. The VAE decoder takes the sampled codewords and reconstructs the original quantized images.

Another form of deep learning coding includes deep belief networks (DBNs). Deep Belief Networks are generative models that consist of multiple layers of restricted Boltzmann machines (RBMs). DBNs can learn hierarchical representations of the input data by training each layer in an unsupervised manner, followed by fine-tuning the entire network using supervised learning. DBNs can be used to generate codewords that capture the hierarchical structure of the quantized data. The DBN is trained on the quantized data, and the activations of the hidden layers serve as the codewords. The hierarchical nature of DBNs allows for capturing complex patterns and dependencies in the data. Consider an example of using a DBN for encoding quantized text data. The quantized text is represented as a binary vector, where each element corresponds to the presence or absence of a specific word. The DBN is trained on the quantized text data, and the activations of the hidden layers serve as the codewords. The DBN learns to capture the hierarchical structure and semantic relationships in the text data.

These are just a few examples of deep learning encoding techniques that can be explored for creating codewords of the quantized data in a LCM. The choice of the specific deep learning architecture depends on the nature of the data and the desired properties of the codewords. It's important to note that the deep learning encoding process should be designed to generate codewords that are suitable for homomorphic operations. The codewords should exhibit certain properties, such as being compatible with the homomorphic encryption scheme's plaintext space and allowing for efficient homomorphic computations.

During the training process of the deep learning models, the objective function should be designed to capture the desired properties of the codewords, such as minimizing the reconstruction error while ensuring the codewords are suitable for homomorphic operations. Additionally, regularization techniques can be employed to encourage sparsity or other desirable properties in the codewords. Once the deep learning models are trained, the encoder part can be used to generate codewords for new quantized data. The generated codewords can then be used in the codebook-based homomorphic compression scheme, enabling efficient and privacy-preserving computations on the compressed data.

Experimental evaluation and performance analysis can be conducted to assess the effectiveness of the deep learning encoding techniques in generating codewords that achieve good compression ratios, maintain low approximation errors, and enable efficient homomorphic operations. The choice of the deep learning architecture and hyperparameters can be fine-tuned based on the specific requirements and characteristics of the data.

According to the aspect, a codebook library 1304 is present and configured to store a plurality of codewords (i.e., a codebook) generated by one or more of the techniques described herein. When it comes to storing the codewords and codebook in the codebook-based homomorphic compression system, several database systems and data storage solutions can be considered. The choice of the storage system depends on factors such as the size of the codebook, the frequency of updates, the retrieval and query requirements, and the overall system architecture. In some implementations key-value stores may be used, Key-value stores are a type of NoSQL database that provide a simple and efficient way to store and retrieve data based on a unique key. Examples of key-value stores include Redis, Memcached, and Amazon DynamoDB. For storing the codewords and codebook, key-value stores can be used to store each codeword as a key-value pair, where the key represents the codeword, and the value represents the corresponding data or metadata associated with the codeword. The codebook can be stored as a collection of key-value pairs, allowing for fast retrieval of codewords based on their keys. Key-value stores offer high performance, low latency, and scalability, making them suitable for scenarios where fast retrieval of codewords is critical.

Document databases, such as MongoDB or Couchbase, store data as flexible, semi-structured documents in formats like JSON or BSON. They provide a schema-less design and allow for easy modification of the data structure. For storing the codewords and codebook, document databases can be used to store each codeword as a document, along with its associated data or metadata. The codebook can be stored as a collection of documents, where each document represents a codeword and its related information. Document databases offer flexibility in terms of data structure, allowing for easy addition or modification of codeword attributes. They also provide querying capabilities based on document fields, enabling efficient retrieval of codewords based on specific criteria.

Relational databases, such as MySQL, PostgreSQL, or Oracle, can also be used to store the codewords and codebook. In a relational database, the codewords can be stored in a table with columns representing the codeword and its associated data or metadata. The codebook can be stored in a separate table, with each row representing a codeword and its corresponding information. Relational databases provide structured querying capabilities using SQL, allowing for efficient retrieval and filtering of codewords based on specific conditions. Relational databases offer strong consistency, ACID properties, and support for complex queries, making them suitable for scenarios where data integrity and structured querying are important.

Graph databases, such as Neo4j or Amazon Neptune, store data as nodes and edges in a graph structure. They are designed to efficiently handle complex relationships and connections between data entities. For storing the codewords and codebook, graph databases can be used to represent the relationships between codewords and their associated data or metadata. Each codeword can be represented as a node in the graph, with edges connecting related codewords or linking codewords to their corresponding data. Graph databases provide efficient traversal and querying capabilities based on the graph structure, allowing for fast retrieval of connected codewords and exploration of relationships between codewords.

Distributed key-value stores, such as Apache Cassandra or Apache HBase, are designed to handle large-scale data and provide high scalability and fault tolerance. They distribute data across multiple nodes in a cluster, allowing for horizontal scaling. For storing the codewords and codebook, distributed key-value stores can be used to store codewords as key-value pairs, similar to regular key-value stores. The codebook can be partitioned and distributed across multiple nodes in the cluster, enabling high scalability and performance. Distributed key-value stores offer eventual consistency, high write throughput, and the ability to handle large volumes of data, making them suitable for scenarios where scalability and fault tolerance are critical.

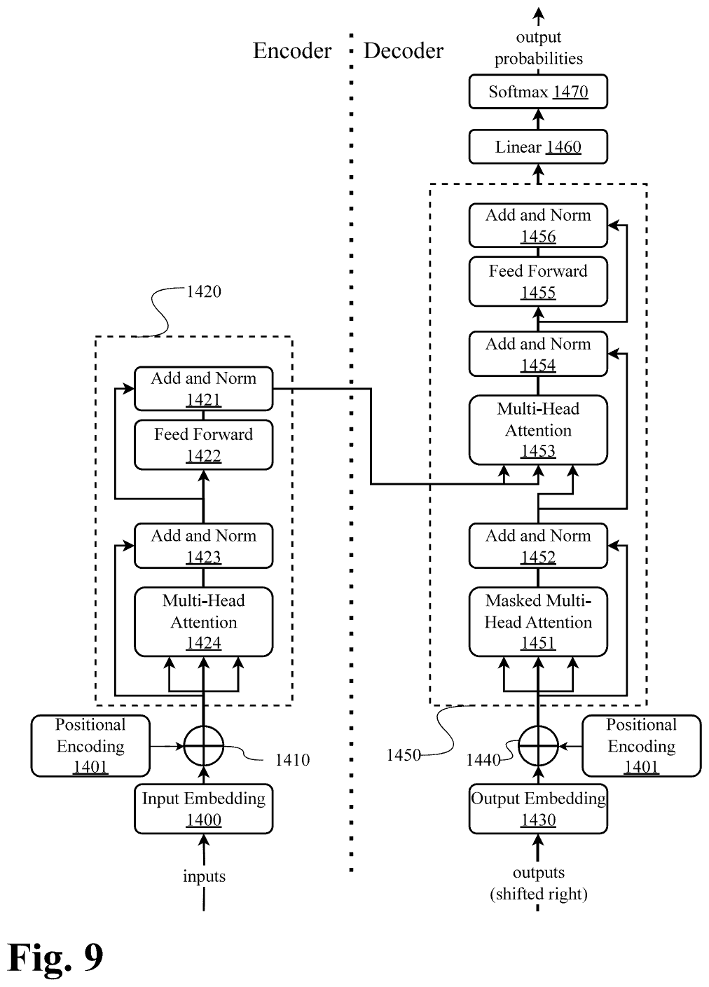

FIG. 9 is a block diagram illustrating an embodiment of the system and method for a large codeword model for deep learning, where the machine learning core is a Transformer-based core. A Transformer generally comprises an Encoder (the components on the left side of the illustration) and a Decoder (the components on the right side of the illustration).

The illustrated Transformer comprises an Encoder and a Decoder. The Encoder takes input embeddings and processes them through a stack of layers (represented as dashed box 1420). Each layer consists of: positional encoding, which adds position information to the input embeddings; multi-head attention, which allows the model to attend to different parts of the input sequence; add and norm, which applies residual connection and layer normalization; feed forward, which is a fully connected feed-forward network; and add and norm which is another residual connection and layer normalization.

The power of the transformer model lies in the self-attention mechanism. This mechanism contributes to accelerated learning compared to traditional models such as long short-term memory models. Self-attention empowers the transformer model with the remarkable capability to meticulously scrutinize distinct segments of a given sequence or even encompass the entire contextual essence of a sentence. This profound contextual awareness enables the model to make predictions with an elevated degree of accuracy and relevance.

The input embedding 1400 to the Encoder is a sequence of tokens, typically represented as integers. Each token is mapped to a learnable embedding vector of a fixed size. The embedding layer is a lookup table that converts each token into its corresponding dense vector representation. The embeddings are learned during training and capture semantic and syntactic relationships between tokens.

A dense vector representation, also known as a dense embedding or a continuous vector representation, is a way of representing data, particularly words or tokens, as dense vectors in a high-dimensional continuous space. In the context of natural language processing (NLP) and language models, dense vector representations are used to capture semantic and syntactic information about words or tokens. Each word or token is mapped to a fixed-size vector of real numbers, typically with hundreds or thousands of dimensions. Each word or token is represented by a vector of a fixed size, regardless of the length of the input sequence. The size of the vector is a hyperparameter that is determined during model design. The vectors exist in a continuous high-dimensional space, where each dimension represents a latent feature or aspect of the word or token. The continuous nature allows for capturing fine-grained relationships and similarities between words. The dense vector representations are learned during the training process of the model. The model learns to assign similar vectors to words that have similar meanings or occur in similar contexts. The dense vector representations aim to capture semantic and syntactic relationships between words. Words that have similar meanings or are used in similar contexts tend to have similar vector representations. Dense vector representations allow for performing algebraic operations on words, such as addition and subtraction. These operations can capture analogies and relationships between words, such as “prince”−“man”+“woman”≈“princess”. Dense vector representations serve as input features for various downstream NLP tasks, such as text classification, sentiment analysis, named entity recognition, and machine translation. The dense representations provide a rich and informative input to the models, enabling them to learn patterns and make predictions. Some popular examples of dense vector representations include, but are not limited to, Word2Vec, Global Vectors for Word Representations (GloVe), FastText, and BERT.

After the input embedding layer, positional encoding 1401 is added to the input embedding to provide position information to the model. The positional encoding 1401 and the input embedding 1400 may be added using a function 1410. Since the Transformer architecture doesn't have inherent recurrence or convolution, positional encodings help capture the order and relative positions of tokens. The positional encodings are typically sine and cosine functions of different frequencies, allowing the model to learn relative positions. The positional encodings have the same dimensionality as the input embeddings and are summed with them.

The Encoder utilizes a multi-head attention mechanism 1424 which is a key component of the Transformer architecture. It allows the Encoder to attend to different parts of the input sequence and capture dependencies between tokens. The attention mechanism computes three matrices: Query (Q), Key (K), and Value (V). The Query, Key, and Value matrices are obtained by linearly projecting the input embeddings using learned weight matrices. The attention scores are computed by taking the dot product of the Query matrix with the transpose of the Key matrix, followed by scaling and applying a softmax function. The attention scores determine the importance of each token in the input sequence for a given position. The Value matrix is then multiplied with the attention scores to obtain the weighted sum of the values, which forms the output of the attention mechanism. Multi-Head Attention splits the Query, Key, and Value matrices into multiple heads, allowing the model to attend to different aspects of the input simultaneously. The outputs from each head are concatenated and linearly projected to obtain the final output of the Multi-Head Attention layer 1424.

After the Multi-Head Attention layer, a residual connection is applied, followed by Layer Normalization at add and norm 1423. The residual connection adds the input embeddings to the output of the attention layer, helping the model learn faster and deeper. Layer Normalization normalizes the activations across the features, stabilizing the training process.

The Feed Forward layer 1422 is a fully connected neural network applied to each position of the Encoder's hidden states. It consists of two linear transformations with a Rectified Linear Unit (ReLU) activation function in between. The purpose of the Feed Forward layer is to introduce non-linearity and increase the model's capacity to learn complex representations. The output of the Feed Forward layer has the same dimensionality as the input embeddings. A residual connection and Layer Normalization 1421 are applied after the Feed Forward layer.

The Encoder layers 1420 are stacked Nx times, where N is a hyperparameter that determines the depth of the Encoder. Each layer follows the same structure: Multi-Head Attention, Add & Norm, Feed Forward, and Add & Norm. By stacking multiple Encoder layers, the model can capture hierarchical and long-range dependencies in the input sequence. The output of the final Encoder layer represents the encoded input sequence, which is then passed to the Decoder for generating the output sequence.

The Decoder generates the output probabilities. It has a similar structure to the Encoder, with a few additions. The Decoder takes output embeddings and processes them through a stack of layers (represented as dashed box 1450). The output embedding layer 1430 takes the previous output tokens (shifted right by one position) and converts them into dense vectors. Each token is mapped to a learnable embedding vector of a fixed size. The embedding vectors capture semantic and syntactic relationships between tokens.

Positional encoding 1401 is added to the output embedding 1430 to provide position information to the model. Positional encoding 1401 may be added to the output embedding 1430 through a function 1440. Since the Transformer architecture does not have inherent recurrence or convolution, positional encodings help capture the order and relative positions of tokens. The positional encodings are typically sine and cosine functions of different frequencies, allowing the model to learn relative positions.

The masked multi-head attention 1451 mechanism prevents the model form attending to future tokens. This layer performs self-attention on the Decoder's input sequence. It allows the Decoder to attend to different parts of its own input sequence. The attention is “masked” to prevent the Decoder from attending to future tokens, ensuring that the predictions are based only on the previously generated tokens. Multi-head attention splits the input into multiple heads, allowing the model to attend different aspect of the input simultaneously.

After the masked multi-head attention, a residual connection is applied follows by layer normalization via add and norm 1452. The residual connection adds the input to the output of the attention layer, helping the model learn faster and deeper. Layer normalization normalizes the activations across the features, stabilizing the training process.

The multi-head attention 1453 layer performs attention between the Decoder's hidden states and the Encoder's output. It allows the Decoder to attend to relevant parts of the input sequence based on the Encoder's representations. The attention weights are computed based on the compatibility between the Decoder's hidden states and Encoder's outputs.

Another add and norm 1454 layer is then followed by feed forward network 1455. This a fully connected feed-forward network applied to each position of the Decoder's hidden states. It consists of two linear transformations with a Rectified Linear Unit (ReLU) activation in between. The feed forward layer helps the model capture non-linear interactions and increases the model's capacity.

Another add and norm 1456 layer is followed by linear 1460 and softmax 1470 layers. The final hidden states of the Decoder are passed through a linear transformation to project them into the vocabulary space. Vocabulary space refers to the set of all unique tokens or words that the model can generate or predict. In the context of language models, the vocabulary is a predefined set of tokens that the model is trained on and can output. When the Decoder's final hidden states are passed through a linear transformation, they are projected into a vector space with the same dimensionality as the size of the vocabulary. Each dimension in this space corresponds to a specific token in the vocabulary. For example, the model has a vocabulary of 10,000 unique tokens. The linear transformation would project the Decoder's hidden states into a 10,000-dimensional vector space. Each element in this vector represents the model's predicted probability or score for the corresponding token in the vocabulary.

A softmax function is applied to the projected values (vectors) to generate output probabilities over the vocabulary. The softmax function normalizes the values so that they sum up to 1, representing a probability distribution over the vocabulary. Each probability indicates the likelihood of a specific token being the next output token. The token with the highest probability is selected as the next output token. During the model's training, the objective is to maximize the probability of the correct next token given the input sequence and the previously generated tokens. The model learns to assign higher probabilities to the tokens that are more likely to appear based on the context. At inference time, the token with the highest probability in the vocabulary space is selected as the next output token. This process is repeated iteratively, with the generated token being fed back into the Decoder as input for the next step, until a stopping criterion is met (e.g., reaching a maximum length or generating an end-of-sequence token). The size and composition of the vocabulary can vary depending on the specific task and the data the model is trained on. It can include words, sub-words, or even characters, depending on the tokenization strategy used.

The Decoder layers 1450 can be stacked Nx times, allowing the model to capture complex dependencies and generate coherent output sequences.

This transformer architecture allows the model to process input sequences, capture long-range dependencies, and generate output sequence based on the encoded input and the previously generated codewords.

There are at least three variations of transformer architecture that may enable an LCM. A first such variation comprises Auto-Encoding Models. In autoencoders, the decoder portion of the transformer is discarded after pre-training and only the encoder is used to generate the output. The popular BERT and ROBERTa models are examples of models based on this architecture and perform well on sentiment analysis and text classification. These types of models may be trained using a process called masked language modeling (MLM).

The primary goal of an autoencoder is to learn efficient representations of input data by encoding the data into a lower-dimensional space and then reconstructing the original data from the encoded representation. Autoencoders are trained in an unsupervised manner, meaning they don't require labeled data. They learn to capture the underlying structure and patterns in the input data without explicit guidance. An autoencoder consists of two main components: an encoder and a decoder. The encoder takes the input data and maps it to a lower-dimensional representation, often referred to as the latent space or bottleneck. The decoder takes the latent representation and tries to reconstruct the original input data. Autoencoders can be used for dimensionality reduction by learning a compressed representation of the input data in the latent space. The latent space has a lower dimensionality than the input data, capturing the most salient features or patterns. The training objective of an autoencoder is to minimize the reconstruction error between the original input and the reconstructed output. The model learns to encode and decode the data in a way that preserves the essential information needed for reconstruction. Variants and extensions of autoencoders can include denoising autoencoders, variational autoencoders (VAEs) which introduce a probabilistic approach to autoencoders wherein they learn a probabilistic encoder and decoder, allowing for generating new samples from the learned latent space, and conditional autoencoders which incorporate additional conditions or labels as input to the encoder and decoder, enabling the generation of samples conditioned on specific attributes.

Autoencoders can have various applications. Autoencoders can be used to detect anomalies by measuring the reconstruction error. Anomalous samples tend to have higher reconstruction errors compared to normal samples. Autoencoders can be used as a pre-training step to learn meaningful features from unlabeled data. The learned features can then be used for downstream tasks like classification or clustering. Additionally, or alternatively, autoencoders, particularly VAEs, can be used as generative models to generate new samples similar to the training data by sampling from the learned latent space. It's worth noting that while autoencoders can be effective for certain tasks, they have some limitations. They may struggle to capture complex dependencies and may generate blurry or less sharp reconstructions compared to other generative models like Generative Adversarial Networks (GANs).

Another type of variation is the auto-regressive model which feature the use of only the decoder portion of the transformer architecture. In autoregressive architectures, the decoder portion of the transformer is retained and the encoder portion is not used after model pre-training. Auto-regressive models are a class of models that generate outputs by predicting the next element based on the previously generated elements. In the context of the Transformer architecture and language modeling, auto-regressive models are commonly used for tasks such as text generation, machine translation, and language understanding.

Auto-regressive models generate outputs sequentially, one element at a time. In the case of language modeling, the model predicts the next word or token based on the previous words or tokens in the sequence. The prediction of the next element is conditioned on the previously generated elements. The model learns the conditional probability distribution P (x_t|x_1, x_2, . . . , x_{t−1}), where x_t is the element at position t, and x_1, x_2, . . . , x_{t−1} are the previously generated elements. The Transformer architecture, particularly the Decoder component, is well-suited for auto-regressive modeling. The Decoder generates the output sequence one element at a time, conditioned on the previously generated elements and the encoded input sequence from the Encoder. In the Transformer Decoder, the self-attention mechanism is masked to prevent the model from attending to future positions during training. This masking ensures that the model relies only on the previously generated elements to make predictions, following the auto-regressive property. During training, the Transformer Decoder uses a technique called teacher forcing. Instead of feeding the model's own predictions as input for the next step, the ground truth target sequence is used. This helps the model learn to generate the correct output sequence based on the input sequence and the previous target tokens. During inference or generation, the Transformer Decoder generates the output sequence one element at a time. At each step, the model takes the previously generated elements as input and predicts the next element. This process continues until a stopping criterion is met, such as reaching a maximum sequence length or generating an end-of-sequence token. Auto-regressive models, including the Transformer, have achieved state-of-the-art performance in language modeling tasks. They excel at capturing the statistical properties and dependencies in sequential data, making them effective for generating coherent and fluent text.

While text generation is the most suitable use case of auto-regressors, they perform exceptionally well on a wide variety of tasks. Most modern LLMs are auto-regressors including, for example, the popular GPT series of LLMs, BERT, and XLNet.

The third variation of the transformer model is the sequence-to-sequence model which utilizes both the encoder and decoder portions of the transformer and can be trained in multiple ways. One of the methods is span corruption and reconstruction. These models are, generally, best suited for language translation. The T5 and BART family of models are examples of sequence-to-sequence models.

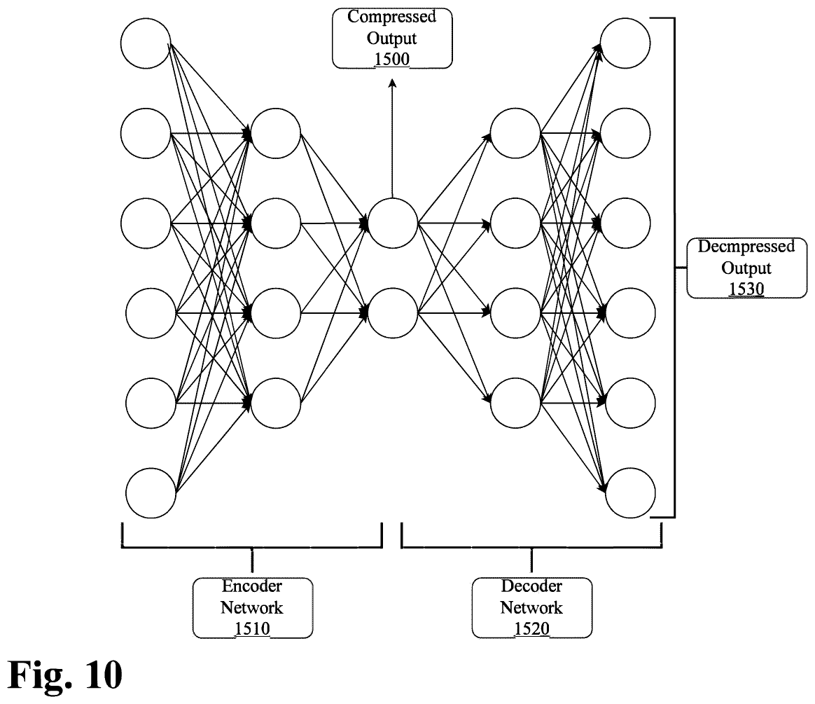

FIG. 10 is a block diagram illustrating an embodiment of the system and method for a large codeword model for deep learning, where the machine learning core is a VAE-based core. An autoencoder network comprises an encoder network 1510 or a decoder network 1520 that work together to encode and decode data effectively. The encoder network 1510 and decoder network 1520 within the autoencoder network is comprised of a plurality of layers that contribute to the encoding and decoding process. These layers include, but are not limited to, convolutional layers, pooling layers, and a bottleneck layer. Some embodiments also include functions that operate on information including but not limited to rectified linear unit functions, sigmoid functions, and skip connections.

The convolutional layers are responsible for extracting meaningful features from the input data. They apply convolutional operations using learnable filters to capture spatial patterns and hierarchical representations of the data. The convolutional layers can have different numbers of filters, kernel sizes, and strides to capture features at various scales and resolutions. Skip connections are employed to facilitate the flow of information across different layers of the autoencoder. Skip connections allow the output of a layer to be directly added to the output of a subsequent layer, enabling the network to learn residual mappings and mitigate the vanishing gradient problem. Skip connections help in preserving fine-grained details and improving the training stability of the autoencoder.

Pooling layers are used to downsample the feature maps generated by the convolutional layers. They reduce the spatial dimensions of the feature maps while retaining the most salient information. Common pooling operations include but are not limited to max pooling and average pooling. Pooling layers help in achieving translation invariance, reducing computational complexity, and controlling the receptive field of the autoencoder. Rectified Linear Unit (ReLU) functions introduce non-linearity into the autoencoder by applying a ReLU activation function element-wise to the output of the previous layer. ReLU functions help in capturing complex patterns and relationships in the data by allowing the network to learn non-linear transformations. They also promote sparsity and alleviate the vanishing gradient problem. The bottleneck layer represents the most compressed representation of the input data. The bottleneck layer has a significantly reduced dimensionality compared to the input and output layers of the autoencoder. It forces the network to learn a compact and meaningful encoding of the data, capturing the essential features and discarding redundant information. In one embodiment, the multi-layer autoencoder network is comprised of a plurality of the previously mentioned layers where the sequence and composition of the layers may vary depending on a user's preferences and goals. The bottleneck layer is where the compressed output 1500 is created. Each layer previous to the bottleneck layer creates a more and more compressed version of the original input. The layers after the bottleneck layer represent the decoder network 1530 where a plurality of layers operate on a compressed input to decompress a data set. Decompression results in a version of the original input which is largely similar but has some lost data from the transformations.

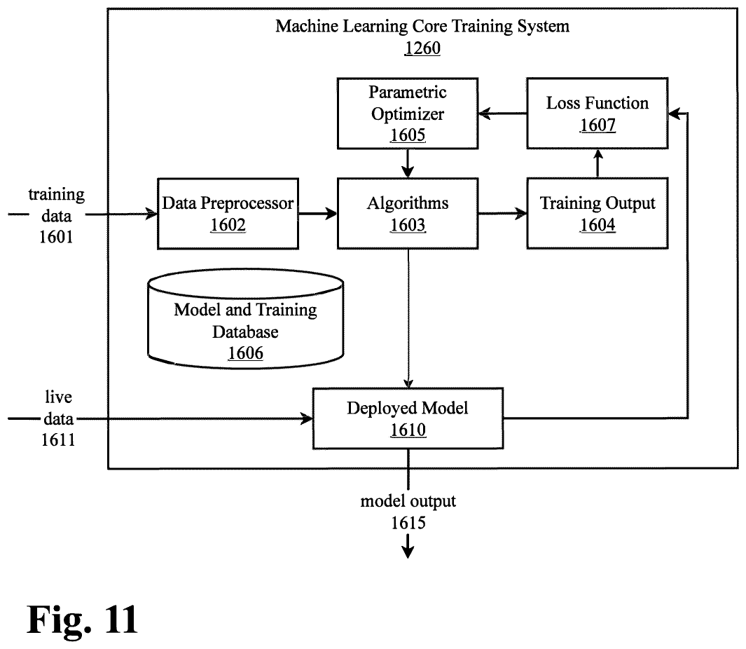

FIG. 11 is a block diagram illustrating an aspect of system and method for a large codeword model for deep learning, a machine learning core training system. According to the embodiment, the machine learning core training system 1260 may comprise a model training stage comprising a data preprocessor 1602, one or more machine and/or deep learning algorithms 1603, training output 1604, and a parametric optimizer 1605, and a model deployment stage comprising a deployed and fully trained model 1610 configured to perform tasks described herein such as processing codewords through a large codeword model. The machine learning core training system 1260 may be used to train and deploy a plurality of machine learning architectures in order to support the services provided by the large codeword model for deep learning.

At the model training stage, a plurality of training data 1601 may be received by the generative AI training system 1650. Data preprocessor 1602 may receive the input data (e.g., codewords, sourceblocks) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 1602 may also be configured to create training dataset, a validation dataset, and a test set from the plurality of input data 1601. For example, a training dataset may comprise 80% of the preprocessed input data, the validation set 10%, and the test dataset may comprise the remaining 10% of the data. The preprocessed training dataset may be fed as input into one or more machine and/or deep learning algorithms 1603 to train a predictive model for object monitoring and detection.

During model training, training output 1604 is produced and used to measure the accuracy and usefulness of the predictive outputs. During this process a parametric optimizer 1605 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the machine learning core training system 1260 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 1607 to measure the system's performance. The loss function 1607 compares the training outputs with an expected output and determined how the algorithm needs to be changed in order to improve the quality of the model output. During the training stage, all outputs may be passed through the loss function 1607 on a continuous loop until the algorithms 1603 are in a position where they can effectively be incorporated into a deployed model 1615.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 1610 in a production environment making predictions based on live input data 1611 (e.g., interest factor data, incentive data). Further, model correlations and restorations made by deployed model can be used as feedback and applied to model training in the training stage, wherein the model is continuously learning over time using both training data and live data and predictions. A model and training database 1606 is present and configured to store training/test datasets and developed models. Database 1606 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 1603 may comprise a deep learning algorithm such as neural networks (e.g., recurrent, convolutional, long short-term memory networks, etc.).

In some implementations, the machine learning core training system 1260 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 1606.

### Dynamically-Encoded Agent Network for Optimized Deep Learning

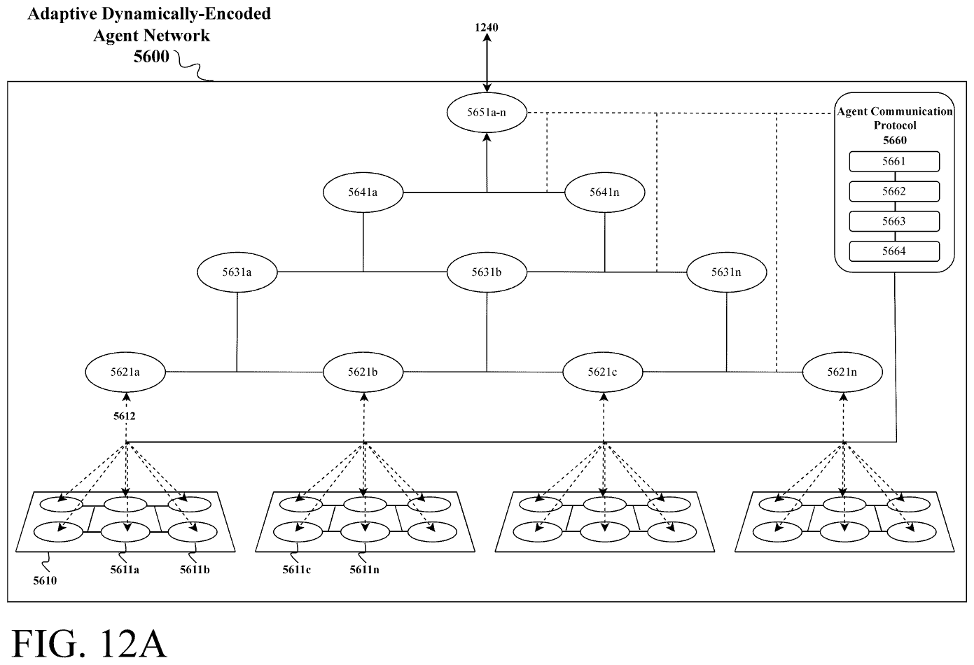

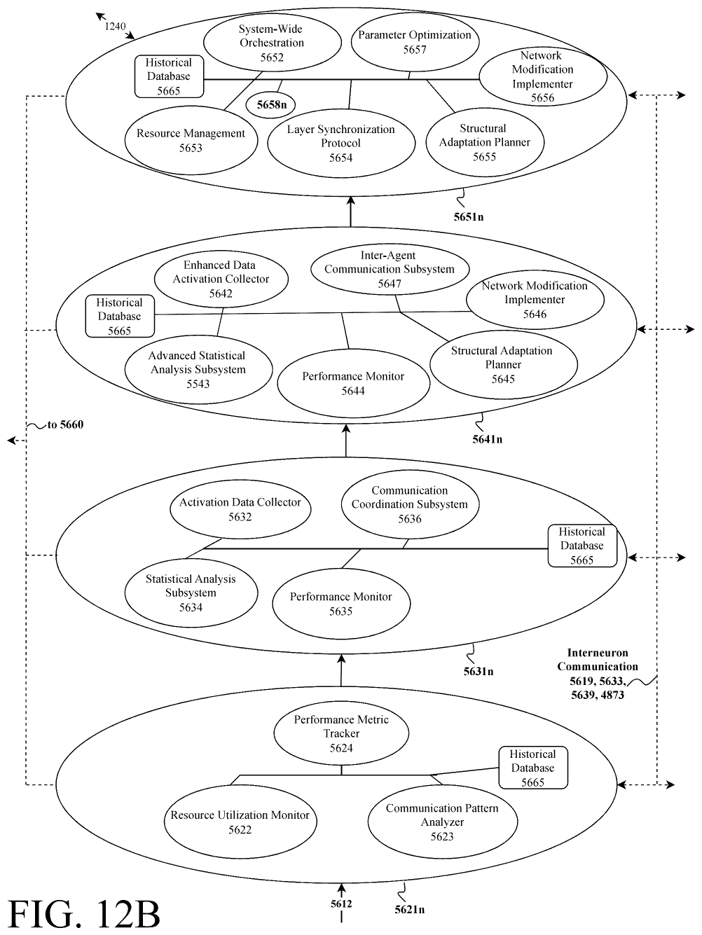

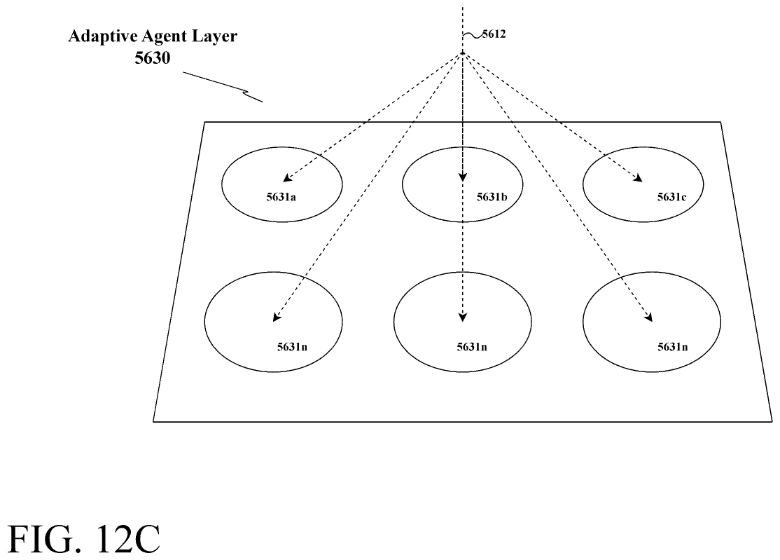

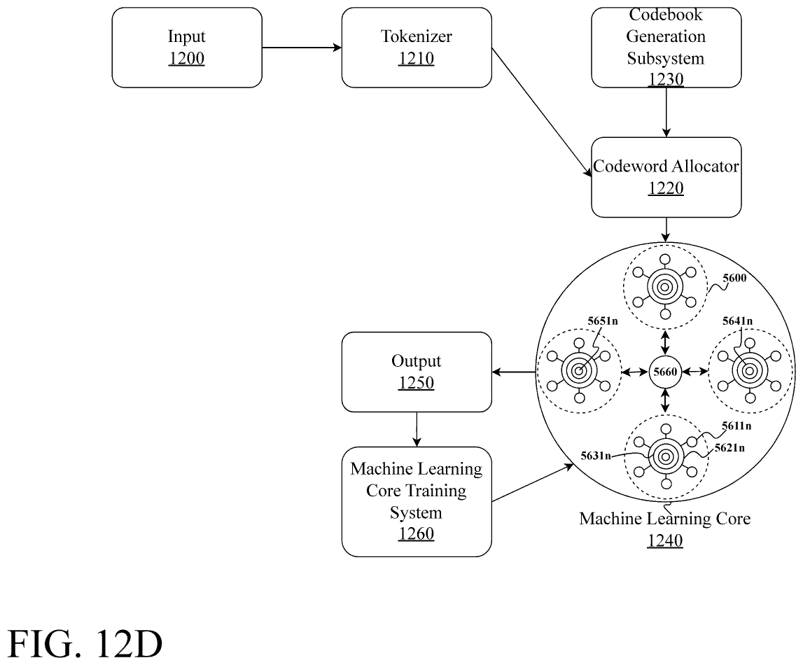

FIG. 12A illustrates exemplary architecture of adaptive dynamically-encoded agent network 5600, in an embodiment. Adaptive dynamically-encoded agent network 5600 may be operatively connected to machine learning core 1240 and designed to monitor and adapt the network structure through dynamically encoded agents. Adaptive dynamically-encoded agent network 5600 may comprise multiple functional layers, implementing comprehensive agent encoding, generation, pruning, and optimization across the network. Thus, this network functions as a dynamically-encoded agent network for optimized deep learning.

In an embodiment the base of adaptive dynamically-encoded agent network 5600 is a base graph layer 5610, comprising interconnected computational nodes that facilitate agent-based processing within machine learning core 1240. These nodes serve as fundamental computation units and interact with dynamically-encoded agents to execute encoding transformations and optimize inter-agent communication. Base agents 5611a-n form the core processing units of base graph layer 5610, executing initial encoding transformations, managing localized data processing, and maintaining structured communication with higher-layer agents. These base agents dynamically adjust their encoding strategies based on telemetry feedback and continuously refine their transmission pathways to optimize efficiency.

Interlayer communication system 5612 facilitates structured data exchange between layers of adaptive dynamically-encoded agent network 5600, ensuring that encoding updates, adaptation signals, and performance metrics propagate efficiently across the network. This system enables base agents 5611a-n to transmit optimized encoding transformations to mid-level dynamically-encoded agents 5641a-n, which in turn communicate refined adaptation strategies to high-level dynamically-encoded agents 5651a-n. Agent communication protocol 5660 governs the formatting, synchronization, and interpretation of these messages, ensuring that dynamically-encoded agents across all layers maintain a standardized structure for encoding updates and adaptation directives. By integrating 5612 with 5660, adaptive dynamically-encoded agent network 5600 maintains consistency in interlayer communication while enabling flexible, real-time encoding optimization.

Global performance monitor 5661 maintains network-wide encoding effectiveness evaluations, ensuring that dynamically-encoded agents continue to meet system performance thresholds. Structural adaptation planner 5662 within orchestration agents executes coordinated agent lifecycle management strategies, optimizing network-wide agent distribution and interaction structures. Network modification implementer 5663 implements synchronized adaptation cycles, ensuring that large-scale modifications do not disrupt system stability.

Inter-layer communication subsystem 5664 ensures structured information exchange across all dynamically-encoded agent layers, executing distributed consensus procedures for system-wide optimization decisions. This subsystem synchronizes encoding transformation strategies across base, mid-level, high-level, and orchestration layers, ensuring consistent adaptation.

Above a base graph layer, a telemetry layer 5620 implements continuous monitoring and real-time performance tracking. This layer consists of, for example, telemetry agents 5621a-n that collect encoding efficiency data, communication patterns, and resource utilization metrics. These agents may execute adaptive kernel-based monitoring and topology-aware analysis, ensuring that network performance is continuously optimized.

Higher-level agent layers 5630, 5640, and 5650 contain dynamically-encoded agents 5631a-n, 5641a-n, and 5651a-n, which may be responsible for adaptive optimization of the network structure. Various embodiments of these higher-level dynamically encoded agent layers may be implemented, depending on system needs. These agents may, for example, dynamically modify encoding strategies, generate new agents, and/or prune existing agents based on real-time telemetry data. In an embodiment, agent encoding managers coordinates these operations by adjusting encoding parameters and optimizing inter-agent message passing.

An encoding manager agent 5631a-n coordinates these operations by adjusting encoding parameters and optimizing inter-agent message passing, in an embodiment.

A memory layer 5640 includes dynamically encoded memory agents 5641a-n, which manage short-term and long-term memory retention, facilitating efficient recall and adaptation of previously learned patterns, in an embodiment. These memory agents adjust data retention policies based on evolving network demands, ensuring seamless access to relevant historical encoding patterns.

In an embodiment, an orchestration layer 5650 may oversee network-wide adaptation, ensuring coherence across all layers. A system-wide orchestration agents 5651a-n evaluates global performance trends, manages large-scale agent generation and pruning operations, and synchronizes resource distribution across all functional layers.

In an embodiment, the encodings within adaptive dynamically-encoded agent network 5600 may encompass a comprehensive range of agent characteristics and operational parameters. These encodings may include, but are not limited to, neural network weights, bias values, embedding parameters, hyperparameters, learning rate schedules, attention mechanisms, activation functions, and model architecture specifications. For example, an encoding might specify particular embedding dimensions for processing sequential data, attention head configurations for transformer-based operations, or dynamic learning rate adjustments for optimization procedures. Additionally, encodings may contain executable code snippets, allowing for dynamic modification of agent behavior. Through this flexible encoding framework, adaptive dynamically-encoded agent network 5600 can dynamically optimize multiple aspects of agent operation simultaneously, adjusting both structural characteristics and operational parameters based on telemetry feedback and performance objectives. This comprehensive approach to encoding enables fine-grained control over agent adaptation while maintaining the generality needed for diverse applications. Adaptive dynamically-encoded agent network 5600 may continuously refine its structure based on layer-specific performance metrics while maintaining global consistency through coordinated agent adaptation. By leveraging multi-layered encoding optimization, autonomous agent adaptation, and dynamic topology restructuring, the system enables efficient and scalable real-time network adaptation.

In an embodiment, adaptive dynamically-encoded agent network 5600 implements specific criteria and scenarios for agent pruning and generation operations. For example, telemetry agents 5620 may identify pruning candidates when multiple dynamically-encoded base agents 5631a-n exhibit encoding transformations with less than 5% variation in their outputs over a defined time window, indicating redundant processing. In such cases, the system may consolidate these operations into fewer agents, pruning redundant ones while maintaining processing capability through the remaining agents.

Agent pruning may also be triggered when resource utilization metrics indicate inefficient operation. For instance, if an agent's memory consumption or computational overhead exceeds 150% of the average for its layer while contributing less than 50% of the average performance improvement, high-level dynamically-encoded agents 5651a-n may flag it for pruning. Similarly, when communication pathway analysis reveals that an agent's incoming or outgoing connections have fallen below 30% utilization over multiple adaptation cycles, the system may initiate pruning operations to optimize network topology.

Conversely, agent generation may be triggered by specific performance metrics and operational demands. For example, when processing latency for particular data types exceeds defined thresholds—such as when encoding transformation time increases beyond 200% of the baseline for sustained periods—mid-level dynamically-encoded agents such as memory agents 5641a-n may initiate the generation of additional specialized agents. These new agents receive encoding parameters optimized for the specific data types experiencing bottlenecks, allowing for more efficient parallel processing.

The system may also generate new agents when encoding diversity metrics indicate a need for specialization. For instance, if the variance in encoding transformations within a network region drops below a defined threshold, suggesting limited adaptation capability, the system may generate new agents with modified encoding parameters to expand the range of possible transformations. This might occur when processing novel data patterns that existing agents are not optimized to handle efficiently.

Memory utilization patterns may also drive agent generation. When telemetry data indicates that certain agents are frequently accessing historical encoding patterns stored in memory agents 5641a-n, the system may generate dedicated caching agents to optimize data access. These specialized agents maintain frequently used encoding transformations in rapid-access memory structures, reducing latency for common operations.

During periods of high network load, agent generation may be triggered by bandwidth utilization metrics. For example, when communication pathways between specific network regions consistently operate above 80% capacity, the system may generate intermediate agents to create additional transmission routes and prevent bottlenecks. These new agents implement encoding transformations that optimize data flow while maintaining processing efficiency.

Structural adaptation scenarios may also drive agent lifecycle events. When network topology analysis reveals regions of high connectivity density, the system may generate load-balancing agents that redistribute processing tasks and optimize resource utilization. Conversely, in regions where connectivity has become sparse due to previous pruning operations, the system may generate bridging agents to maintain efficient information flow across the network.

Each lifecycle operation is governed by the system's overall performance objectives and resource constraints. For example, during resource-constrained periods, pruning thresholds may be dynamically adjusted to more aggressively consolidate processing capacity. Similarly, during high-demand periods, generation thresholds may be modified to more readily expand network capacity in response to processing needs. This adaptive approach to lifecycle management ensures that adaptive dynamically-encoded agent network 5600 maintains optimal performance while efficiently utilizing available resources.

In an embodiment, adaptive dynamically-encoded agent network 5600 implements optimization through a comprehensive mathematical framework that guides encoding decisions and network adaptations. For any pair of connected agents (i,j), where agent i transmits encoded information to agent j, the system defines a loss function L that quantifies the efficiency and effectiveness of their interaction:

L(i,j)=C_encode(i,j)+C_transmit(i,j)+C_latency(i,j)−P_improvement(j)

where C_encode(i,j) represents the computational cost of encoding at agent i for transmission to agent j, C_transmit(i,j) captures the bandwidth cost of transmission, C_latency(i,j) accounts for latency-related penalties, and P_improvement(j) measures the performance improvement at agent j resulting from the encoding.

At the network level, adaptive dynamically-encoded agent network 5600 optimizes a global objective function that considers both individual agent interactions and system-wide performance:

L_network=Σ(i,j)∈E L(i,j)+γ₁|E|+γ₂Σ(latency)+γ₃max (latency)−Σ(P_network(j))

where E represents the set of all agent connections, |E| denotes the total number of connections, and the γ terms weight different aspects of network performance. The γ₁|E| term penalizes excessive network complexity, while γ₂Σ(latency) and γ₃max(latency) balance average and worst-case latency considerations. The final term Σ(P_network(j)) captures the aggregate performance improvement across all agents.

Dynamically-encoded agents 5631a-n continuously optimize these objectives through adaptive encoding strategies. When telemetry agents 5620 detect suboptimal performance, they trigger encoding adjustments that minimize the local loss function L(i,j) while contributing to network-wide optimization of L_network. This mathematical framework guides agent generation and pruning decisions, with new agents being instantiated when they would reduce L_network and existing agents being pruned when their removal would improve the overall objective.

The framework also informs memory retention strategies within memory agents 5641a-n, which maintain historical performance data to refine optimization over time. High-level dynamically-encoded agents 5651a-n leverage this mathematical basis to coordinate large-scale network adaptations, ensuring that local optimizations align with global performance objectives.

System-wide orchestration agents 5658a-n may dynamically adjust the weighting parameters γ₁, γ₂, and γ₃ based on operational requirements and network conditions, allowing adaptive dynamically-encoded agent network 5600 to balance different performance aspects as needed. This adaptive weighting enables the system to prioritize latency reduction during time-critical operations or emphasize efficiency during resource-constrained periods.

This mathematical foundation provides a principled basis for the various adaptation mechanisms within adaptive dynamically-encoded agent network 5600, ensuring that agent-level decisions and network-wide modifications contribute to systematic performance improvement while maintaining operational stability.

In an embodiment, adaptive dynamically-encoded agent network 5600 may incorporate various machine learning models to optimize encoding transformations, agent adaptation strategies, and network-wide decision-making. For example, deep neural networks may be used to refine encoding representations within dynamically-encoded agents, ensuring that transmitted data is efficiently compressed while retaining critical features. Transformer-based architectures may, for example, be employed within high-level dynamically-encoded agents to analyze long-term encoding patterns, detect anomalies, and optimize inter-agent communication. Additionally, reinforcement learning models may be integrated to enable dynamically-encoded agents to iteratively refine their encoding strategies based on reward signals derived from telemetry data and network efficiency metrics.

Machine learning models within adaptive dynamically-encoded agent network 5600 may be trained on various types of data, depending on the operational domain and application requirements. For example, in an embodiment where the system is deployed in a natural language processing environment, training data may include large-scale text corpora, encoded linguistic structures, and semantic embeddings. In a computer vision implementation, training datasets may comprise image sequences, feature maps, and encoded representations of visual patterns. Time-series forecasting applications may, for example, train models on historical data streams, sensor readings, and encoded temporal patterns to predict future trends and optimize network resource allocation accordingly.

Training methodologies for machine learning models within adaptive dynamically-encoded agent network 5600 may vary based on model complexity and deployment requirements. For example, supervised learning techniques may be used where labeled datasets are available, enabling models to learn optimal encoding transformations by minimizing loss functions. In cases where explicit labels are not available, unsupervised learning approaches such as clustering or autoencoders may be employed to identify patterns in encoded data and optimize agent interactions. Additionally, federated learning may be utilized in distributed implementations, allowing dynamically-encoded agents to collaboratively refine models across multiple network nodes without centralized data aggregation. These diverse training methodologies ensure that adaptive dynamically-encoded agent network 5600 remains flexible, scalable, and capable of learning and evolving based on real-world operational conditions.

The system 5600 represented in this figure is an embodiment, and one skilled in the art would recognize that variations in the number of layers may be present in different implementations of a dynamically-encoded agent network for optimized deep learning. Depending on system requirements, computational constraints, or specific network demands, certain embodiments may incorporate additional functional layers to enhance adaptability, while others may reduce the number of layers to streamline processing. The hierarchical arrangement of dynamically-encoded agents allows for flexible configurations, enabling the system to scale based on performance objectives, data complexity, or resource availability. In some cases, specialized layers may be introduced to handle distinct processing tasks, such as dedicated memory retention, enhanced telemetry analysis, or more granular agent coordination. Conversely, simplified embodiments may consolidate multiple layers into unified structures to optimize efficiency. Regardless of the specific configuration, the principles of adaptive agent encoding, network monitoring, and dynamic optimization remain fundamental to the system's operation.

FIG. 12B illustrates exemplary architecture of dynamically-encoded agents within adaptive dynamically-encoded agent network 5600, in an embodiment.

Dynamically-encoded base agents 5631a-n form the foundation of adaptive dynamically-encoded agent network 5600. These agents manage local encoding operations and agent interactions within the base graph layer 5610. Each base agent integrates an activation data collector 5632, which interfaces with the computational nodes of the base graph layer 5610 via data stream 5633. The activation data collector continuously monitors encoding transformations, agent interactions, and data flow efficiency. It executes adaptive sampling functions, dynamically adjusting monitoring rates based on agent activity, information propagation density, and encoding complexity.

Statistical analysis subsystem 5634 implements advanced data evaluation techniques by combining encoding transformation metrics with agent communication patterns. This subsystem performs gradient field computations, encoding stability assessments, and entropy-based evaluation of agent interactions. It maintains a hierarchical pattern analysis framework, tracking agent-level encoding optimizations across multiple network layers. The performance monitor 5635 implements continuous tracking of agent adaptation processes, evaluating the efficiency of newly instantiated agents and their integration within the network. This monitor maintains processing efficiency metrics, encoding quality evaluations, and real-time tracking of agent pruning operations. The communication coordination subsystem 5636 implements structured inter-agent messaging protocols, ensuring efficient information flow between dynamically-encoded agents for optimized encoding adaptation and decision-making.

Dynamically-encoded mid-level agents 5641a-n operate as coordinating entities overseeing multiple base agents. These mid-level agents execute multi-scale encoding transformations, dynamically adjusting network encodings to optimize compression efficiency and inter-agent transmission latency. The enhanced activation data collector 5642 within mid-level agents implements multi-layer monitoring, aggregating encoding efficiency data from multiple base agents. It applies adaptive kernel functions for encoding validation, executing reservoir sampling mechanisms to maintain a representative dataset for real-time analysis.

Advanced statistical analysis subsystem 5643 within mid-level agents executes spatiotemporal analysis of encoding efficiency, combining gradient-based transformations with encoding evolution tracking. This subsystem applies spectral decomposition techniques and encoding divergence analysis, ensuring that dynamically-encoded agents maintain optimal performance across multiple processing cycles. The performance monitor 5644 systematically tracks mid-level agent efficiency, executing real-time comparisons between encoding transformation methods and ensuring layer-wide consistency in optimization strategies.

Structural adaptation planner 5645 within mid-level agents implements strategic agent modifications based on telemetry feedback and encoding transformation efficiency. This planner balances exploration-based agent generation with exploitation-based refinement of existing agents, maintaining an equilibrium between network expansion and stability. The network modification implementer 5646 executes these planned modifications, dynamically instantiating new agents and removing underperforming ones while ensuring seamless encoding propagation throughout the network. The inter-agent communication subsystem 5647 facilitates structured messaging between mid-level agents, executing distributed consensus algorithms for encoding adaptation decisions.

Dynamically-encoded high-level agents 5651a-n oversee network-wide encoding optimizations and adaptation strategies. These agents implement hierarchical data collection through high-level activation data collector 5652, which consolidates encoding transformation data across multiple mid-level agents. This data collector applies adaptive multi-scale sampling methods, enabling the monitoring of large-scale encoding patterns and network dynamics. The sophisticated statistical analysis subsystem 5653 within high-level agents executes advanced anomaly detection and causal inference across multiple agent layers. This subsystem applies deep structural analysis techniques to track long-term encoding transformations and optimize data retention strategies.

Performance monitor 5654 within high-level agents implements dynamic adaptation evaluation, ensuring that large-scale modifications align with system-wide optimization goals. This monitor integrates cross-layer encoding adaptation analysis, systematically evaluating the impact of high-level agent modifications on mid- and low-level agent performance. The structural adaptation planner 5655 within high-level agents manages long-term encoding transformation strategies, incorporating global resource optimization frameworks and multi-layer performance balancing. The network modification implementer 5656 executes complex adaptation operations, ensuring network-wide encoding synchronization and preserving system stability during large-scale modifications.

Parameter optimization subsystem 5657 within high-level agents executes real-time encoding parameter tuning, dynamically adjusting compression efficiency, agent interaction thresholds, and network-wide transmission latency constraints. This subsystem ensures that each dynamically-encoded agent maintains encoding efficiency without introducing redundant or conflicting transformations.

Top-level orchestration agents 5658a-n implement comprehensive oversight across adaptive dynamically-encoded agent network 5600. These agents consolidate network-wide encoding adaptation data, executing holistic network performance evaluations through orchestration data collector 5659.

Historical record database 5665 stores long-term encoding adaptation logs, maintaining a distributed storage framework across dynamically-encoded agent network 5600. This database implements temporal encoding management, preserving system evolution data for future optimization cycles. It applies adaptive storage pruning techniques, ensuring that historical encoding data remains relevant while preventing redundant storage overhead.

Adaptive dynamically-encoded agent network 5600 implements multi-scale, hierarchical encoding adaptation, ensuring continuous optimization across all agent layers. Each dynamically-encoded agent executes real-time encoding transformation monitoring, strategic adaptation planning, and structured messaging coordination. The network-wide flow of information enables continuous system refinement, ensuring that adaptive dynamically-encoded agent network 5600 remains efficient and scalable across dynamic operational environments. Dynamically-encoded agents within adaptive dynamically-encoded agent network 5600 interact across layers through structured feedback loops, in an embodiment. Telemetry agents within telemetry layer 5620 continuously collect and analyze encoding efficiency metrics, transmitting optimization recommendations to dynamically-encoded base agents 5631a-n. These recommendations inform encoding adjustments, pruning decisions, and adaptive message-passing protocols between agents. Mid-level dynamically-encoded agents 5641a-n aggregate these telemetry insights to refine encoding policies across agent clusters, ensuring local optimizations align with network-wide adaptation goals. High-level dynamically-encoded agents 5651a-n oversee macro-scale encoding adjustments, propagating performance objectives downward to guide agent transformations while integrating feedback from lower-layer encoding operations. This bidirectional interaction ensures that adaptation remains context-aware and dynamically responsive to evolving network conditions. Historical adaptation database 5665 maintains long-term records of encoding optimizations, agent lifecycle events, and network evolution patterns, allowing dynamically-encoded agents to reference past adaptation strategies for improved future performance.

In an embodiment, data flows through adaptive dynamically-encoded agent network 5600 in a structured, multi-layered process that ensures efficient information propagation, encoding optimization, and adaptive decision-making. Input data enters the base graph layer 5610, where computational nodes process raw information and generate initial encodings. These encodings are transmitted to dynamically-encoded base agents 5631a-n, which refine and optimize the data representations before passing them to telemetry agents in telemetry layer 5620. The telemetry agents analyze encoding efficiency, communication latency, and resource utilization, then relay performance metrics and optimization signals to mid-level dynamically-encoded agents 5641a-n. These mid-level agents execute multi-scale encoding transformations, aggregating data from multiple sources and adjusting encoding strategies based on telemetry insights. High-level dynamically-encoded agents 5651a-n oversee larger network segments, processing cumulative performance metrics and executing large-scale adaptation strategies. Orchestration agents 5658a-n within orchestration layer 5650 coordinate system-wide synchronization, ensuring that optimized encodings, agent modifications, and network restructuring propagate throughout the system while maintaining stability and efficiency.

FIG. 12C is a top-down view of adaptive agent layer 5630, illustrating the interconnected nature of dynamically-encoded base agents 5631a-n, in an embodiment. This layer is responsible for encoding optimization, inter-agent communication, and adaptive decision-making within adaptive dynamically-encoded agent network 5600. Dynamically-encoded base agents 5631a-n form a decentralized, self-optimizing network, exchanging data and adapting encoding strategies based on real-time performance metrics.

One skilled in the art would recognize that while FIG. 12C explicitly depicts an embodiment of the interconnected nature of dynamically-encoded base agents 5631a-n within adaptive agent layer 5630, other layers within adaptive dynamically-encoded agent network 5600 are similarly structured to facilitate efficient data flow, encoding optimization, and adaptive decision-making. For example, in an embodiment where such layers are present, telemetry layer(s) 5620, memory layer(s) 5640, and orchestration layer(s) 5650 each maintain inter-agent communication pathways that enable real-time information exchange, synchronization of encoding strategies, and coordinated adaptation across the network. The principles of distributed encoding refinement, bidirectional data propagation, and agent lifecycle management apply consistently across all layers, ensuring that dynamically-encoded agent networks for optimized deep learning at every level contribute to the overall efficiency and adaptability of the system.

Dynamically-encoded base agents 5631a-n continuously adapt to network demands through an integrated agent lifecycle process that includes both agent generation and pruning. When encoding workloads increase beyond an agent's processing capacity or when telemetry data identifies a need for additional encoding diversity, new dynamically-encoded base agents may be instantiated to redistribute processing tasks and optimize network efficiency. Conversely, if an agent is deemed redundant, inefficient, or inactive based on real-time performance metrics, it may be pruned, with its encoding responsibilities reallocated to neighboring agents. This adaptive lifecycle mechanism ensures that the network remains balanced, scalable, and resource-efficient, preventing unnecessary computational overhead while dynamically adjusting to changing encoding requirements.

Each dynamically-encoded base agent 5631a-n is connected to multiple neighboring agents through inter-agent communication links 5639, forming a web of encoding interactions that facilitates distributed encoding refinement and message-passing efficiency. These agents dynamically adjust their encoding parameters based on local and global optimization objectives, ensuring that encoding strategies remain efficient, adaptive, and resource-aware.

The interconnections between agents 5639 are structured to enable efficient data propagation, redundancy management, and hierarchical adaptation. Some agents act as hubs, handling higher volumes of encoding exchanges, while others specialize in localized encoding refinement and targeted optimization. Connections between agents 5639 may dynamically form or dissolve based on real-time encoding efficiency, workload distribution, and agent lifecycle decisions.

To ensure scalability, the system dynamically adjusts agent density and connectivity based on network demand. When processing loads increase, new dynamically-encoded agents are instantiated to balance encoding workloads and prevent communication bottlenecks. Conversely, when agent density exceeds operational efficiency thresholds, redundant agents may be pruned, preventing unnecessary computational overhead. The scalability mechanisms embedded in agent interactions allow the network to expand or contract in response to evolving performance requirements while maintaining overall stability.

The system also implements robust error correction and fault tolerance mechanisms to ensure encoding reliability. If an agent detects communication failures, corrupted encoding data, or inconsistencies in transmission, it initiates an error recovery protocol that may include automatic retransmission, redundant encoding verification, or real-time adjustments to inter-agent communication links 5639. Additionally, dynamically-encoded agents 5631a-n maintain a distributed validation process, where encoding transformations are periodically cross-verified between agents to detect and correct anomalies before they propagate through the network. In cases where persistent errors are detected, high-level dynamically-encoded agents 5651a-n oversee system-wide corrections, reallocating encoding responsibilities and modifying network topology as needed.

Data flows bidirectionally through the network, with encoding updates propagating between agents 5631a-n via inter-agent communication links 5639 to ensure synchronization and alignment with network-wide performance goals. When an agent detects a performance bottleneck, it may trigger a localized encoding refinement operation, collaborating with neighboring agents to redistribute encoding complexity or generate a new dynamically-encoded agent to balance processing demands. Conversely, if an agent is deemed redundant or inefficient based on telemetry feedback, it may be pruned from the layer, with its encoding responsibilities redistributed among remaining agents.

The interconnected nature of dynamically-encoded base agents 5631a-n enables emergent optimization patterns, where encoding transformations are continuously refined based on collaborative agent interactions. This structure ensures that adaptive agent layer 5630 remains scalable, fault-tolerant, and capable of real-time adjustments in response to evolving data processing requirements.

FIG. 12D is a block diagram illustrating the architecture of adaptive dynamically-encoded agent network 5600 interfacing with machine learning core 1240, in an embodiment. Adaptive dynamically-encoded agent network 5600 is operatively connected to machine learning core 1240 and implements monitoring, optimization, and adaptation of core network structure and function, including real-time encoding transformations, agent lifecycle management, and network topology modifications. Adaptive dynamically-encoded agent network 5600 comprises multiple layers, each facilitating different levels of encoding optimization, agent interactions, and network-wide decision-making. Thus, it is a dynamically-encoded agent network for optimized deep learning.

At the base of adaptive dynamically-encoded agent network 5600 are dynamically-encoded base agents 5631a-n, which directly interface with and monitor computational nodes in machine learning core 1240. Dynamically-encoded base agents 5631a-n collect encoding and transmission efficiency data, track agent communication patterns, and execute localized encoding optimizations. These base agents implement fine-grained adjustments to encoding representations, ensuring that transmitted data retains critical features while minimizing resource overhead. They continuously monitor inter-agent data flow and optimize encoding schemes based on localized performance feedback.

Mid-level dynamically-encoded agents 5641a-n oversee groups of dynamically-encoded base agents, aggregating and analyzing encoding efficiency data from larger sections of machine learning core 1240. Mid-level agents coordinate localized encoding optimization across multiple dynamically-encoded base agents while managing inter-agent transmission pathways and agent topology. These mid-level agents execute region-wide encoding efficiency assessments, track resource utilization, and facilitate distributed encoding adjustments across interconnected agent clusters.

High-level dynamically-encoded agents 5651a-n monitor multiple mid-level dynamically-encoded agents, implementing large-scale encoding optimization and coordinating adaptation across network segments. High-level dynamically-encoded agents execute network-wide capacity analysis and direct large-scale agent modification processes. These agents oversee distributed encoding transformation decisions, ensuring that system-wide encoding adaptations align with long-term optimization goals and operational constraints.

At the highest level, system-wide orchestration agents 5658a-n coordinate network-wide encoding adaptation, managing global encoding transformations, resource distribution, and large-scale agent lifecycle events. These agents implement hierarchical encoding analysis, tracking encoding evolution patterns across dynamically-encoded agents. They manage inter-agent synchronization, ensuring that encoding transformations and topology adjustments are applied consistently throughout adaptive dynamically-encoded agent network 5600.

Each dynamically-encoded agent network layer for optimized deep learning contains specialized subsystems that implement comprehensive monitoring, adaptation, and optimization capabilities. These subsystems include encoding performance monitors, hierarchical statistical analysis modules, inter-agent communication controllers, and structured encoding adaptation planners. Performance monitoring subsystems execute real-time assessments of encoding efficiency, agent interaction latency, and network-wide adaptation impact. Hierarchical statistical analysis subsystems execute multi-scale encoding efficiency tracking, identifying patterns in agent adaptation and encoding optimization trends. Inter-agent communication controllers manage structured information exchange, executing distributed consensus mechanisms to ensure consistency in encoding decisions. Encoding adaptation planners execute strategic encoding transformations, dynamically modifying agent behaviors based on real-time performance insights.

Adaptive dynamically-encoded agent network 5600 interfaces with modification subsystems that implement architectural modifications to machine learning core 1240 based on coordinated adaptation decisions. These modification subsystems execute various structural changes, including encoding optimization, agent pruning, and dynamic agent generation, ensuring that machine learning core 1240 remains adaptable and efficient under changing operational conditions.

Data flows bidirectionally between machine learning core 1240 and adaptive dynamically-encoded agent network 5600. Dynamically-encoded base agents 5631a-n collect activation data, encoding quality metrics, and transmission performance indicators from machine learning core 1240, continuously refining encoding models. This data propagates upward through mid-level and high-level dynamically-encoded agents for broader analysis and strategic optimization. Simultaneously, orchestration agents transmit adaptation strategies downward, ensuring that encoding optimization and agent lifecycle decisions are consistently applied across the network.

Adaptive dynamically-encoded agent network 5600 operates continuously during execution of machine learning core 1240, implementing real-time encoding optimizations, agent-based topology adjustments, and adaptive data transmission strategies. This adaptive architecture enables machine learning core 1240 to dynamically refine its encoding structures, optimize inter-agent communication efficiency, and scale computational resources based on evolving performance requirements.

Adaptive dynamically-encoded agent network 5600 actively refines encoding transformations within machine learning core 1240 by continuously optimizing inter-agent message representations, latent space utilization, and transmission efficiency. Dynamically-encoded base agents 5631a-n directly interact with machine learning core 1240, ensuring that encoded data maintains high-fidelity feature representations while reducing computational overhead. Mid-level dynamically-encoded agents 5641a-n adapt encoding parameters in response to network-wide efficiency trends, optimizing how data propagates through latent transformer architectures within machine learning core 1240. High-level dynamically-encoded agents 5651a-n further refine encoding transformations by analyzing multi-layer encoding performance and adjusting processing flows accordingly. These optimizations dynamically shape how information is processed, ensuring that machine learning core 1240 operates with continuously updated, highly efficient encoding structures that improve inference accuracy and overall system responsiveness.

The data flow process in an embodiment of dynamically-encoded agent network for optimized deep learning begins with raw input 1200, which may represent various data modalities, including text, images, audio, or time series. This input proceeds through data preprocessing modules, which perform segmentation, normalization, and initial encoding transformations. The processed data is then assigned encoding representations through an encoding allocation module, which generates compressed data structures for efficient transmission and processing.

These encoded representations propagate through machine learning core 1240, which applies computational transformations, feature extraction, and learning-based encoding refinements. Throughout this process, dynamically-encoded base agents 5631a-n execute real-time monitoring of encoding transformations, tracking performance and agent-level efficiency metrics. These agents communicate encoding updates to mid-level dynamically-encoded agents 5641a-n, which perform higher-level encoding optimization strategies and transmission adjustments.

High-level dynamically-encoded agents 5651a-n aggregate encoding adaptation data across multiple regions of machine learning core 1240, executing network-wide encoding synchronization and agent lifecycle management. Orchestration agents 5658a-n ensure that all encoding updates, agent topology modifications, and resource optimization processes align with global system objectives.

The final output from machine learning core 1240 is processed through post-processing modules, where final encoding transformations are applied based on learned optimizations. This ensures that the output data retains maximum relevant information while maintaining computational efficiency. The refined output 150 is then transmitted to external applications or decision-making subsystems, completing the data flow cycle of dynamically-encoded agent network for optimized deep learning.

Adaptive dynamically-encoded agent network 5600 continuously evolves based on real-time encoding feedback, ensuring that dynamically-encoded agents optimize network performance under changing operational conditions. By implementing multi-layered encoding transformations, hierarchical agent-based adaptation strategies, and coordinated network-wide optimization, the system maintains efficient, scalable, and adaptable processing capabilities.

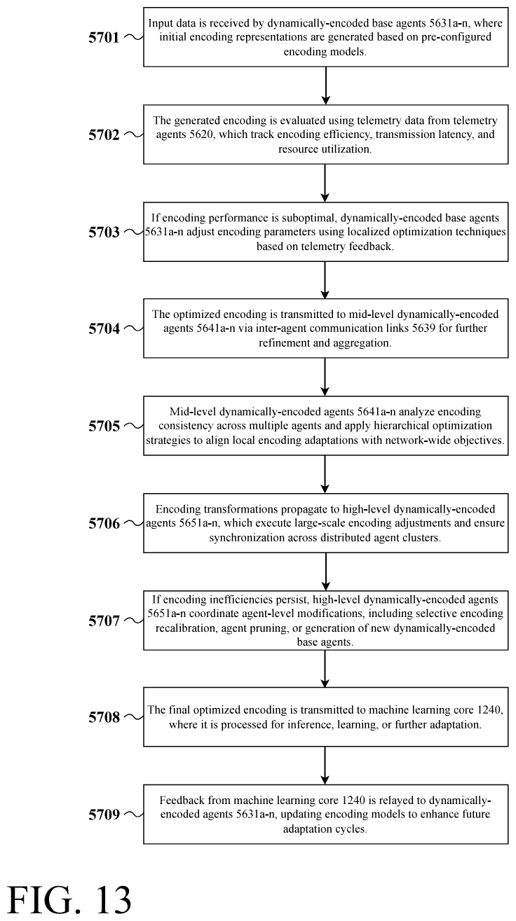

FIG. 13 is a method diagram illustrating the adaptive encoding workflow of adaptive dynamically-encoded agent network 5600, in an embodiment. Input data is received by dynamically-encoded base agents 5631a-n, where initial encoding representations are generated based on pre-configured encoding models tailored to the characteristics of the input data. These encoding models may be dynamically selected based on historical performance, data modality, or real-time telemetry insights 5701. The generated encoding is then evaluated using telemetry data from telemetry agents 5620, which track encoding efficiency, transmission latency, and resource utilization. Telemetry agents assess how well the encoding aligns with system-wide performance objectives and whether adjustments are required to enhance transmission efficiency or reduce computational overhead 5702.

If encoding performance is determined to be suboptimal, dynamically-encoded base agents 5631a-n adjust encoding parameters using localized optimization techniques based on telemetry feedback. These optimizations may include modifying compression ratios, adjusting encoding granularity, or restructuring encoding segments to better fit transmission constraints and downstream processing needs 5703. Once optimized, the encoding is transmitted to mid-level dynamically-encoded agents 5641a-n via inter-agent communication links 5639. Mid-level agents aggregate encoding transformations from multiple base agents and assess their consistency, ensuring that encodings maintain structural coherence across the network 5704.

Mid-level dynamically-encoded agents 5641a-n analyze encoding consistency across multiple agents and apply hierarchical optimization strategies to align local encoding adaptations with network-wide objectives. This process may involve cross-verifying encodings against reference models, adjusting encoding weight distributions, or synchronizing encoding structures between agents within the same processing region 5705. Encoding transformations then propagate to high-level dynamically-encoded agents 5651a-n, which execute large-scale encoding adjustments and ensure synchronization across distributed agent clusters. High-level agents may refine global encoding policies, redistribute encoding complexity, or adjust data transmission pathways to optimize inter-agent communication 5706.

If encoding inefficiencies persist, high-level dynamically-encoded agents 5651a-n coordinate agent-level modifications, including selective encoding recalibration, agent pruning, or generation of new dynamically-encoded base agents. These modifications are implemented based on observed trends in encoding performance, ensuring that the agent network remains balanced and resource-efficient while maintaining high encoding accuracy 5707. The final optimized encoding is then transmitted to machine learning core 1240, where it is processed for inference, learning, or further adaptation. machine learning core 1240 may integrate these encodings into its ongoing computational processes, leveraging optimized representations for predictive modeling or decision-making tasks 5708.

Feedback from machine learning core 1240 is relayed to dynamically-encoded base agents 5631a-n, updating encoding models to enhance future adaptation cycles. This feedback loop ensures that encoding strategies continuously evolve based on changing data patterns and system performance objectives, allowing dynamically-encoded agent network 5600 to refine its encoding processes over time 5709.

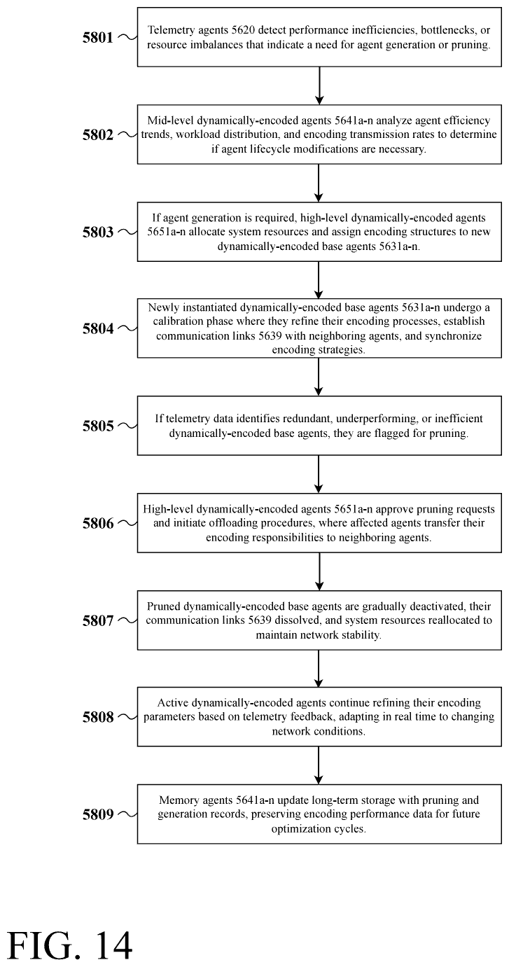

FIG. 14 is a method diagram illustrating the agent lifecycle management process of adaptive dynamically-encoded agent network 5600, in an embodiment. Telemetry agents 5620 detect performance inefficiencies, bottlenecks, or resource imbalances that indicate a need for agent generation or pruning 5801. Upon detecting a potential need for lifecycle modification, mid-level dynamically-encoded agents 5641a-n analyze agent efficiency trends, workload distribution, and encoding transmission rates to determine whether agent generation or pruning is necessary 5802.

If agent generation is required, high-level dynamically-encoded agents 5651a-n allocate system resources and assign encoding structures to new dynamically-encoded base agents 5631a-n. These assignments ensure that newly instantiated agents receive the appropriate encoding templates and communication pathways for seamless integration into the network 5803. Newly instantiated dynamically-encoded base agents 5631a-n undergo a calibration phase, where they refine their encoding processes, establish communication links 5639 with neighboring agents, and synchronize encoding strategies with adjacent nodes 5804.

If telemetry data identifies dynamically-encoded base agents as redundant, underperforming, or inefficient, they are flagged for pruning 5805. High-level dynamically-encoded agents 5651a-n review pruning requests and initiate offloading procedures, where affected agents transfer their encoding responsibilities to neighboring agents before deactivation 5806. Pruned dynamically-encoded base agents are gradually deactivated, their inter-agent communication links 5639 dissolved, and system resources reallocated to maintain network stability and processing efficiency 5807.

Throughout the lifecycle process, active dynamically-encoded agents continuously refine their encoding parameters based on telemetry feedback, adapting in real time to shifting network conditions 5808. The final stage of the lifecycle process involves updating long-term storage within memory agents 5641a-n, ensuring that pruning and generation records are preserved for future optimization cycles and long-term network evolution 5809.

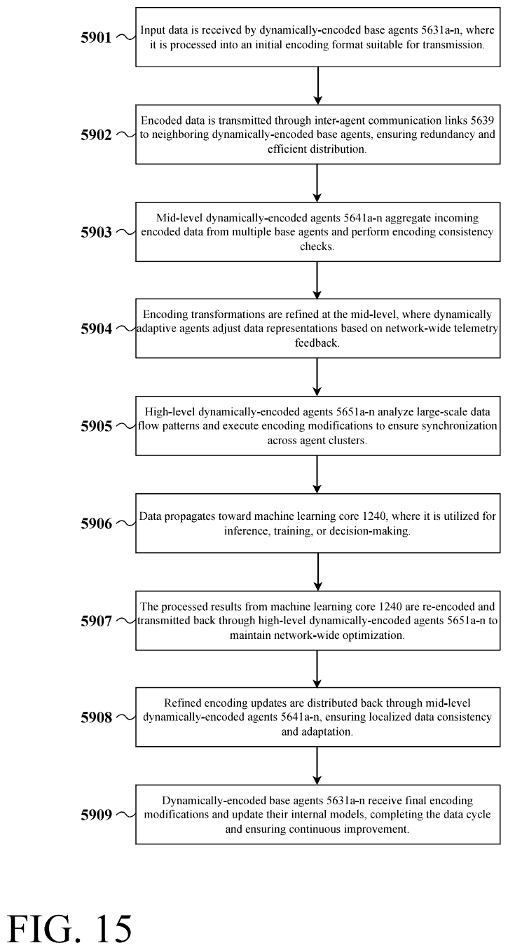

FIG. 15 is a method diagram illustrating the data flow through adaptive dynamically-encoded agent network 5600, in an embodiment. Input data is received by dynamically-encoded base agents 5631a-n, where it is processed into an initial encoding format optimized for efficient transmission across the network 5901. Once encoding is generated, the encoded data is transmitted through inter-agent communication links 5639 to neighboring dynamically-encoded base agents, ensuring redundancy and preventing localized bottlenecks 5902.

Mid-level dynamically-encoded agents 5641a-n receive and aggregate encoded data from multiple base agents, performing consistency checks to verify encoding accuracy and efficiency 5903. At this stage, encoding transformations are refined based on telemetry feedback, with mid-level dynamically-encoded agents adjusting data representations to align with network-wide optimization objectives 5904.

High-level dynamically-encoded agents 5651a-n analyze large-scale data flow patterns, identifying inefficiencies in encoding propagation and executing modifications to maintain synchronization across agent clusters 5905. Once optimized, data is propagated toward machine learning core 1240, where it is used for inference, training, or decision-making processes 5906.

Following processing within machine learning core 1240, the output is re-encoded into an optimized representation and transmitted back through high-level dynamically-encoded agents 5651a-n, ensuring that encoding adjustments reflect system-wide learning improvements 5907. Refined encoding updates are then distributed back through mid-level dynamically-encoded agents 5641a-n, where local encoding refinements are made to ensure continuity and coherence across the agent network 5908.

Finally, dynamically-encoded base agents 5631a-n receive the updated encoding modifications, incorporating the refined transformations into their internal models. This completes the data cycle and ensures that adaptive dynamically-encoded agent network 5600 continuously improves its encoding processes over time 5909.

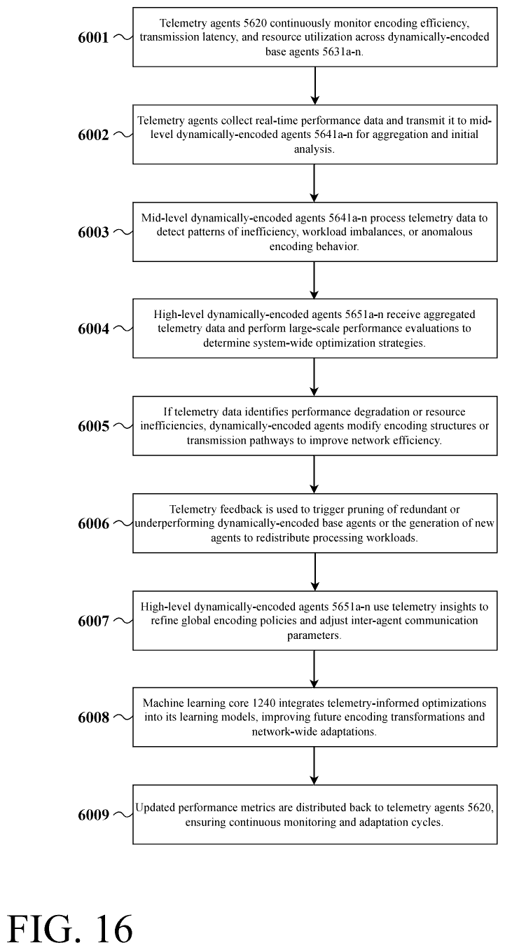

FIG. 16 is a method diagram illustrating telemetry and performance monitoring in adaptive dynamically-encoded agent network 5600, in an embodiment. Telemetry agents 5620 continuously monitor encoding efficiency, transmission latency, and resource utilization across dynamically-encoded base agents 5631a-n, ensuring that real-time performance data is captured for network-wide adaptation 6001. Collected telemetry data is then transmitted to mid-level dynamically-encoded agents 5641a-n, where it is aggregated and analyzed for initial performance assessments 6002.

Mid-level dynamically-encoded agents 5641a-n process the telemetry data to detect patterns of inefficiency, workload imbalances, or anomalous encoding behavior that could impact network performance. These agents evaluate inter-agent communication trends, resource distribution, and encoding transformations to determine whether adjustments are necessary 6003. The aggregated telemetry data is then forwarded to high-level dynamically-encoded agents 5651a-n, which perform large-scale evaluations to assess system-wide optimization needs and encoding efficiency trends 6004.

If telemetry data identifies performance degradation, resource bottlenecks, or underutilized network regions, dynamically-encoded agents modify encoding structures or transmission pathways to improve network efficiency. Adjustments may include refining compression ratios, altering agent-to-agent communication links 5639, or redistributing encoding responsibilities among dynamically-encoded base agents 6005. Telemetry feedback may also trigger pruning of redundant or underperforming dynamically-encoded base agents or the generation of new agents to redistribute processing workloads dynamically 6006.

High-level dynamically-encoded agents 5651a-n use telemetry insights to refine global encoding policies, ensuring that optimization strategies are consistently applied across the network. These agents adjust inter-agent communication parameters, rebalancing network-wide resource allocation to enhance overall stability and efficiency 6007. Telemetry-informed optimizations are then integrated into machine learning core 1240, allowing encoding transformations and processing methodologies to continuously evolve based on system-wide adaptation data 6008.

Finally, updated performance metrics are distributed back to telemetry agents 5620, ensuring that monitoring and adaptation cycles remain continuous. This feedback loop allows adaptive dynamically-encoded agent network 5600 to refine its encoding efficiency, self-optimize resource allocation, and improve overall system responsiveness 6009.

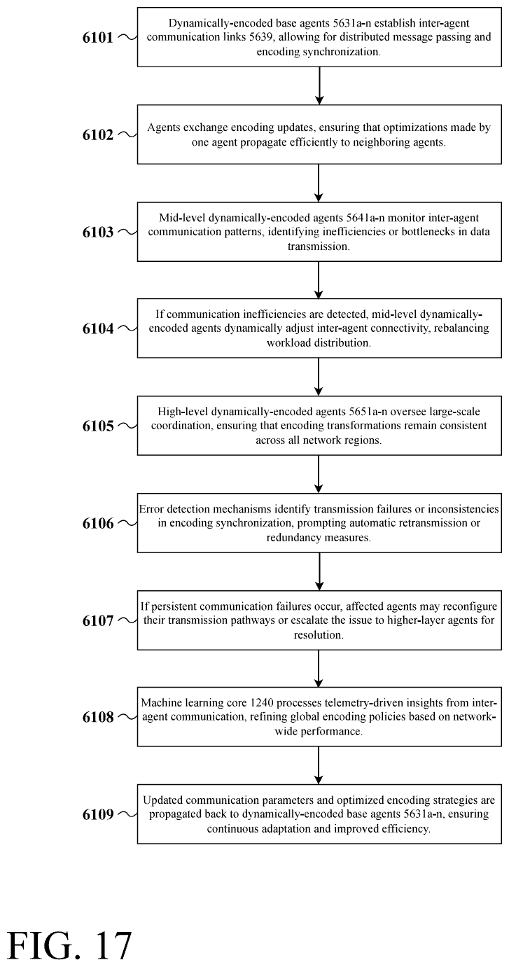

FIG. 17 is a method diagram illustrating inter-agent communication and coordination in adaptive dynamically-encoded agent network 5600, in an embodiment. Dynamically-encoded base agents 5631a-n establish inter-agent communication links 5639, enabling distributed message passing and encoding synchronization across the network. These links allow dynamically-encoded agents to share encoding transformations, collaboratively refine data representations, and optimize processing efficiency 6101. Once established, agents continuously exchange encoding updates, ensuring that optimizations made by one agent propagate efficiently to neighboring agents, preventing redundant processing and improving encoding cohesion across the layer 6102.

Mid-level dynamically-encoded agents 5641a-n monitor inter-agent communication patterns, tracking encoding transmission rates and identifying inefficiencies or bottlenecks in data exchange. If an agent experiences prolonged transmission delays or encoding inconsistencies, mid-level dynamically-encoded agents assess the underlying issue and determine whether connectivity adjustments are needed 6103. If communication inefficiencies are detected, mid-level dynamically-encoded agents dynamically adjust inter-agent connectivity, rebalancing workload distribution to optimize network efficiency and reduce transmission overhead 6104.

High-level dynamically-encoded agents 5651a-n oversee large-scale coordination of inter-agent communication, ensuring that encoding transformations remain consistent across all network regions. These agents implement top-down refinements to prevent encoding divergence and to synchronize network-wide message-passing strategies, ensuring that performance improvements are distributed efficiently 6105. Error detection mechanisms continuously monitor inter-agent exchanges for signs of transmission failures or inconsistencies in encoding synchronization. If errors are identified, affected agents automatically initiate retransmission protocols or engage redundancy measures to prevent data loss 6106.

If persistent communication failures occur, affected agents may reconfigure their transmission pathways by rerouting messages through alternative dynamically-encoded agents or escalating the issue to higher-layer agents for resolution. This process ensures that the system maintains robust fault tolerance and prevents network-wide inefficiencies from affecting downstream encoding operations 6107.

Machine learning core 1240 processes telemetry-driven insights from inter-agent communication, analyzing system-wide data exchange trends and refining global encoding policies accordingly. This integration enables machine learning core 1240 to improve encoding methodologies based on real-world communication efficiency metrics 6108. Finally, updated communication parameters and optimized encoding strategies are propagated back to dynamically-encoded base agents 5631a-n, ensuring continuous adaptation and improved efficiency in future communication cycles 6109.

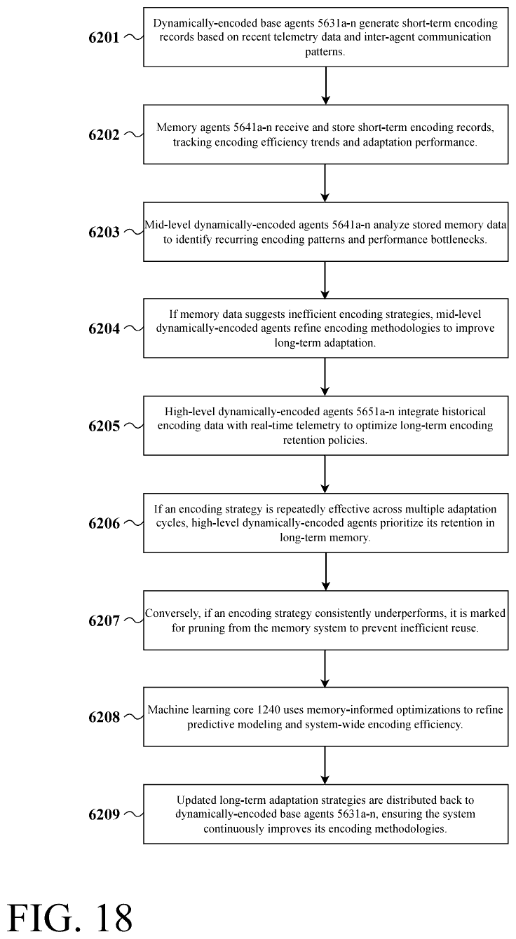

FIG. 18 is a method diagram illustrating memory integration and long-term adaptation in adaptive dynamically-encoded agent network 5600, in an embodiment. Dynamically-encoded base agents 5631a-n generate short-term encoding records based on recent telemetry data and inter-agent communication patterns. These records capture key encoding transformations, transmission efficiencies, and real-time adaptation outcomes, forming the basis for short-term learning within the network 6201.

Memory agents 5641a-n receive and store these short-term encoding records, maintaining structured logs of encoding efficiency trends and adaptation performance. This allows for continuous tracking of encoding evolution over time, enabling dynamically-encoded agents to refine their transformation strategies based on past results 6202. Mid-level dynamically-encoded agents 5641a-n analyze stored memory data to identify recurring encoding patterns, transmission bottlenecks, and processing inefficiencies that may require long-term optimization 6203.

If memory data suggests that an encoding strategy is suboptimal or inefficient, mid-level dynamically-encoded agents refine encoding methodologies by adjusting compression ratios, transmission redundancies, or encoding complexity to improve long-term adaptation 6204. High-level dynamically-encoded agents 5651a-n integrate historical encoding data with real-time telemetry insights, optimizing long-term encoding retention policies to ensure that the network maintains adaptive efficiency without excessive memory overhead 6205.

If an encoding strategy has repeatedly demonstrated high efficiency across multiple adaptation cycles, high-level dynamically-encoded agents prioritize its retention in long-term memory. This allows the system to reinforce proven encoding transformations, improving processing efficiency over time 6206. Conversely, if an encoding strategy consistently underperforms or introduces processing inefficiencies, it is marked for pruning from the memory system to prevent unnecessary computational overhead and ensure that only effective encoding methodologies persist 6207.

Machine learning core 1240 uses memory-informed optimizations to refine predictive modeling, encoding transformation strategies, and system-wide efficiency. This enables the network to continuously evolve based on accumulated performance data, ensuring that encoding decisions are informed by both real-time and historical adaptation insights 6208. Finally, updated long-term adaptation strategies are distributed back to dynamically-encoded base agents 5631a-n, ensuring that dynamically-encoded agent network 5600 continuously improves its encoding methodologies and maintains optimized data flow across all network layers 6209. Memory agents 5641a-n update historical adaptation database 5665 with encoding retention data, ensuring that prior encoding transformations and adaptation trends are preserved for long-term optimization and retrieval by dynamically-encoded agents.

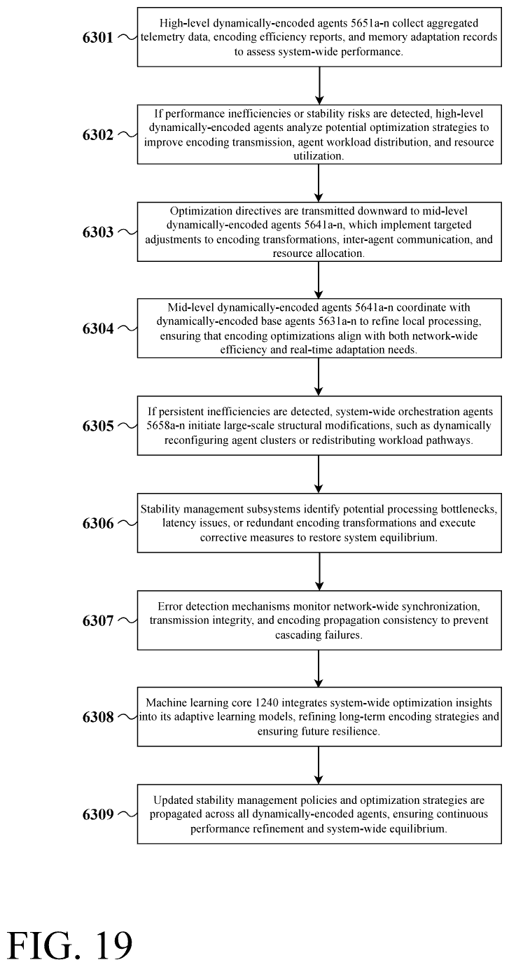

FIG. 19 is a method diagram illustrating system-wide optimization and stability management in adaptive dynamically-encoded agent network 5600, in an embodiment. High-level dynamically-encoded agents 5651a-n collect aggregated telemetry data, encoding efficiency reports, and memory adaptation records to assess system-wide performance trends. These agents analyze inter-agent communication efficiency, encoding transmission integrity, and workload distribution across the network to determine areas requiring optimization 6301.

If performance inefficiencies or stability risks are detected, high-level dynamically-encoded agents evaluate potential optimization strategies to improve encoding transformations, reduce transmission overhead, and rebalance agent workload distribution. This analysis includes detecting redundant encoding pathways, adjusting inter-agent communication links 5639, and optimizing the overall structure of dynamically-encoded agent clusters 6302.

Optimization directives are transmitted downward to mid-level dynamically-encoded agents 5641a-n, which implement targeted refinements to encoding strategies, inter-agent communication efficiency, and local processing parameters. These adjustments help prevent inefficiencies from propagating throughout the network and ensure that optimizations are applied in a structured, scalable manner 6303.

Mid-level dynamically-encoded agents 5641a-n then coordinate with dynamically-encoded base agents 5631a-n to refine local encoding processing, ensuring that optimizations align with network-wide adaptation objectives. Localized refinements may include adjusting encoding compression ratios, modifying data retention policies, or dynamically restructuring agent communication pathways to maximize performance 6304.

If persistent inefficiencies are identified despite localized optimizations, system-wide orchestration agents 5658a-n initiate large-scale structural modifications, dynamically reconfiguring agent clusters or redistributing workload pathways to optimize network stability and performance. These modifications help rebalance processing loads, prevent communication bottlenecks, and maintain efficiency across all network layers 6305.

Stability management subsystems continuously identify potential processing bottlenecks, transmission latency issues, and redundant encoding transformations, executing corrective measures to restore system equilibrium. These measures may include adaptive load redistribution, encoding recalibration, or real-time topology restructuring 6306.

Error detection mechanisms monitor network-wide synchronization, transmission integrity, and encoding propagation consistency to prevent cascading failures. If inconsistencies are detected, dynamically-encoded agents automatically adjust communication patterns or trigger failover mechanisms to maintain uninterrupted processing 6307.

Machine learning core 1240 integrates system-wide optimization insights into its adaptive learning models, refining long-term encoding strategies and ensuring future resilience. By incorporating real-time telemetry and performance feedback into its optimization framework, machine learning core 1240 continuously evolves to enhance overall encoding efficiency and network stability 6308.

Finally, updated stability management policies and optimization strategies are propagated across all dynamically-encoded agents, ensuring continuous performance refinement and system-wide equilibrium. These updates allow adaptive dynamically-encoded agent network 5600 to remain highly resilient, scalable, and capable of adapting to fluctuating operational demands 6309.

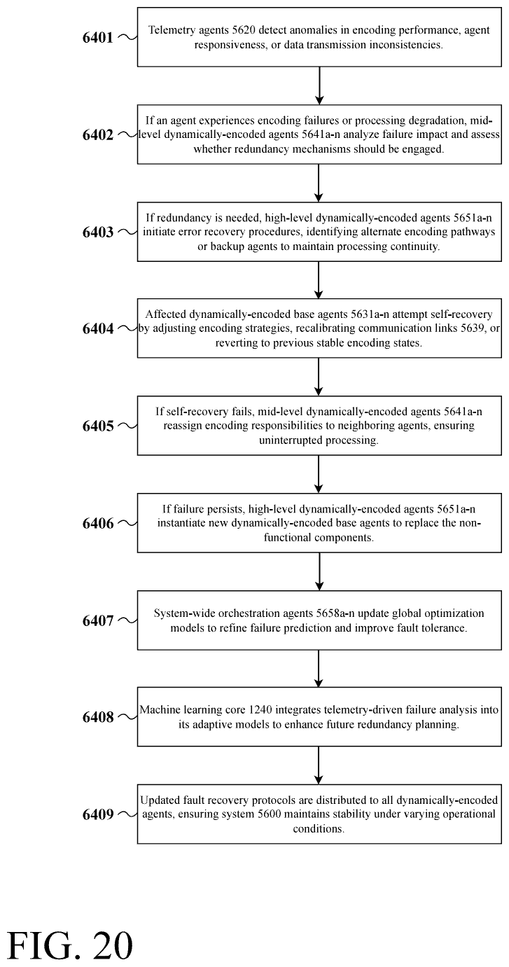

FIG. 20 is a method diagram illustrating fault recovery and redundancy handling in adaptive dynamically-encoded agent network 5600, in an embodiment. Telemetry agents 5620 continuously monitor encoding performance, agent responsiveness, and data transmission consistency, detecting anomalies that may indicate failures in encoding propagation or agent processing 6401.

If an agent experiences encoding failures, excessive transmission delays, or performance degradation, mid-level dynamically-encoded agents 5641a-n analyze the impact of the failure and assess whether redundancy mechanisms should be engaged to prevent system-wide inefficiencies 6402. If redundancy is required, high-level dynamically-encoded agents 5651a-n initiate error recovery procedures, identifying alternate encoding pathways or backup dynamically-encoded agents that can assume processing responsibilities 6403.

Affected dynamically-encoded base agents 5631a-n attempt self-recovery by recalibrating encoding parameters, adjusting communication links 5639, or reverting to previous stable encoding states. This localized recovery mechanism ensures minimal disruption to network processing 6404. If self-recovery fails, mid-level dynamically-encoded agents 5641a-n redistribute encoding responsibilities among neighboring dynamically-encoded base agents, allowing processing to continue without interruption 6405.

If failure persists and redundancy measures are insufficient, high-level dynamically-encoded agents 5651a-n instantiate new dynamically-encoded base agents to replace non-functional components, ensuring that network integrity and processing continuity are maintained 6406. System-wide orchestration agents 5658a-n update global optimization models to refine failure prediction, continuously improving the network's ability to handle future faults through adaptive redundancy mechanisms 6407.

Machine learning core 1240 integrates telemetry-driven failure analysis into its adaptive learning models, refining its ability to predict agent failures and recommend proactive redundancy measures to minimize future disruptions 6408. Finally, updated fault recovery protocols are distributed to all dynamically-encoded agents, ensuring that adaptive dynamically-encoded agent network 5600 maintains stability under varying operational conditions 6409.

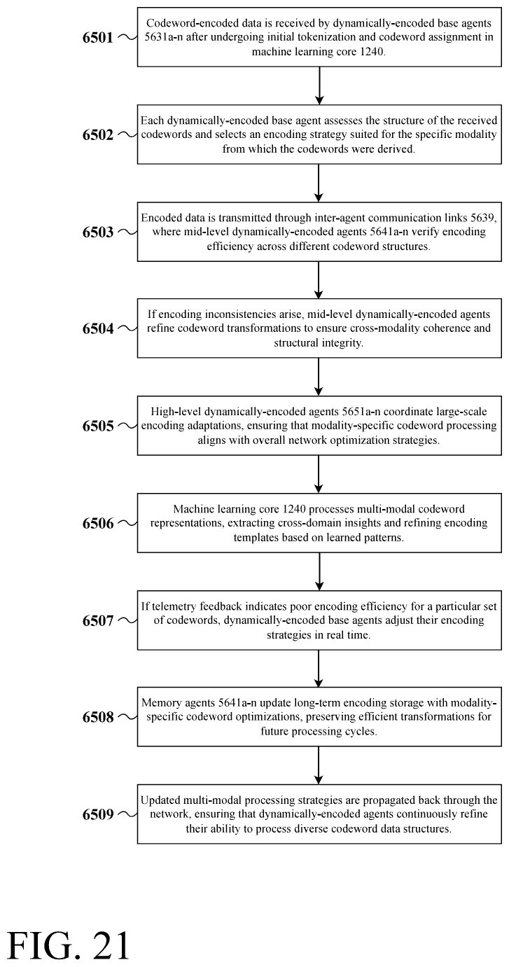

FIG. 21 is a method diagram illustrating adaptive processing of multi-modal codeword data in adaptive dynamically-encoded agent network 5600, in an embodiment. Codeword-encoded data is received by dynamically-encoded base agents 5631a-n after undergoing initial tokenization and codeword assignment in machine learning core 1240. These codewords represent structured transformations of original input data, optimized for transmission and processing within the dynamically-encoded agent network 6501.

Each dynamically-encoded base agent assesses the structure of the received codewords and selects an encoding strategy best suited for the specific modality from which the codewords were derived. This selection ensures that encoding efficiency is maintained while preserving relevant data characteristics 6502. Encoded data is then transmitted through inter-agent communication links 5639, where mid-level dynamically-encoded agents 5641a-n verify encoding efficiency across different codeword structures, ensuring that transformations align with system-wide optimization objectives 6503.

If encoding inconsistencies arise, mid-level dynamically-encoded agents refine codeword transformations to ensure cross-modality coherence and structural integrity, modifying encoding parameters or adjusting compression ratios to prevent data loss or degradation 6504. High-level dynamically-encoded agents 5651a-n coordinate large-scale encoding adaptations, aligning modality-specific codeword processing with overall network performance goals 6505.

Machine learning core 1240 processes multi-modal codeword representations, analyzing cross-domain relationships and refining encoding templates based on learned patterns. These insights enable dynamically-encoded agents to continuously improve their transformation methodologies for future encoding cycles 6506. If telemetry feedback indicates poor encoding efficiency for a particular set of codewords, dynamically-encoded base agents adjust their encoding strategies in real time, modifying encoding weight distributions, feature extraction parameters, or transmission pathways 6507.

Memory agents 5641a-n update long-term encoding storage with modality-specific codeword optimizations, preserving efficient transformations for future processing cycles. This ensures that encoding strategies remain adaptable while preventing redundant or inefficient transformations from persisting 6508. Finally, updated multi-modal processing strategies are propagated back through the network, ensuring that dynamically-encoded agents continuously refine their ability to process diverse codeword data structures while maintaining encoding efficiency 6509.

In a non-limiting use case example of adaptive dynamically-encoded agent network 5600, the dynamically-encoded agent network for optimized deep learning system is deployed to process and analyze real-time financial market data, dynamically optimizing encoding transformations for rapid, high-precision decision-making. Modern financial markets generate vast volumes of high-frequency data, including stock price fluctuations, trading volumes, macroeconomic indicators, social sentiment analytics, and alternative data sources such as satellite imagery and supply chain metrics. To process and extract meaningful insights from this data, system 5600 first converts raw financial inputs into structured codeword representations via machine learning core 1240.

Dynamically-encoded base agents 5631a-n receive these codeword representations and optimize their structure for transmission efficiency and real-time processing. Agents apply encoding transformations that prioritize high-impact financial signals while filtering out noise, allowing for more accurate short-term trend analysis and anomaly detection. These optimizations ensure that trading algorithms and predictive models are fed with the most relevant market indicators while reducing computational overhead.

Telemetry agents 5620 continuously track encoding efficiency, latency, and information density, detecting periods of market turbulence—such as earnings announcements, geopolitical events, or flash crashes—where encoding strategies must adapt in real time. If encoding inefficiencies emerge, mid-level dynamically-encoded agents 5641a-n modify compression levels, reallocate workload assignments among base agents, and introduce redundancy measures to ensure that critical financial signals are not lost.

As large-scale financial trends emerge, high-level dynamically-encoded agents 5651a-n coordinate network-wide encoding refinements, ensuring that dynamically-encoded agent network 5600 remains responsive to shifting market conditions. These agents dynamically adjust encoding precision for different asset classes, such as equities, commodities, or cryptocurrencies, optimizing the system's ability to identify profitable trading opportunities across diverse investment portfolios.

Additionally, memory agents 5641a-n retain historical encoding adaptations, allowing financial institutions to recall and refine predictive models based on prior market events. By leveraging long-term encoding retention, dynamically-encoded agent network 5600 continuously enhances its market forecasting capabilities, providing traders and automated systems with more reliable and actionable insights.

By dynamically optimizing encoding transformations, pruning redundant agents, and refining predictive modeling with memory agents, system 5600 enables hedge funds, algorithmic traders, and financial analysts to process high-frequency market data with enhanced precision, reduced latency, and improved decision-making efficiency.

In another non-limiting use case example of adaptive dynamically-encoded agent network 5600, the system is integrated into an adaptive sensor network for autonomous vehicles, optimizing encoding strategies for real-time perception, environmental awareness, and intelligent decision-making. Autonomous driving systems rely on a combination of LiDAR, radar, cameras, GPS, and vehicle-to-vehicle (V2V) communication to navigate complex and unpredictable road environments. The vast amount of sensory data generated by these systems must be efficiently processed to enable split-second decision-making while minimizing computational overhead and power consumption.

As raw sensory data is collected, machine learning core 1240 converts it into structured codeword representations, allowing for efficient compression and real-time transmission. Dynamically-encoded base agents 5631a-n receive these codeword representations and optimize them based on environmental context, dynamically adjusting encoding resolution to prioritize critical objects such as pedestrians, vehicles, and traffic signals while deprioritizing redundant or irrelevant data such as stationary road signs or background scenery.

Telemetry agents 5620 continuously monitor encoding efficiency, ensuring that dynamically-encoded agents adapt to road conditions in real time. For example, in high-speed highway environments, encoding transformations may prioritize vehicle trajectory predictions and lane-keeping models, whereas in urban settings, dynamically-encoded agents may focus on detecting pedestrians and cyclists. If telemetry feedback detects bottlenecks in encoding transmission rates or identifies resource imbalances, mid-level dynamically-encoded agents 5641a-n redistribute processing workloads, adjust encoding strategies, or reconfigure inter-agent communication links 5639 to optimize information flow.

High-level dynamically-encoded agents 5651a-n oversee large-scale encoding adaptations across the vehicle's sensor network. In adverse weather conditions, such as fog or heavy rain, these agents may increase redundancy in LiDAR-based encodings to compensate for reduced camera visibility. Similarly, in traffic-dense environments, they may adjust encoding prioritization to enhance object detection capabilities and prevent potential collisions.

To ensure long-term performance improvements, memory agents 5641a-n store encoding optimizations specific to various driving conditions. If an autonomous vehicle repeatedly encounters a complex urban intersection or a high-risk merging scenario, memory agents retain refined encoding strategies that enhance the system's ability to process future encounters more efficiently. Over time, system 5600 enables vehicles to develop adaptive driving intelligence, continuously refining their perception and decision-making models through an iterative encoding learning process.

By dynamically optimizing encoding strategies, redistributing processing loads, and leveraging long-term memory for environment-specific adaptations, adaptive dynamically-encoded agent network 5600 enables autonomous vehicles to achieve superior situational awareness, reduce latency in critical decision-making, and enhance overall safety and efficiency on the road.

One skilled in the art would recognize that adaptive dynamically-encoded agent network 5600 may be applied to a wide range of domains beyond the specific use case examples provided herein. These examples are non-limiting in nature and are intended to illustrate certain capabilities of the system rather than define its scope. Dynamically-encoded agent network for optimized deep learning may be implemented in any application where dynamic encoding optimization, adaptive data processing, or intelligent resource allocation is beneficial. Potential applications include but are not limited to distributed computing networks, intelligent edge computing, adaptive communication protocols, cybersecurity threat detection, biological signal processing, and real-time industrial automation. The principles of encoding refinement, agent-based adaptation, and telemetry-driven optimization may be customized for varying data types, network architectures, and computational environments. Furthermore, one skilled in the art would recognize that modifications to system architecture, encoding methodologies, or adaptation strategies may be made without departing from the spirit and scope of the invention.

### Hierarchical Thought Supervision Network System Architecture

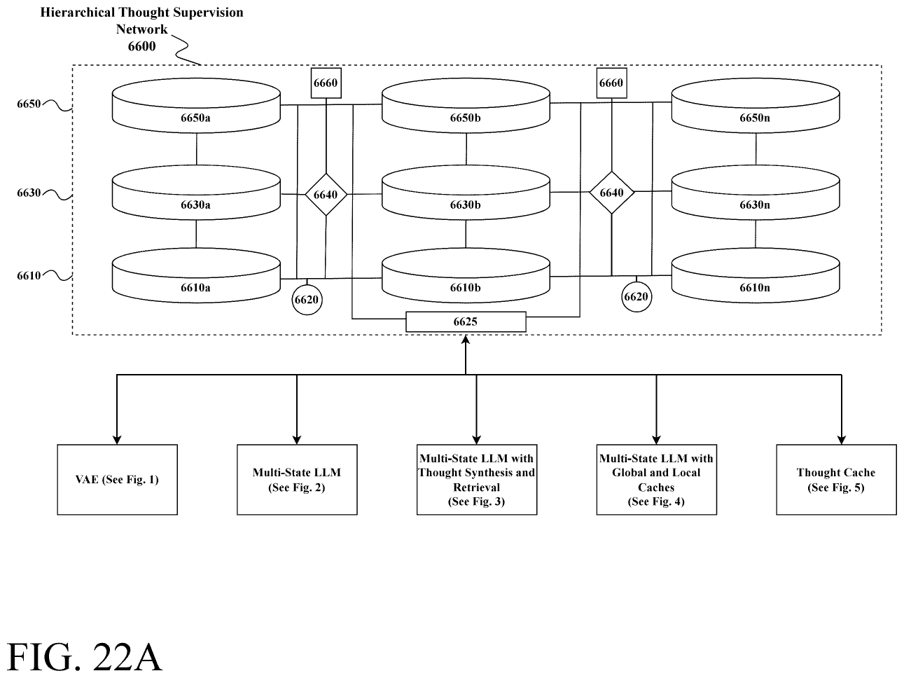

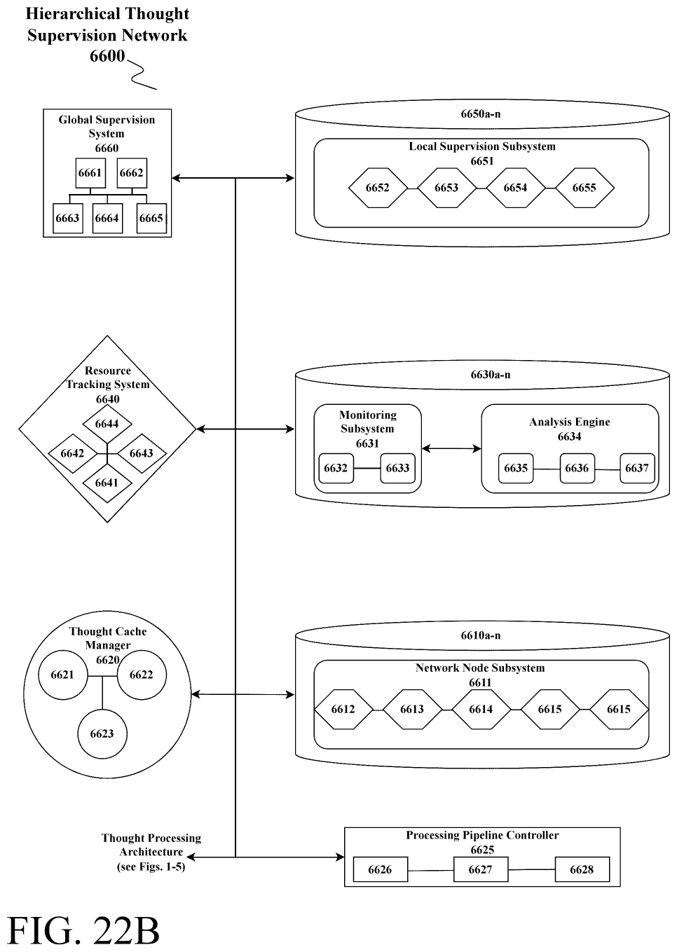

FIG. 22A is a block diagram illustrating exemplary architecture of hierarchical thought supervision network 6600 with thought processing and caching core (illustrated in FIGS. 1-5), in an embodiment. One skilled in the art would recognize that various implementations of hierarchical thought supervision network 6600 are possible, with different embodiments potentially including or omitting various elements based on specific implementation requirements, computational resources, deployment environments, and operational objectives. System components described herein may be implemented through hardware, software, firmware, or combinations thereof. In some implementations, certain components may be combined while in others they may be further subdivided into additional subcomponents. Various arrangements of components may be employed, and specific data flows or component interactions described herein represent exemplary implementations rather than limiting configurations. Additionally, functionality described in relation to certain components may be incorporated into other components in some implementations, and the names of components are for descriptive purposes rather than limiting their functionality. System scale may vary from small deployments to large distributed implementations, with components potentially being added or removed based on scaling requirements. Performance characteristics, operational parameters, and specific implementation details may vary based on deployment context, available resources, and specific use cases. For example, in resource-constrained environments, certain monitoring or optimization components might be simplified or omitted, while in large-scale deployments, additional layers of supervision or specialized processing components might be implemented to handle increased complexity and scale. Machine learning components described herein may be implemented using various model architectures and training approaches depending on specific requirements and available training data.

In an embodiment, hierarchical thought supervision network 6600 comprises base graph layer 6610, telemetry layer 6630, supervision layer 6650, and thought processing core integration. These layers comprise multiple interconnected processing nodes 6610a-n, 6630a-n, and 6650a-n, arranged hierarchically to serve as foundation for thought processing operations.

In an embodiment, hierarchical thought supervision network 6600 interacts with and enhances the latent transformer architecture described in FIG. 1 through coordinated optimization of the VAE processing pipeline. Base graph layer 6610a-n interfaces directly with VAE encoder subsystem 200, latent transformer subsystem 220, and VAE decoder subsystem 240, enabling supervision of latent space transformations. Telemetry layer 6630a-n monitors encoding efficiency and latent space utilization, while supervision layer 6650a-n optimizes encoding parameters and transformation strategies across the VAE pipeline.

The system may enhance the multi-state LLM architecture of FIG. 2 by implementing hierarchical supervision over model interactions. Base graph layer 6610a-n interfaces with both large language model 300 and smaller language model 340, while incorporating router 310's functionality through intelligent node-based routing. Telemetry layer 6630a-n monitors model performance and interaction patterns, enabling supervision layer 6650a-n to optimize resource allocation between models and refine routing strategies.

For the thought synthesis and retrieval capabilities described in FIG. 3, system 6600 may implement sophisticated monitoring and optimization of thought generation and combination processes. Base graph layer 6610a-n interfaces with synthesizer 430, while telemetry layer 6630a-n tracks the effectiveness of thought combinations. Supervision layer 6650a-n optimizes synthesis strategies by monitoring the generation of new thoughts T₁ 410 from existing thoughts T₀ 400, ensuring efficient thought refinement and adaptation.

The system may extend the local and global cache architecture presented in FIG. 4 through hierarchical cache supervision. Thought cache manager 6620 within base graph layer 6610a-n coordinates with both local cache 510 and global cache 530, implementing sophisticated cache optimization strategies. Telemetry layer 6630a-n monitors cache performance across both local and global scales, while supervision layer 6650a-n manages cache coherence and optimizes thought distribution between cache levels.

For the thought cache architecture detailed in FIG. 5, system 6600 could implement comprehensive cache supervision and optimization. Base graph layer 6610a-n interfaces with both recent thoughts 1020 and consolidated thoughts 1040, while telemetry layer 6630a-n monitors thought retention and consolidation effectiveness. Supervision layer 6650a-n optimizes the progression of thoughts between active session cache 1030 and persistent cache 1050, ensuring efficient thought storage and retrieval across the memory hierarchy.

In an embodiment, hierarchical thought supervision network 6600 comprises three primary layers: base graph layer 6610, telemetry layer 6630, and supervision layer 6650. Each layer contains multiple nodes (denoted as 6610a-n, 6630a-n, and 6650a-n respectively) that work together to enable hierarchical thought supervision.

Each node 6610a-n within base graph layer 6610 implements a network node subsystem 6611 that manages thought processing operations. This subsystem includes computational nodes 6612 for distributed processing, thought processing units 6613 for executing operations, and an encoding transformation controller 6614 for managing data transformations. Each base layer node also contains a node state manager 6615 and node communication controller 6616 to coordinate operations with other nodes.

Within telemetry layer 6630, each monitoring node 6630a-n contains a monitoring subsystem 6631 that implements the node's telemetry functions. This includes performance metric collectors 6632 and efficiency analyzers 6633 within each node. Each telemetry node also contains an analysis engine 6634 with kernel function processor 6635, topology analysis unit 6636, and metric aggregation system 6637, enabling distributed monitoring across the network.

Each supervisory node 6650a-n within supervision layer 6650 contains a local supervision subsystem 6651 that manages optimization within its assigned network region. This includes node generation controller 6652, pruning management unit 6653, local optimization engine 6654, and error recovery handler 6655. Additionally, certain supervisory nodes implement global supervision controller 6660 functionality to coordinate network-wide operations.

In an embodiment, supervisory nodes 6650a-n may dynamically instantiate new cache structures based on observed system requirements and performance metrics. These caches may be created at either local or global scope depending on the detected need. For example, if telemetry data indicates frequent access patterns for specific types of thoughts or prompts from the base system, a supervisory node may establish a specialized cache to optimize access to this frequently-used data. Cache creation decisions may be driven by various factors including but not limited to thought access patterns, prompt processing requirements, resource availability, and system performance objectives. This dynamic cache creation capability enables the system to adaptively optimize its storage architecture based on actual usage patterns and computational demands. Thought cache manager 6620 may implement cache creation and management capabilities in response to directives from supervision layer 6650a-n, enabling dynamic instantiation of new cache structures at both local and global levels based on system requirements.

While many components may exist within individual nodes of each layer according to various embodiments, hierarchical thought supervision network 6600 may also implement several shared infrastructure systems that operate across all nodes and layers. Processing pipeline controller 6626 serves as a central management system for thought flow throughout the network, using input handler 6626 for receiving thoughts, transformation sequencer 6627 for coordinating processing steps, and output generator 6628 for producing final outputs. Resource tracking system 6640 implements network-wide monitoring infrastructure through memory usage monitor 6641, computation load tracker 6642, network utilization analyzer 6643, and storage efficiency monitor 6644, enabling comprehensive resource monitoring across all nodes and layers. Global supervision controller 6660 provides centralized coordination through cross-layer coordinator 6661, resource allocation manager 6662, system-wide optimizer 6663, configuration manager 6664, and synchronization controller 6665. These shared systems enable coordinated operation of the entire network while maintaining efficiency at both local and global scales. Information flows bidirectionally between layers, with thoughts propagating through processing pipeline while telemetry data and optimization signals flow between monitoring and supervision components. Through coordinated operation of these components, hierarchical thought supervision network 6600 maintains efficient thought processing while dynamically adapting to computational demands.

Hierarchical thought supervision network 6600 implements comprehensive monitoring of thought cache operations through coordinated local and global tracking mechanisms. Local cache controller 6621 maintains detailed usage statistics for recently accessed thoughts, tracking access patterns, retrieval latency, and cache hit rates. Memory usage monitor 6641 analyzes local cache utilization, enabling dynamic adjustment of cache allocation based on thought access frequency and processing requirements. At global level, global cache interface 6622 coordinates with storage efficiency monitor 6644 to track distributed thought storage patterns and synchronization effectiveness across system components. Resource tracking system 6640 aggregates cache performance metrics through computation load tracker 6642 and network utilization analyzer 6643, providing insights into cache efficiency at both local and global scales. When performance metrics indicate suboptimal cache utilization, system-wide optimizer 6663 coordinates with configuration manager 6664 to refine cache parameters and thought distribution policies. Synchronization controller 6665 ensures coherence between local and global caches, managing thought migration and replication based on usage patterns and system demands. Through continuous monitoring and adaptation of both cache levels, hierarchical thought supervision network 6600 maintains efficient thought access while optimizing storage resource utilization across distributed components.

In an embodiment, hierarchical thought supervision network 6600 may integrate with and enhance the multi-state language model architecture through various coordinated operations of its layered components. The integration points and relationships described herein represent exemplary implementations, and one skilled in the art would recognize that multiple alternative integration approaches and system configurations are possible. The specific arrangement of components and data flows may vary based on implementation requirements, available resources, and operational objectives.

Base graph layer 6610 may, for example, interface with both the large language model 300 and smaller language model 340 through specialized processing nodes, though other interface configurations are possible. Network node subsystem 6611 may implement routing functionality (similar to that previously handled by router 310) by dynamically directing thought processing between the large and small models based on telemetry feedback and supervision directives, though alternative routing architectures and decision mechanisms could be employed.

Thought cache manager 6620 may extend the thought cache architecture by implementing hierarchical storage across both local and global scopes, though other storage hierarchies and organizations are possible. Local cache controller 6621 may handle immediate model-specific caching needs while global cache interface 6622 may manage broader thought distribution and retrieval across the entire system, though alternative cache management strategies could be implemented.

The supervision capabilities may be implemented through supervision layer 6650's hierarchical structure, though other supervision architectures are possible. Local supervision subsystem 6651 may handle model-specific optimizations while global supervision controller 6660 may coordinate system-wide adaptations, though alternative optimization and coordination approaches could be employed. Processing pipeline controller 6626 may coordinate the flow of thoughts through the integrated system components, though alternative flow control mechanisms are possible.

While specific data flows and relationships between components are described herein, one skilled in the art would recognize that multiple integration points and alternative data pathways between system components are possible. The system architecture supports flexible configuration and adaptation of component interactions based on specific implementation needs and operational requirements.

In an embodiment, hierarchical thought supervision network 6600 enhances the unlimited context capabilities of the original system through coordinated cache management and supervision. Base graph layer 6610 maintains context through progressive thought abstraction, where each processing node 6610a-n can process thoughts at different levels of abstraction. This hierarchical approach allows the system to maintain effectively unlimited context by storing recent thoughts with full fidelity in local cache controller 6621 while progressively synthesizing older thoughts into more abstract representations managed by global cache interface 6622. Supervision layer 6650 oversees this abstraction process, ensuring that essential contextual relationships are preserved while optimizing storage and processing resources.

The coordination between local and global components across supervision and caching layers implements a multi-tiered optimization strategy. Local supervision subsystem 6651 directly monitors and optimizes local cache operations through local cache controller 6621, enabling rapid adaptation to immediate processing needs. Simultaneously, global supervision controller 6660 coordinates with global cache interface 6622 to manage broader thought distribution and abstraction patterns across the network. This layered relationship enables efficient thought processing at multiple scales-local supervisory nodes can optimize immediate thought processing and caching operations, while global supervisory nodes ensure efficient thought distribution and long-term context maintenance across the entire network. The telemetry layer 6630a-n provides continuous feedback about both local and global operations, enabling dynamic adjustment of both supervision and caching strategies based on real-time performance metrics.

In an embodiment, data flows through hierarchical thought supervision network 6600 following structured pathways that enable efficient thought processing and optimization. Initial thought inputs enter through input handler 6626, where processing pipeline controller 6626 coordinates their distribution to computational nodes 6612. Network node subsystem 6611 processes these thoughts through thought processing units 6613, applying encoding transformations via encoding transformation controller 6614. Processed thoughts flow to thought cache manager 6620, where local cache controller 6621 handles immediate storage needs while global cache interface 6622 manages broader distribution.

During processing, monitoring subsystem 6631 continuously collects performance data through metric collectors 6632, while efficiency analyzers 6633 evaluate processing effectiveness. Analysis engine 6634 processes this telemetry data using kernel function processor 6635 and topology analysis unit 6636, with metric aggregation system 6637 consolidating insights. Pattern detection engine 6638 identifies recurring patterns in thought processing performance.

Supervision layer 6650 receives analyzed telemetry data, with local supervision subsystem 6651 implementing immediate optimizations while global supervision controller 6660 coordinates system-wide adjustments. Node generation controller 6652 and pruning management unit 6653 modify network structure based on performance requirements, while local optimization engine 6654 refines processing parameters. Processed thoughts flow through base transformer system, where VAE encoder subsystem 200 compresses thoughts into latent space for processing by latent transformer subsystem 220.

Output generator 6628 prepares processed thoughts for transmission, incorporating optimization feedback from supervision layer 6650. Throughout operation, synchronization controller 6665 maintains coherence across system components, while configuration manager 6664 ensures optimal system configuration based on processing demands.

FIG. 22B is a block diagram illustrating exemplary architecture of hierarchical thought supervision network 6600, in an embodiment. Hierarchical thought supervision network 6600 implements layered optimization through coordinated operation of nodes within base graph layer 6610, telemetry layer 6630, and supervision layer 6650. Base graph layer 6610 with nodes 6610a-n comprises network node subsystem 6611, which manages computational nodes 6612 and coordinates their operation through node state manager 6615 and node communication controller 6616. Thought processing units 6613 execute encoding operations under direction of encoding transformation controller 6614.

Within base graph layer 6610, thought cache manager 6620 implements distributed storage through coordination of local cache controller 6621 and global cache interface 6622, where local cache controller 6621 may, for example, maintain frequently accessed thoughts in high-speed memory while implementing progressive compression for less frequently accessed data. Global cache interface 6622 may coordinate distributed storage operations across multiple system nodes, implementing sophisticated synchronization protocols to maintain cache coherence while minimizing communication overhead. Thought storage manager 6623 handles physical storage allocation and maintenance, which may include implementing multi-tiered storage strategies with dynamic data placement optimization. Processing pipeline controller 6626 manages operational flow through input handler 6626, transformation sequencer 6627, and output generator 6628, where input handler 6626 may, for example, prepare thoughts for processing by validating formats and optimizing encoding schemes.

Thought cache manager 6620 implements distributed storage across base layer nodes 6610a-n through coordination of local cache controller 6621 and global cache interface 6622. Each processing node maintains its own local cache, managed by local cache controller 6621, which maintains frequently accessed thoughts in high-speed memory while implementing progressive compression for less frequently accessed data. Global cache interface 6622 coordinates cache operations across all nodes in the network, implementing sophisticated synchronization protocols to maintain cache coherence while minimizing inter-node communication overhead.

Telemetry layer 6630, comprised of telemetry nodes 6630a-n, executes continuous monitoring through monitoring subsystem 6631, which incorporates performance metric collectors 6632 and efficiency analyzers 6633. For example, performance metric collectors 6632 may gather data about thought processing efficiency, resource utilization, and operation timing, while efficiency analyzers 6633 may process telemetry data to identify optimization opportunities.

Analysis engine 6634 processes telemetry data collected across monitoring nodes 6630a-n using kernel function processor 6635 and topology analysis unit 6636, while metric aggregation system 6637 consolidates performance insights from all nodes. Pattern detection engine 6638 identifies recurring patterns in node behavior and interactions across all layers, analyzing both individual node performance and collective node dynamics. Resource tracking system 6640 monitors system utilization across all nodes through memory usage monitor 6641, computation load tracker 6642, and network utilization analyzer 6643.

Analysis engine 6634 processes monitoring data using kernel function processor 6635, topology analysis unit 6636, and metric aggregation system 6637, where kernel function processor 6635 may, in an embodiment, implement adaptive monitoring strategies that adjust sampling rates based on observed system behavior. Pattern detection engine 6638 identifies operational trends and may employ multiple analysis techniques simultaneously, combining results through weighted voting mechanisms to improve pattern detection reliability. Resource tracking system 6640 monitors utilization through memory usage monitor 6641, computation load tracker 6642, network utilization analyzer 6643, and storage efficiency monitor 6644, where these components may dynamically adjust their monitoring granularity based on observed volatility in resource utilization patterns.

Each supervisory node within 6650a-n can independently initiate local optimizations while participating in network-wide adaptation strategies. Local optimization engine 6654 implements targeted improvements based on telemetry feedback from corresponding monitoring nodes, while global supervision controller 6660 coordinates larger-scale adjustments across multiple node clusters. This multi-level node structure enables both fine-grained local optimization and efficient system-wide adaptation.

Supervision layer 6650 implements hierarchical optimization through local supervision subsystem 6651 and global supervision controller 6660, where local supervision subsystem 6651 may continuously monitor and optimize operations within assigned network regions. Local supervision subsystem 6651 manages node-level operations through node generation controller 6652, pruning management unit 6653, and local optimization engine 6654, with error recovery handler 6655 maintaining operational stability. For example, node generation controller 6652 may analyze telemetry data to identify opportunities for enhancing processing capacity through targeted node creation, while pruning management unit 6653 may track node utilization patterns and processing efficiency to make informed decisions about node retention or removal. Global supervision controller 6660 coordinates system-wide adaptation through cross-layer coordinator 6661, resource allocation manager 6662, and system-wide optimizer 6663, where cross-layer coordinator 6661 may, for example, aggregate performance insights from multiple layers to develop comprehensive optimization strategies. Configuration manager 6664 maintains operational parameters and may implement dynamic system adjustment capabilities through coordinated parameter optimization, while synchronization controller 6665 ensures coherent operation across network components through adaptive coordination mechanisms.

Cross-layer coordinator 6661 facilitates communication and optimization between nodes across different layers, enabling supervisory nodes 6650a-n to direct adjustments to both monitoring nodes 6630a-n and base processing nodes 6610a-n. This hierarchical coordination ensures that optimization decisions account for both local node performance and global network efficiency. Resource allocation manager 6662 dynamically distributes processing resources across all nodes based on telemetry data collected from the monitoring node network.

Performance data flows from computational nodes 6612 through monitoring subsystem 6631 to supervision layer 6650, enabling continuous optimization of network operations. Supervision directives flow from global supervision controller 6660 through local supervision subsystem 6651 to network node subsystem 6611, implementing coordinated adaptation across processing layers. Resource tracking system 6640 provides utilization insights to resource allocation manager 6662, enabling efficient distribution of processing resources. Through integrated operation of these components, hierarchical thought supervision network 6600 maintains efficient processing while adapting to operational demands.

Hierarchical thought supervision network 6600 may incorporate various machine learning models to optimize processing, supervision, and adaptation. For example, deep neural networks may be employed within analysis engine 6634 to process telemetry data and identify optimization opportunities. These models may, for example, be trained on historical performance data, including but not limited to system resource utilization patterns, thought processing metrics, and adaptation outcomes. Training data may include logs of successful thought processing operations, encoding efficiency measurements, and resource allocation patterns.

Pattern detection engine 6638 may implement transformer-based architectures to analyze long-term operational patterns and detect anomalies. These models may, for example, be trained on sequences of system states, telemetry measurements, and optimization outcomes to learn temporal dependencies and predict potential performance issues. Training datasets may include recorded system behaviors under various operational conditions, allowing models to learn adaptive responses to different processing demands.

Resource tracking system 6640 may employ reinforcement learning models that continuously refine resource allocation strategies. For example, these models may learn optimal policy distributions for managing computational resources across network nodes through interaction with system components. Training may involve simulated workloads and real operational data, allowing models to develop sophisticated resource management policies that adapt to changing system conditions.

Local supervision subsystem 6651 may incorporate ensemble learning approaches, where multiple specialized models work together to optimize different aspects of system operation. These models may, for example, be trained on domain-specific datasets related to their particular optimization tasks. Training data may include thought processing patterns, cache utilization metrics, and node performance statistics, enabling models to develop targeted optimization strategies for different operational contexts.

Global supervision controller 6660 may implement hierarchical learning models that coordinate optimization across multiple system layers. These models may be trained on system-wide performance data, cross-layer interaction patterns, and long-term adaptation outcomes. For example, training datasets may include records of successful system-wide optimizations, resource reallocation patterns, and configuration adjustment outcomes, enabling models to learn effective coordination strategies across different operational scales.

In an embodiment of hierarchical thought supervision network 6600, data flows through multiple coordinated pathways to enable efficient processing and adaptation. Network node subsystem 6611 processes incoming data through computational nodes 6612, where thought processing units 6613 execute encoding operations under control of encoding transformation controller 6614. Node state manager 6615 and node communication controller 6616 coordinate information exchange between nodes. Performance data flows from computational nodes 6612 to monitoring subsystem 6631, where performance metric collectors 6632 and efficiency analyzers 6633 gather operational metrics. Analysis engine 6634 processes this telemetry data through kernel function processor 6635 and topology analysis unit 6636, with metric aggregation system 6637 consolidating insights. Resource tracking system 6640 continuously monitors system utilization through coordinated operation of memory usage monitor 6641, computation load tracker 6642, network utilization analyzer 6643, and storage efficiency monitor 6644. This monitoring data flows to supervision layer 6650, where local supervision subsystem 6651 implements immediate optimizations while global supervision controller 6660 coordinates broader system adjustments. Optimization directives flow from global supervision controller 6660 through cross-layer coordinator 6661 to local supervision subsystem 6651, which implements changes through node generation controller 6652, pruning management unit 6653, and local optimization engine 6654. Throughout operation, configuration manager 6664 maintains system parameters while synchronization controller 6665 ensures coherent operation across all components. This multi-level flow enables continuous adaptation while maintaining processing efficiency across hierarchical thought supervision network 6600.

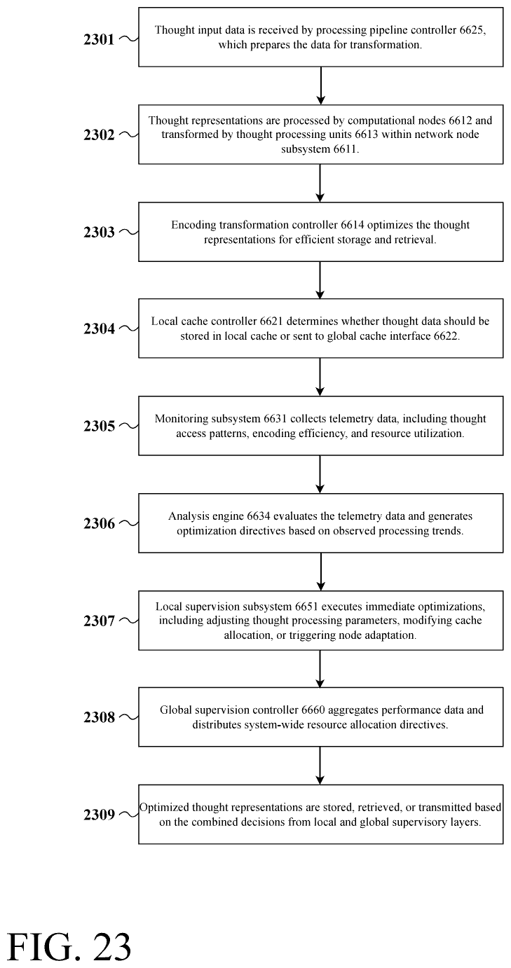

FIG. 23 is a method diagram illustrating the core thought supervision process of hierarchical thought supervision network 6600, in an embodiment. Thought input data is first received by processing pipeline controller 6625, which prepares the data for transformation by organizing thought elements and ensuring compatibility with processing subsystems 2301. Once prepared, computational nodes 6612 execute processing operations, while thought processing units 6613 within network node subsystem 6611 refine and structure the thought representations according to system requirements 2302. To optimize processing efficiency, encoding transformation controller 6614 applies encoding strategies that enhance storage, retrieval, and transmission capabilities 2303.

The processed thought representations are then evaluated by local cache controller 6621, which determines whether the thoughts should be stored in local cache for immediate access or routed to global cache interface 6622 for broader distribution across the system 2304. As these thought processing operations occur, monitoring subsystem 6631 collects telemetry data, tracking thought access frequency, encoding efficiency, and system resource utilization 2305. The collected telemetry data is then analyzed by analysis engine 6634, which identifies patterns, inefficiencies, and opportunities for optimization, generating directives to enhance system performance 2306.

Based on the analysis engine's findings, local supervision subsystem 6651 applies immediate optimizations by modifying thought processing parameters, adjusting cache allocations, or initiating node adaptations to improve performance 2307. For broader system-wide efficiency, global supervision controller 6660 aggregates telemetry insights from multiple subsystems and distributes resource allocation directives that dynamically balance computational load and thought processing demand across the network 2308. Finally, optimized thought representations are stored, retrieved, or transmitted according to the directives established by the local and global supervisory layers, ensuring efficient and adaptive thought processing throughout hierarchical thought supervision network 6600 2309.

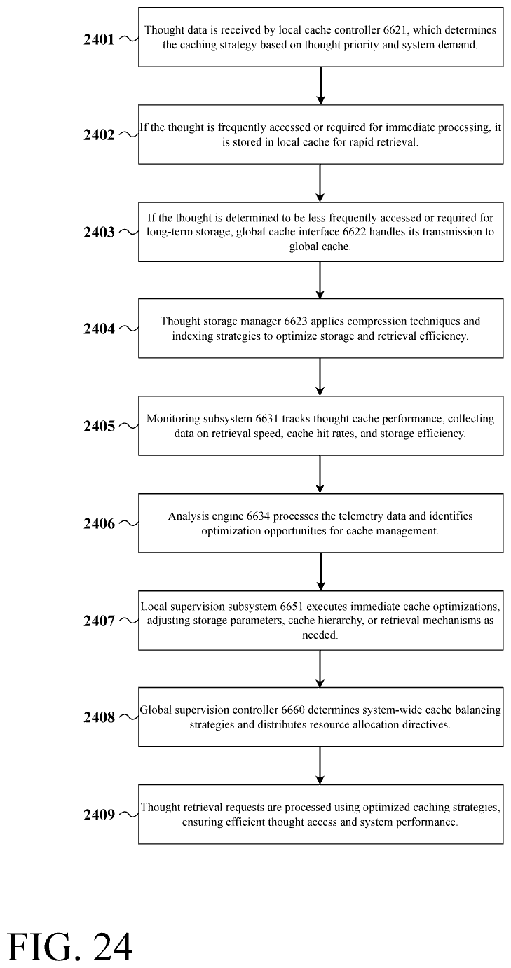

FIG. 24 is a method diagram illustrating the thought cache integration flow of hierarchical thought supervision network 6600, in an embodiment. Thought data is first received by local cache controller 6621, which evaluates caching strategies based on thought priority, system demand, and retrieval frequency 2401. If the thought is frequently accessed or required for immediate processing, local cache controller 6621 stores it in local cache, ensuring rapid retrieval and minimal processing delays 2402. If the thought is determined to be less frequently accessed or more suitable for long-term storage, global cache interface 6622 transmits it to global cache, where it can be accessed as needed for broader system-wide use 2403.

Once stored, thought storage manager 6623 applies compression techniques and indexing strategies to optimize memory usage and retrieval efficiency, ensuring that thought representations are structured for effective access 2404. Monitoring subsystem 6631 continuously tracks thought cache performance, collecting telemetry data such as retrieval speed, cache hit rates, and overall storage efficiency 2405. The collected data is processed by analysis engine 6634, which identifies patterns, inefficiencies, and areas where cache performance can be optimized 2406.

Based on the analysis findings, local supervision subsystem 6651 applies immediate cache optimizations, adjusting storage parameters, modifying cache hierarchy, or refining retrieval mechanisms to improve access efficiency 2407. At the system-wide level, global supervision controller 6660 assesses cache utilization across multiple nodes, determining balancing strategies and distributing resource allocation directives to ensure efficient thought management 2408. Finally, thought retrieval requests are processed using optimized caching strategies, ensuring fast and adaptive thought access while maintaining system-wide performance within hierarchical thought supervision network 6600 2409.

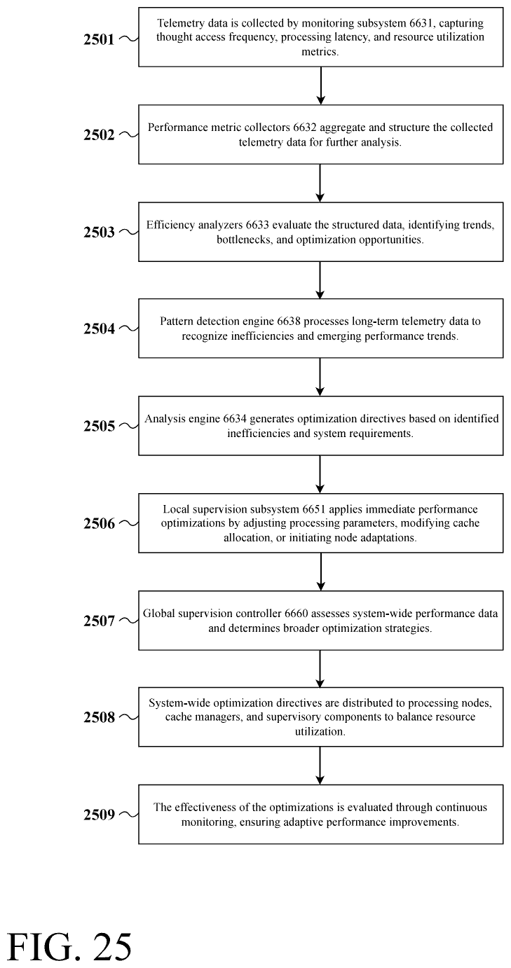

FIG. 25 is a method diagram illustrating the performance monitoring and optimization process of hierarchical thought supervision network 6600, in an embodiment. Telemetry data is first collected by monitoring subsystem 6631, capturing information on thought access frequency, processing latency, and resource utilization metrics across various system components 2501. Performance metric collectors 6632 then aggregate and structure this telemetry data, ensuring that it is organized for accurate evaluation and comparison 2502.

Once structured, efficiency analyzers 6633 process the data, identifying trends, performance bottlenecks, and areas where improvements can be made 2503. In parallel, pattern detection engine 6638 evaluates long-term telemetry data to recognize inefficiencies and emerging performance trends, allowing for proactive adjustments before performance degradation occurs 2504. Based on these evaluations, analysis engine 6634 generates optimization directives tailored to the system's operational needs, ensuring efficient allocation of computational resources 2505.

Local supervision subsystem 6651 applies immediate performance optimizations by adjusting processing parameters, modifying cache allocation, or initiating node adaptations to maintain optimal system function 2506. For broader performance enhancements, global supervision controller 6660 assesses system-wide telemetry insights, determining overarching optimization strategies that improve efficiency across multiple processing layers 2507. Once these strategies are finalized, system-wide optimization directives are distributed to processing nodes, cache managers, and supervisory components, ensuring balanced resource utilization throughout the network 2508.

Finally, the effectiveness of these optimizations is evaluated through continuous monitoring by monitoring subsystem 6631, allowing hierarchical thought supervision network 6600 to dynamically adapt and refine its performance over time 2509.

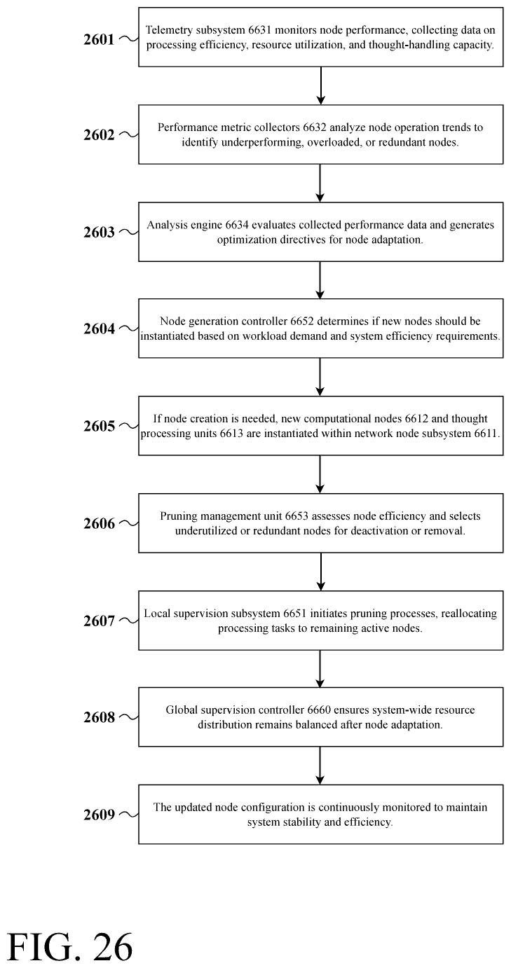

FIG. 26 is a method diagram illustrating the node lifecycle management process of hierarchical thought supervision network 6600, in an embodiment. Telemetry subsystem 6631 first monitors node performance by collecting data on processing efficiency, resource utilization, and the capacity of nodes to handle thought representations 2601. Performance metric collectors 6632 analyze this data, identifying trends that indicate whether nodes are underperforming, overloaded, or redundant within the system 2602.

Once these trends are identified, analysis engine 6634 processes the collected performance data and generates optimization directives for node adaptation, ensuring that the system maintains an optimal balance of processing resources 2603. Node generation controller 6652 evaluates workload demand and system efficiency requirements to determine if additional nodes should be instantiated to support increased processing needs 2604. If node creation is required, new computational nodes 6612 and thought processing units 6613 are instantiated within network node subsystem 6611, expanding processing capacity 2605.

Simultaneously, pruning management unit 6653 assesses system-wide node efficiency to identify underutilized or redundant nodes that may no longer be necessary 2606. If nodes are selected for removal, local supervision subsystem 6651 executes the pruning process, ensuring that processing tasks handled by deactivated nodes are efficiently redistributed among remaining active nodes 2607. To maintain overall system stability, global supervision controller 6660 reviews the updated resource allocation and distributes workloads accordingly to prevent imbalances 2608.

Finally, the updated node configuration is continuously monitored by telemetry subsystem 6631, ensuring that hierarchical thought supervision network 6600 remains efficient, stable, and dynamically optimized over time 2609.

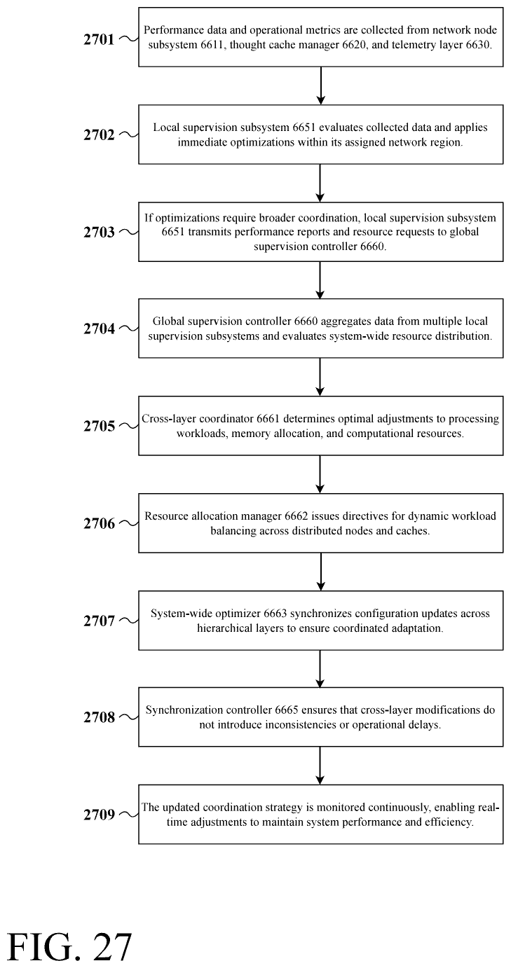

FIG. 27 is a method diagram illustrating the cross-layer coordination process of hierarchical thought supervision network 6600, in an embodiment. Performance data and operational metrics are first collected from network node subsystem 6611, thought cache manager 6620, and telemetry layer 6630, ensuring that system activity is continuously tracked across multiple levels 2701. Local supervision subsystem 6651 evaluates the collected data and applies immediate optimizations within its assigned network region, adjusting processing parameters and cache allocations as needed 2702.

If an optimization requires broader coordination beyond the local region, local supervision subsystem 6651 transmits performance reports and resource requests to global supervision controller 6660, ensuring that system-wide factors are considered in decision-making 2703. Global supervision controller 6660 aggregates performance data from multiple local supervision subsystems and evaluates resource distribution across the entire system to identify inefficiencies and imbalances 2704.

To optimize resource allocation, cross-layer coordinator 6661 determines the best adjustments to processing workloads, memory allocation, and computational resources, ensuring that hierarchical thought supervision network 6600 maintains efficiency across all operational layers 2705. Based on this analysis, resource allocation manager 6662 issues directives for dynamic workload balancing, ensuring that distributed nodes and caches receive the necessary resources for optimal operation 2706.

System-wide optimizer 6663 synchronizes configuration updates across all hierarchical layers, ensuring that adaptations occur in a coordinated manner without introducing system-wide disruptions 2707. To prevent inconsistencies or operational delays, synchronization controller 6665 oversees the execution of cross-layer modifications, ensuring that updates are seamlessly integrated into existing processes 2708. Finally, the updated coordination strategy is monitored continuously, allowing for real-time adjustments that maintain system performance, resource efficiency, and scalability 2709.

In a non-limiting use case example of hierarchical thought supervision network 6600, the system performs an automated node pruning operation to optimize processing efficiency and resource utilization while maintaining the integrity of thought processing.

The process begins when telemetry subsystem 6631 continuously monitors system performance, tracking key metrics such as node processing efficiency, memory consumption, encoding transformation latency, and inter-agent communication overhead. In this example, dynamically-encoded base agents 5631a-n process incoming thoughts, and one of these agents (Node A) begins to exhibit consistently low utilization and suboptimal efficiency. The telemetry subsystem detects that Node A's encoding transformations have less than 5% variation from neighboring nodes over a defined evaluation period, suggesting redundancy in processing capabilities.

Upon detecting this inefficiency, performance metric collectors 6632 aggregate Node A's activity data and efficiency analyzers 6633 identify that the node contributes negligible improvements to encoding transformations or processing throughput. This analysis is then forwarded to pattern detection engine 6638, which evaluates whether this inefficiency is temporary or indicative of a persistent redundancy within the hierarchical network.

Analysis engine 6634 processes these findings and generates a pruning directive, which is transmitted to pruning management unit 6653 within local supervision subsystem 6651. The pruning management unit cross-references these findings with recent resource allocation reports from global supervision controller 6660, ensuring that removing the node will not create processing bottlenecks or degrade system-wide efficiency.

Once confirmed, local supervision subsystem 6651 initiates a graceful decommissioning process for Node A. The computational responsibilities of Node A are reassigned to neighboring dynamically-encoded base agents 5631a-n. To prevent loss of important thought representations, thought storage manager 6623 ensures that Node A's thought cache is migrated to local cache controller 6621 or global cache interface 6622 as necessary.

Next, synchronization controller 6665 ensures that all references to Node A within inter-agent communication links 5639 are rerouted, preventing dead-end processing paths or inefficient transmission loops. System-wide optimizer 6663 updates network topology metadata, reflecting the removal of Node A and adjusting task distribution models accordingly.

After Node A is deactivated, telemetry subsystem 6631 continues monitoring the impact of the pruning operation. If thought processing latency remains stable or improves and system efficiency increases, global supervision controller 6660 confirms the pruning operation as successful. However, if unforeseen processing delays emerge, the system can either reinstate a node with modified parameters or distribute additional computational resources from mid-level dynamically-encoded agents 5641a-n.

This automated and adaptive node pruning process enables hierarchical thought supervision network 6600 to maintain scalable, efficient, and redundant-free operation while ensuring that computational resources are allocated effectively across all system layers.

In another non-limiting use case example of hierarchical thought supervision network 6600, the system performs an adaptive cache creation operation at the local level to improve thought retrieval efficiency and reduce redundant processing.

The process begins when local cache controller 6621 monitors thought access frequency, retrieval latency, and processing demand for a specific category of thoughts. In this example, an application utilizing hierarchical thought supervision network 6600 frequently queries a set of related thoughts concerning adaptive language translation models. Telemetry subsystem 6631 detects that identical or highly similar queries are being processed multiple times within a short period, leading to unnecessary repeated computations by thought processing units 6613.

Performance metric collectors 6632 aggregate data on retrieval delays and repeated computation cycles, and efficiency analyzers 6633 determine that the system could benefit from a localized caching solution. Analysis engine 6634 evaluates whether creating a dedicated local cache for these high-frequency thoughts would reduce processing overhead and improve response times. The results are forwarded to local supervision subsystem 6651, which is responsible for executing immediate cache optimizations.

Upon verifying that a local cache instance would enhance processing efficiency, local supervision subsystem 6651 issues a directive to thought storage manager 6623, instructing it to allocate memory space within local cache controller 6621. The system automatically indexes and stores frequently accessed thought representations while ensuring that encoding transformations remain optimized for quick retrieval.

Synchronization controller 6665 ensures that existing thought retrieval pathways are updated, so that future queries first check the new localized cache instance before accessing broader system resources. Additionally, resource allocation manager 6662 assigns memory resources dynamically to support cache expansion or contraction based on evolving demand.

Once the cache is operational, monitoring subsystem 6631 continues tracking cache performance metrics, such as retrieval speed, cache hit rates, and memory utilization. If the cache significantly improves response times, local supervision subsystem 6651 maintains it as an active component. If usage decreases, the cache may be consolidated or deallocated to free up resources.

Through this process, hierarchical thought supervision network 6600 dynamically creates, manages, and optimizes local cache instances to ensure that frequently accessed thoughts are available with minimal latency, improving overall system responsiveness and computational efficiency.

One skilled in the art would recognize that hierarchical thought supervision network 6600 may be applied to a wide range of use cases beyond the specific examples described herein. The system's capabilities, including dynamic thought processing, multi-tier optimization, adaptive encoding, intelligent caching, and automated resource management, enable it to be implemented in various domains such as artificial intelligence model optimization, real-time data processing, distributed computing architectures, and autonomous decision-making systems. These use cases are non-limiting in nature, as the underlying framework of hierarchical thought supervision network 6600 is designed to generalize across different applications where hierarchical supervision, adaptive learning, and efficient data representation are beneficial. Additionally, the modular nature of the system allows for further customization and extension based on specific operational requirements, technological advancements, and domain-specific challenges. The described examples should therefore be understood as illustrative implementations rather than exhaustive definitions of the system's full range of potential applications.

### Exemplary Computing Environment

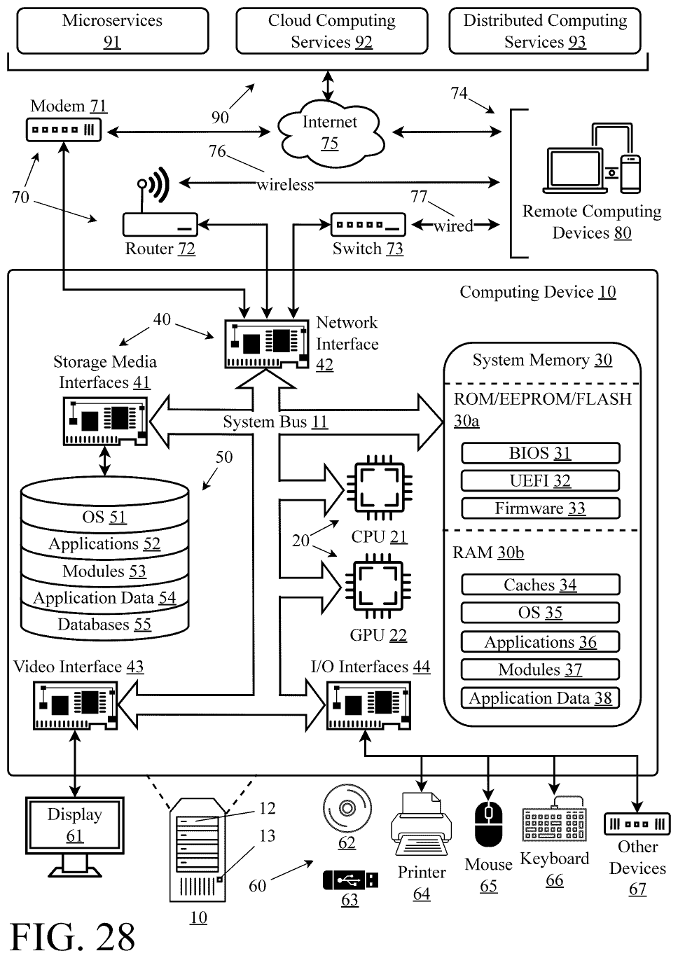

FIG. 28 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
implement a layered network architecture comprising:
a base graph layer comprising interconnected network nodes configured to process and manage thought representations;
a telemetry layer comprising monitoring nodes, wherein the monitoring nodes collect and analyze operational metrics related to thought processing efficiency; and
one or more supervision layers, wherein each supervision layer comprises a plurality of supervisory nodes that adapt network operations through thought encoding optimization, network node generation, and node pruning based on thought processing performance objectives.

2. The computer system of claim 1, wherein node encodings comprise dynamic representations of operational characteristics.

3. The computer system of claim 1, wherein the telemetry layer implements continuous monitoring using adaptive kernel functions and topology-aware distance metrics.

4. The computer system of claim 1, wherein network performance objectives comprise encoding costs, transmission costs, latency costs, and performance improvements.

5. The computer system of claim 1, wherein the base graph layer implements a thought cache for storing and retrieving thought representations.

6. The computer system of claim 5, wherein the thought cache comprises a local cache for recent thoughts and a global cache for persistent thought patterns.

7. The computer system of claim 1, wherein the supervisory nodes implement thought synthesis operations for combining thought representations.

8. The computer system of claim 1, wherein the supervision layers implement hierarchical thought supervision through coordinated local and global supervisory nodes.

9. The computer system of claim 1, wherein the supervisory nodes maintain thought encoding histories for optimization.

10. The computer system of claim 1, wherein the layered network architecture implements cross-layer thought coordination for resource optimization.

11. A method performed by a computer system executing software instructions stored on nontransitory machine-readable storage media, comprising:
implementing a layered network architecture by:
establishing a base graph layer comprising interconnected network nodes configured to process and manage thought representations;
implementing a telemetry layer comprising monitoring nodes, wherein the monitoring nodes collect and analyze operational metrics related to thought processing efficiency; and
maintaining one or more supervision layers, wherein each supervision layer comprises a plurality of supervisory nodes that adapt network operations through thought encoding optimization, network node generation, and node pruning based on thought processing performance objectives.

12. The method of claim 11, wherein node encodings comprise dynamic representations of operational characteristics.

13. The method of claim 11, wherein the telemetry layer implements continuous monitoring using adaptive kernel functions and topology-aware distance metrics.

14. The method of claim 11, wherein network performance objectives comprise encoding costs, transmission costs, latency costs, and performance improvements.

15. The method of claim 11, wherein the base graph layer implements a thought cache for storing and retrieving thought representations.

16. The method of claim 15, wherein the thought cache comprises a local cache for recent thoughts and a global cache for persistent thought patterns.

17. The method of claim 11, wherein the supervisory nodes implement thought synthesis operations for combining thought representations.

18. The method of claim 11, wherein the supervision layers implement hierarchical thought supervision through coordinated local and global supervisory nodes.

19. The method of claim 11, wherein the supervisory nodes maintain thought encoding histories for optimization.

20. The method of claim 11, wherein the layered network architecture implements cross-layer thought coordination for resource optimization.
